(19) United States
(12) Patent Application Publication
(10) Pub. No.: US 2026/0016493 A1
(43) Pub. Date: Jan. 15, 2026

(54) CONSUMABLES CONTAINER LOADING/UNLOADING SYSTEM

(71) Applicant: Beckman Coulter, Inc., Brea, CA (US)

(72) Inventors: Nathan E. MUELLER, Richfield, MN (US); Kevin L. NOWAK, Waconia, MN (US); Jon P. LINDQUIST, Jr., Coon Rapids, MN (US); Rebecca BUSACKER, Chanhassen, MN (US); Amit SAWHNEY, Chaska, MN (US); Benjamin J. RODMAN, Cologne, MN (US); Christopher R. KNUTSON, Chanhassen, MN (US); Takayuki MIZUTANI, Edina, MN (US)

(21) Appl. No.: 18/880,472

(22) PCT Filed: Jun. 30, 2023
(86) PCT No.: PCT/US2023/026664

§ 371 Date: Dec. 31, 2024

Related U.S. Application Data
(60) Provisional application No. 63/357,639, filed on Jul. 1, 2022.
(60) Provisional application No. 63/368,485, filed on Jul. 14, 2022.

(51) Int. Cl. G01N 35/00; G01N 35/02

(52) U.S. Cl. CPC G01N 35/00663; G01N 35/025

(57) ABSTRACT

A system (100, 100′, 100″) is provided for an automated analyzer (10) having an analyzer arrangement (12) configured to consume liquid consumables (14). The liquid consumables (14) are delivered to the automated analyzer (10) via consumables containers (20). The system (100, 100′, 100″) comprises a consumables container loading/unloading unit (102) comprising at least a first container holding position (C1) and a second container holding position (C2). Each of the first container holding position (C1) and the second container holding position (C2) is configured to removably hold at least one of the consumables containers (20). The system (100, 100′, 100″) further comprises at least one operator accessible container station (104) accessible by an operator, such that at least one of the first container holding position (C1) and the second container holding position (C2) is configured to directly receive the consumables containers (20) at the at least one operator accessible container station (104) from the operator. The system (100, 100′, 100″) further comprises at least one analyzer supply station (106) configured to deliver the liquid consumables (140 to the automated analyzer (10).

### PRIORITY

This application claims the benefit of U.S. Pat. App. No. 63/368,485, entitled “Consumables Container Loading/Unloading System,” filed Jul. 14, 2022, and U.S. Pat. App. No. 63/357,639, entitled “Consumables Container Loading/Unloading System,” filed Jul. 1, 2022, the disclosures of which are incorporated by reference herein.

### FIELD

The present disclosure generally relates to an automated analyzer. Particularly, the present disclosure relates to a consumables container loading/unloading system for the automated analyzer.

### BACKGROUND

Automated analyzers are well known in the art and are generally used for automated or semi-automated analysis of patient samples, such as blood, urine, spinal fluid, and the like. For testing and analyzing the patient sample, several key components are dispensed into a reaction vessel. The patient sample is dispensed by a sample nozzle from a sample container to the reaction vessel. Further, a reagent is dispensed by a reagent nozzle from a reagent container to the reaction vessel to which the patient sample has been dispensed. Further, a substrate is dispensed by a substrate nozzle from a substrate container to the reaction vessel to which the patient sample and the reagent has been dispensed. Therefore, liquid consumables (reagents and/or patient analytes) are dispensed to the reaction vessel for automated or semi-automated analysis of patient samples. Reagents and substrates are examples of liquid consumables, and the reagent container and the substrate container are examples of consumables containers.

Generally, consumables containers or the containers containing liquid consumables are manually loaded into the automated analyzer by an operator in the morning. Since there is a growing demand of analysis of the patient samples and the automated analyzers nowadays have improved processing capability of analysis, the consumption of the liquid consumables has also increased. In some cases, there may be a need to load additional consumables containers into the automated analyzer, for example, due to a shortage of consumables with respect to limited onboard capacity of the analyzer, and/or an urgent unscheduled test requirement. In some other cases, when the consumables in a container has exceeded its expiration date or when a consumables container is empty, it may need to be replaced. In order to load and/or replace the consumables containers, conventionally, the operator has to temporarily interrupt an operation of the automated analyzer. This may negatively affect a throughput of the automated analyzer. Further, in some cases, the operator may have to wait till completion of an operation before loading the additional consumables containers into the automated analyzer. However, this may be undesirable for the operator.

Moreover, during the loading of the consumables container or during aspiration of the liquid consumables from the consumables container, the liquid consumables may be exposed to gases, such as oxygen and carbon dioxide. In many cases, the liquid consumables are sensitive to such gases, which may eventually lead to erroneous test results. Therefore, there is a need to provide an effective sealing of the consumables containers during the loading of the consumables containers and during the aspiration of the liquid consumables from the consumables containers.

### BRIEF SUMMARY

According to a first aspect of the disclosure, a consumables container loading/unloading system is provided for an automated analyzer. The automated analyzer has an analyzer arrangement with a cycle time. The analyzer arrangement is configured to consume at least liquid consumables. At least some of the liquid consumables is delivered to the automated analyzer via consumables containers. The consumables container loading/unloading system comprises a consumables container loading/unloading apparatus comprising at least a first container holding position and a second container holding position. Each of the first container holding position and the second container holding position is configured to removably hold one of the consumables containers. The consumables container loading/unloading system further comprises an operator accessible container station accessible by an operator of the automated analyzer. The consumables container loading/unloading system further comprises an analyzer supply station not accessible by the operator of the automated analyzer. The consumables container loading/unloading system further comprises a fluid supply line positioned at the analyzer supply station. The fluid supply line is configured to deliver the at least some of the liquid consumables to the automated analyzer from the consumables containers. The consumables container loading/unloading apparatus is configured to move the first container holding position between the operator accessible container station and the analyzer supply station and is further configured to move the second container holding position between the analyzer supply station and the operator accessible container station.

The consumables container loading/unloading apparatus is configured to:
a) disconnect the fluid supply line from a first one of the consumables containers positioned at the analyzer supply station;
b) move the first one of the consumables containers away from the analyzer supply station;
c) move a second one of the consumables containers to the analyzer supply station;
d) connect the fluid supply line to the second one of the consumables containers when positioned at the analyzer supply station
   all within the cycle time and thereby provide loading of the consumables containers to the automated analyzer on-the-fly. Steps b) and c) may occur simultaneously. Steps a), b-c), and d) may occur sequentially.

According to an embodiment of the consumables container loading/unloading system of the first aspect, the consumables container loading/unloading system further comprises a barrier positioned between the analyzer supply station and the operator.

According to an embodiment of the consumables container loading/unloading system of the first aspect, the consumables container loading/unloading apparatus comprises an actuator that is configured to simultaneously move the first container holding position between the operator accessible container station and the analyzer supply station and the second container holding position between the analyzer supply station and the operator accessible container station.

According to an embodiment of the consumables container loading/unloading system of the first aspect, the actuator comprises a rotary actuator that moves the first and second container holding positions a half spin.

According to an embodiment of the consumables container loading/unloading system of the first aspect, the consumables container loading/unloading apparatus comprises three or more container holding positions.

According to a second aspect of the disclosure, a consumables container loading/unloading system is provided for an automated analyzer. The automated analyzer has an analyzer arrangement with a cycle time. The analyzer arrangement is configured to consume at least liquid consumables. At least some of the liquid consumables is delivered to the automated analyzer via consumables containers. The consumables container loading/unloading system comprises a consumables container loading/unloading unit comprising at least a first container holding position and a second container holding position. Each of the first container holding position and the second container holding position is configured to removably hold at least one of the consumables containers. The consumables container loading/unloading unit is configured to receive the consumables containers from an operator of the automated analyzer. The consumables container loading/unloading system further comprises an operator accessible container station accessible by the operator, such that at least one of the first container holding position and the second container holding position is configured to directly receive the consumables containers at the operator accessible container station from the operator. The consumables container loading/unloading system further comprises an analyzer supply station not accessible by the operator. The liquid consumables are delivered from the analyzer supply station to the automated analyzer. The consumables container loading/unloading system further comprises a fluid supply line disposed at the analyzer supply station. The fluid supply line is configured to connect with the consumables containers and thereby deliver some of the liquid consumables from the consumables containers to the automated analyzer. The consumables container loading/unloading system further comprises a controller communicably coupled to the consumables container loading/unloading unit and the fluid supply line. The controller is configured to control the consumables container loading/unloading unit to move the first container holding position between the operator accessible container station and the analyzer supply station. The controller is further configured to control the consumables container loading/unloading unit to move the second container holding position between the analyzer supply station and the operator accessible container station. The controller is further configured to control the consumables container loading/unloading unit and the fluid supply line to disconnect the fluid supply line from a first one of the consumables containers positioned at the analyzer supply station; move the first one of the consumables containers away from the analyzer supply station by moving a corresponding one of the first container holding position and the second container holding position located at the analyzer supply station to the operator accessible container station; move a second one of the consumables containers to the analyzer supply station by moving the corresponding other of the first container holding position and the second container holding position located at the operator accessible container station to the analyzer supply station; connect the fluid supply line with the second one of the consumables containers positioned at the analyzer supply station within the cycle time of the analyzer arrangement and thereby provide loading/unloading of the consumables containers during the cycle time of the analyzer arrangement. The operator is allowed to replace the first one of the consumables containers positioned at the operator accessible container station with another consumables container within the cycle time of the analyzer arrangement. However, the operator may take an extended period of time that is multiple cycle times to replace the consumables container positioned at the operator accessible container station.

According to an embodiment of the consumables container loading/unloading system of the second aspect, the consumables container loading/unloading system further comprises an access member configured to move vertically between an open position, a lockout position, and a closed position. In the closed position of the access member, the access member is disposed adjacent to the operator accessible container station and opposite to the analyzer supply station, and the operator is not allowed to load/unload the consumables containers to/from the consumables container loading/unloading unit. In at least the lockout position and not in the closed position of the access member, the first container holding position is moved between the operator accessible container station and the analyzer supply station, and the second container holding position is moved between the analyzer supply station and the operator accessible container station. In the open position of the access member, the operator is allowed to load/unload the consumables containers to/from the consumables container loading/unloading unit at the operator accessible container station.

According to an embodiment of the consumables container loading/unloading system of the second aspect, the consumables container loading/unloading system further comprises a first arm fixedly attached to the access member and communicably coupled to the controller. The first arm is configured to move at least vertically along a first direction in order to move the access member from the open position towards the lockout position and/or the closed position. The first arm is further configured to move at least vertically along a second direction opposite to the first direction in order to move the access member from the closed position towards the lockout position and/or the open position.

According to an embodiment of the consumables container loading/unloading system of the second aspect, the consumables container loading/unloading system further comprises a first lock assembly fixedly attached to the first arm. The first lock assembly comprises a first sealing ring configured to seal an opening of one of the consumables containers held in one of the first container holding position and the second container holding position at the operator accessible container station when the fluid supply line is connected with the other of the consumables containers at the analyzer supply station and when the access member is in the closed position. The first lock assembly further comprises a first spring configured to bias the first sealing ring towards the opening of the one of the consumables containers. The first lock assembly further comprises at least one first manifold configured to hold the first sealing ring thereagainst.

According to an embodiment of the consumables container loading/unloading system of the second aspect, the first sealing ring is not configured to seal the opening of the one of the consumables containers when the access member is in one of the lockout position and the open position.

According to an embodiment of the consumables container loading/unloading system of the second aspect, the consumables container loading/unloading system further comprises a first actuator communicably coupled to the controller. The controller is further configured to control the first actuator to move the first arm at least vertically along the first direction and the second direction in order to move the access member between the open position, the lockout position, and the closed position.

According to an embodiment of the consumables container loading/unloading system of the second aspect, the fluid supply line comprises a suction straw, such that the liquid consumables are accessed by the suction straw and delivered to the automated analyzer when the fluid supply line is connected with one of the consumables containers at the analyzer supply station.

According to an embodiment of the consumables container loading/unloading system of the second aspect, a portion of the suction straw is surrounded by a sleeve configured to limit exposure of the liquid consumables to ambient light.

According to an embodiment of the consumables container loading/unloading system of the second aspect, the consumables container loading/unloading system further comprises a second arm fixedly attached to the fluid supply line and communicably coupled to the controller. The second arm is configured to move at least vertically along the first direction in order to connect the fluid supply line with one of the consumables containers at the analyzer supply station. The second arm is further configured to move at least vertically along the second direction in order to disconnect the fluid supply line from the one of the consumables containers.

According to an embodiment of the consumables container loading/unloading system of the second aspect, the consumables container loading/unloading system further comprises a second lock assembly fixedly attached to the second arm. The second lock assembly comprises a second sealing ring configured to seal an opening of one of the consumables containers held in one of the first container holding position and the second container holding position at the analyzer supply station when the fluid supply line is connected with the one of the consumables containers at the analyzer supply station. The second lock assembly further comprises a second spring configured to bias the second sealing ring towards the opening of the one of the consumables containers. The second lock assembly further comprises at least one second manifold configured to hold the second sealing ring thereagainst. The at least one second manifold comprises an opening for receiving the suction straw therethrough. The second lock assembly further comprises a vent extending at least partially through the at least one second manifold. The vent is disposed in fluid communication with the one of the consumables containers when the fluid supply line is connected with the one of the consumables containers at the analyzer supply station. The second lock assembly further comprises a check valve disposed in fluid communication with the vent and configured to allow a flow of at least one gas into the one of the consumables containers at the analyzer supply station when the fluid supply line is connected with the one of the consumables containers and some of the liquid consumables is being delivered to the automated analyzer. However, the check valve does not allow constant or continuous diffusion of gas (e.g., oxygen and/or carbon dioxide) from the atmosphere into the liquid consumables (e.g., substrate) of the consumables containers (e.g., substrate container), which may otherwise lead to formation of carbonic acid, reduced pH of the substrate, and erroneous test results. The second lock assembly may further prevent excessive loss of liquid due to evaporation.

According to an embodiment of the consumables container loading/unloading system of the second aspect, the consumables container loading/unloading system further comprises a second actuator communicably coupled to the controller. The controller is further configured to control the second actuator to move the second arm at least vertically along the first direction in order to connect the fluid supply line with the one of the consumables containers at the analyzer supply station. The controller is further configured to control the second actuator to move the second arm at least vertically along the second direction in order to disconnect the fluid supply line from the one of the consumables containers at the analyzer supply station.

According to an embodiment of the consumables container loading/unloading system of the second aspect, the controller is further configured to control the second arm to move the second arm at least vertically along the first direction in order to connect the fluid supply line with one of the consumables containers at the analyzer supply station and seal, via the second lock assembly, the opening of the one of the consumables containers at the analyzer supply station. The controller is further configured to control the fluid supply line to deliver the liquid consumables to the automated analyzer when the fluid supply line is connected with the one of the consumables containers at the analyzer supply station. The controller is further configured to control the first arm to move the first arm at least vertically along the first direction in order to seal, via the first lock assembly, the opening of the other of the consumables containers at the operator accessible container station during the transfer of the liquid consumables to the automated analyzer. The controller is further configured to control each of the first arm and the second arm to move each of the first arm and the second arm at least vertically along the second direction when the transfer of the liquid consumables from the one of the consumables containers to the automated analyzer is completed. The controller is further configured to control the consumables container loading/unloading unit to move the first container holding position between the operator accessible container station and the analyzer supply station and to move the second container holding position between the analyzer supply station and the operator accessible container station, such that the other of the consumables containers is positioned at the analyzer supply station. The controller is further configured to control the second arm to move the second arm at least vertically along the first direction in order to connect the fluid supply line with the other of the consumables containers at the analyzer supply station and seal, via the second lock assembly, the opening of the other of the consumables containers at the analyzer supply station. The controller is further configured to control the fluid supply line to deliver the liquid consumables to the automated analyzer when the fluid supply line is connected with the other of the consumables containers at the analyzer supply station. The controller is further configured to control the first arm to further move the first arm at least vertically along the first direction, such that the operator is allowed to replace the one of the consumables containers at the operator accessible container station with a new consumables container. The new consumables container is received in the one of the first container holding position and the second container holding position at the operator accessible container station.

According to an embodiment of the consumables container loading/unloading system of the second aspect, the consumables container loading/unloading system further comprises a first home sensor disposed on the first arm to sense a position of the first arm. The consumables container loading/unloading system further comprises a second home sensor disposed on the second arm to sense a position of the second arm.

According to an embodiment of the consumables container loading/unloading system of the second aspect, the consumables container loading/unloading system further comprises a third actuator communicably coupled to the controller. The controller is configured to control the third actuator to move the first container holding position between the operator accessible container station and the analyzer supply station. The controller is configured to control the third actuator to move the second container holding position between the analyzer supply station and the operator accessible container station.

According to an embodiment of the consumables container loading/unloading system of the second aspect, the third actuator comprises a rotary actuator configured to move the first container holding position between the operator accessible container station and the analyzer supply station by rotating the first container holding position by 180 degrees. The rotary actuator is further configured to move the second container holding position between the analyzer supply station and the operator accessible container station by rotating the second container holding position by 180 degrees. In certain embodiments, the first and second container holding positions are rotated together by 180 degrees.

According to an embodiment of the consumables container loading/unloading system of the second aspect, the third actuator comprises a linear actuator configured to move the first container holding position at least piecewise linearly between the operator accessible container station and the analyzer supply station. The linear actuator is further configured to move the second container holding position at least piecewise linearly between the analyzer supply station and the operator accessible container station.

According to an embodiment of the consumables container loading/unloading system of the second aspect, the consumables container loading/unloading unit further comprises a barrier in order to allow loading of only consumables containers with predetermined dimensions and/or uncapped consumables containers.

According to an embodiment of the consumables container loading/unloading system of the second aspect, the consumables container loading/unloading system further comprises a reader configured to read identifiers of the consumables containers at the operator accessible container station.

According to an embodiment of the consumables container loading/unloading system of the second aspect, the consumables container loading/unloading unit comprises at least one additional container holding position in addition to the first container holding position and the second container holding position.

According to a third aspect of the disclosure, a consumables container loading/unloading system is provided for an automated analyzer. The automated analyzer has an analyzer arrangement with a cycle time. The analyzer arrangement is configured to consume at least liquid consumables. At least some of the liquid consumables is delivered to the automated analyzer via consumables containers. The consumables container loading/unloading system comprises a consumables container loading/unloading unit comprising at least a first container holding position and a second container holding position. Each of the first container holding position and the second container holding position is configured to removably hold at least one of the consumables containers. The consumables container loading/unloading unit is configured to receive the consumables containers from an operator of the automated analyzer. The consumables container loading/unloading system further comprises at least one operator accessible container station accessible by the operator, such that at least one of the first container holding position and the second container holding position is configured to directly receive the consumables containers at the at least one operator accessible container station from the operator. The consumables container loading/unloading system further comprises at least one analyzer supply station. The liquid consumables are delivered from the at least one analyzer supply station to the automated analyzer. The consumables container loading/unloading system further comprises at least one fluid supply line disposed at the at least one analyzer supply station and configured to connect with the consumables containers and thereby deliver some of the liquid consumables from the consumables containers to the automated analyzer. The consumables container loading/unloading system further comprises a first lock assembly fixedly attached to a first arm. The first lock assembly comprises a first sealing ring configured to seal a first opening of a first consumables container held in one of the first container holding position and the second container holding position. The consumables container loading/unloading system further comprises a second lock assembly fixedly attached to a second arm. The second lock assembly comprises a second sealing ring configured to seal a second opening of a second consumables container held in the other of the first container holding position and the second container holding position. The second lock assembly further comprises a second check valve configured to allow a flow of at least one gas into the second consumables container at the at least one analyzer supply station when the at least one fluid supply line is connected with the second consumables container and some of the liquid consumables is being delivered to the automated analyzer. The consumables container loading/unloading system further comprises a controller communicably coupled to the consumables container loading/unloading unit, the at least one fluid supply line, the first arm, and the second arm. The second check valve may be an electrically actuated valve.

According to an embodiment of the consumables container loading/unloading system of the third aspect, the first lock assembly further comprises a first spring configured to bias the first sealing ring towards the first opening of the first consumables container. The first lock assembly further comprises at least one first manifold configured to hold the first sealing ring thereagainst.

According to an embodiment of the consumables container loading/unloading system of the third aspect, the first lock assembly further comprises a first vent extending at least partially through the at least one first manifold and disposed in fluid communication with the first consumables container when the at least one fluid supply line is connected with the first consumables container at the at least one analyzer supply station. The first lock assembly further comprises a first check valve disposed in fluid communication with the first vent and configured to allow a flow of at least one gas into the first consumables container at the at least one analyzer supply station when the at least one fluid supply line is connected with the first consumables container and some of the liquid consumables is being delivered to the automated analyzer. The first check valve may be an electrically actuated valve.

According to an embodiment of the consumables container loading/unloading system of the third aspect, the first arm is fixedly attached to the at least one fluid supply line. The first arm is configured to move at least vertically along a first direction in order to connect the at least one fluid supply line with the first consumables container at the at least one analyzer supply station. The first arm is further configured to move at least vertically along a second direction opposite to the first direction in order to disconnect the at least one fluid supply line from the first consumables container.

According to an embodiment of the consumables container loading/unloading system of the third aspect, the second lock assembly further comprises a second spring configured to bias the second sealing ring towards the second opening of the second consumables container. The second lock assembly further comprises at least one second manifold configured to hold the second sealing ring thereagainst. The second lock assembly further comprises a second vent disposed in fluid communication with the second check valve and extending at least partially through the at least one second manifold. The second vent is disposed in fluid communication with the second consumables container when the at least one fluid supply line is connected with the second consumables container at the at least one analyzer supply station.

According to an embodiment of the consumables container loading/unloading system of the third aspect, the second arm is fixedly attached to the at least one fluid supply line. The second arm is configured to move at least vertically along a first direction in order to connect the at least one fluid supply line with the second consumables container at the at least one analyzer supply station. The second arm is further configured to move at least vertically along a second direction opposite to the first direction in order to disconnect the at least one fluid supply line from the second consumables container.

According to an embodiment of the consumables container loading/unloading system of the third aspect, the controller is configured to control the second arm to move the second arm at least vertically along a first direction in order to connect the at least one fluid supply line with the second consumables container at the at least one analyzer supply station and seal, via the second lock assembly, the second opening of the second consumables container at the at least one analyzer supply station. The controller is further configured to control the at least one fluid supply line to deliver the liquid consumables to the automated analyzer when the at least one fluid supply line is connected with the second consumables container at the at least one analyzer supply station. The controller is further configured to control the first arm to move the first arm at least vertically along a second direction opposite to the first direction, such that the operator is allowed to replace the first consumables container at the at least one operator accessible container station with a new consumables container. The new consumables container is received in the one of the first container holding position and the second container holding position at the at least one operator accessible container station. The controller is further configured to control the first arm to move the first arm at least vertically along the first direction in order to connect the at least one fluid supply line with the new consumables container at the at least one analyzer supply station and seal, via the first lock assembly, an opening of the new consumables container at the at least one operator accessible container station during the transfer of the liquid consumables from the second consumables container to the automated analyzer. The controller is further configured to control the at least one fluid supply line to deliver the liquid consumables from the new consumables container to the automated analyzer when the transfer of the liquid consumables from the second consumables container to the automated analyzer is completed. The controller is further configured to control the second arm to move the second arm at least vertically along the second direction in order to disconnect the at least one fluid supply line from the second consumables container at the at least one analyzer supply station. The operator is allowed to replace the second consumables container at the at least one operator accessible container station with another new consumables container when the at least one fluid supply line is disconnected from the second consumables container. The another new consumables container is received in the other of the first container holding position and the second container holding position at the at least one operator accessible container station.

According to an embodiment of the consumables container loading/unloading system of the third aspect, the at least one operator accessible container station comprises only a single operator accessible container station serving at the one of the first container holding position and the second container holding position.

According to an embodiment of the consumables container loading/unloading system of the third aspect, the at least one analyzer supply station comprises only a single analyzer supply station spaced apart from the single operator accessible container station and serving at the other of the first container holding position and the second container holding position. The single analyzer supply station is not accessible by the operator. The at least one fluid supply line comprises a single fluid supply line disposed at the single analyzer supply station.

According to an embodiment of the consumables container loading/unloading system of the third aspect, the controller is configured to control the consumables container loading/unloading unit to move the first container holding position between the single operator accessible container station and the single analyzer supply station. The controller is further configured to control the consumables container loading/unloading unit to move the second container holding position between the single analyzer supply station and the single operator accessible container station.

According to an embodiment of the consumables container loading/unloading system of the third aspect, the controller is further configured to control the consumables container loading/unloading unit and the single fluid supply line to disconnect the single fluid supply line from the second consumables container positioned at the single analyzer supply station; move the second consumables container away from the single analyzer supply station by moving a corresponding one of the first container holding position and the second container holding position located at the single analyzer supply station to the single operator accessible container station; move the first consumables container to the single analyzer supply station by moving the corresponding other of the first container holding position and the second container holding position located at the single operator accessible container station to the single analyzer supply station; connect the single fluid supply line with the first consumables container positioned at the single analyzer supply station within the cycle time of the analyzer arrangement and thereby provide loading/unloading of the consumables containers during the cycle time of the analyzer arrangement. The operator is allowed to replace the second consumables container positioned at the single operator accessible container station with another consumables container within the cycle time of the analyzer arrangement.

According to an embodiment of the consumables container loading/unloading system of the third aspect, the at least one operator accessible container station comprises a pair of operator accessible container stations spaced apart from each other. One of the pair of operator accessible container stations serves at the one of the first container holding position and the second container holding position. The other of the pair of operator accessible container stations serves at the other of the first container holding position and the second container holding position.

According to an embodiment of the consumables container loading/unloading system of the third aspect, the at least one analyzer supply station comprises a pair of analyzer supply stations spaced apart from each other. One of the pair of analyzer supply stations serves at the one of the first container holding position and the second container holding position. The other of the pair of analyzer supply stations serves at the other of the first container holding position and the second container holding position. The at least one fluid supply line comprises a pair of fluid supply lines. Each of the pair of fluid supply lines is disposed at a corresponding analyzer supply station from the pair of analyzer supply stations.

According to an embodiment of the consumables container loading/unloading system of the third aspect, the one of the pair of analyzer supply stations and the one of the pair of operator accessible container stations are serving at the first container holding position. The other of the pair of analyzer supply stations and the other of the pair of operator accessible container stations are serving at the second container holding position.

According to an embodiment of the consumables container loading/unloading system of the third aspect, each of the at least one fluid supply line comprises a suction straw, such that the liquid consumables are accessed by the suction straw and delivered to the automated analyzer when the at least one fluid supply line is connected with the at least one of the consumables containers at the at least one analyzer supply station.

According to an embodiment of the consumables container loading/unloading system of the third aspect, the consumables container loading/unloading system further comprises a first home sensor disposed on the first arm to sense a position of the first arm. The consumables container loading/unloading system further comprises a second home sensor disposed on the second arm to sense a position of the second arm.

According to an embodiment of the consumables container loading/unloading system of the third aspect, the consumables container loading/unloading unit further comprises a barrier in order to allow loading of only consumables containers with predetermined dimensions and/or uncapped consumables containers.

According to an embodiment of the consumables container loading/unloading system of the third aspect, the consumables container loading/unloading unit further comprises at least one reader configured to read identifiers of the consumables containers at the at least operator accessible container station.

According to an embodiment of the consumables container loading/unloading system of the third aspect, the consumables container loading/unloading system further comprises a tubing guide for guiding the at least one fluid supply line when the second arm moves along the first direction and the second direction.

According to fourth aspect of the disclosure, a method of operating a consumables container loading/unloading system for an automated analyzer is provided. The automated analyzer has an analyzer arrangement with a cycle time. The analyzer arrangement is configured to consume at least liquid consumables, at least some of the liquid consumables delivered to the automated analyzer via consumables containers. The method comprises disconnecting a fluid supply line from a first one of the consumables containers positioned at an analyzer supply station not accessible by an operator of the automated analyzer, moving the first one of the consumables containers away from the analyzer supply station, moving a second one of the consumables containers to the analyzer supply station, and connecting the fluid supply line to the second one of the consumables containers when positioned at the analyzer supply station, wherein disconnecting the fluid supply line from the first one of the consumables containers, moving the first one of the consumables containers away from the analyzer supply station, moving the second one of the consumables containers to the analyzer supply station, and connecting the fluid supply line to the second one of the consumables containers are performed within the cycle time and thereby provide loading of the consumables containers to the automated analyzer on-the-fly.

According to an embodiment of the method of the fourth aspect, moving the first one of the consumables containers away from the analyzer supply station includes moving the first one of the consumables containers to an operator accessible container station accessible by the operator of the automated analyzer.

According to an embodiment of the method of the fourth aspect, moving the second one of the consumables containers to the analyzer supply station includes moving the second one of the consumables containers from an operator accessible container station accessible by the operator of the automated analyzer.

According to an embodiment of the method of the fourth aspect, the fluid supply line is positioned at the analyzer supply station.

According to an embodiment of the method of the fourth aspect, the method further comprises delivering the at least some of the liquid consumables to the automated analyzer from the consumables containers via the fluid supply line.

According to an embodiment of the method of the fourth aspect, the method further comprises operating the analyzer arrangement within the cycle time.

According to an embodiment of the method of the fourth aspect, the cycle time is within a range of about 6 seconds to about 12 seconds.

According to a fifth aspect of the disclosure, a consumables container loading/unloading system for an automated analyzer is provided. The automated analyzer has an analyzer arrangement with a cycle time. The consumables container loading/unloading system comprises an operator accessible container station accessible by an operator of the automated analyzer; an analyzer supply station not accessible by the operator of the automated analyzer; a consumables container loading/unloading apparatus configured to move first and second consumable containers between the operator accessible container station and the analyzer supply station; a fluid supply line positioned at the analyzer supply station, the fluid supply line being configured to deliver liquid consumables to the automated analyzer from the first and second consumables containers; and a controller communicably coupled to the consumables container loading/unloading apparatus, wherein the controller is configured to, within the cycle time: disconnect the fluid supply line from the first consumables container positioned at the analyzer supply station, move the first consumables container away from the analyzer supply station, move the second consumables container to the analyzer supply station, and connect the fluid supply line to the second consumables container when positioned at the analyzer supply station.

According to an embodiment of the consumables container loading/unloading system of the fifth aspect, the consumables container loading/unloading unit further comprises a barrier configured to allow loading of only consumables containers with predetermined dimensions and/or uncapped consumables containers.

According to an embodiment of the consumables container loading/unloading system of the fifth aspect, the barrier includes at least one pair of upper prongs spaced apart from each other to define an opening that is sized and configured to receive a neck portion of only consumables containers with predetermined dimensions and/or uncapped consumables containers.

According to an embodiment of the consumables container loading/unloading system of the fifth aspect, the barrier includes at least one pair of lower prongs spaced apart from each other to define an opening that is sized and configured to receive a body portion of only consumables containers with predetermined dimensions and/or uncapped consumables containers.

According to an embodiment of the consumables container loading/unloading system of the fifth aspect, the consumables container loading/unloading system further comprises a first lock assembly configured to selectively seal an opening of at least one of the first or second consumables containers when positioned at the operator accessible container station.

According to an embodiment of the consumables container loading/unloading system of the fifth aspect, the first lock assembly comprises: a first sealing ring configured to selectively seal the opening of the at least one of the first or second consumables containers when positioned at the operator accessible container station; a first spring configured to bias the first sealing ring towards the opening of the at least one of the first or second consumables containers; and at least one first manifold configured to hold the first sealing ring thereagainst.

According to an embodiment of the consumables container loading/unloading system of the fifth aspect, the at least one first manifold includes only a single manifold, wherein the first lock assembly further comprises a first nut configured to hold the first sealing ring against the single manifold.

According to an embodiment of the consumables container loading/unloading system of the fifth aspect, the consumables container loading/unloading system further comprises a second lock assembly configured to selectively seal an opening of at least one of the first or second consumables containers when positioned at the analyzer supply station.

According to an embodiment of the consumables container loading/unloading system of the fifth aspect, the second lock assembly comprises: a second sealing ring configured to selectively seal the opening of at least one of the first or second consumables containers when positioned at the analyzer supply station; a second spring configured to bias the second sealing ring towards the opening of the at least one of the first or second consumables containers; and at least one second manifold configured to hold the second sealing ring thereagainst, the at least one second manifold comprising an opening for receiving a suction straw therethrough.

According to an embodiment of the consumables container loading/unloading system of the fifth aspect, the at least one second manifold includes only a single manifold, wherein the second lock assembly further comprises a second nut configured to hold the second sealing ring against the single manifold.

The automated analyzer may be used for automated or semi-automated analysis of patient samples, such as blood, urine, spinal fluid, and the like. For testing and analyzing the patient samples, several key components are dispensed into a reaction vessel in the analyzer arrangement of the automated analyzer. The liquid consumables are dispensed by a dispensing apparatus from the consumables containers to the reaction vessel for testing and analyzing the patient samples.

Due to a growing demand of analysis of the patient samples and as the automated analyzers may have improved processing capability of analysis, there may be an increase in consumption of the liquid consumables. Therefore, due to limited onboard capacity of the automated analyzer, and/or an urgent unscheduled test requirement, there may be a need to load/unload the consumables containers into the automated analyzer while the analyzer arrangement is in an active mode (i.e., consuming the liquid consumables).

The consumables container loading/unloading system of the present disclosure may enable manually loading/unloading of the consumables containers into or from the automated analyzer while the analyzer arrangement is in the active mode. Therefore, the operator may not have to pause or interrupt one or more operations of the automated analyzer in order to load/unload the one or more of the consumables containers into or from the automated analyzer. This may prevent delays in a workflow of the automated analyzer and subsequently improve a throughput of the automated analyzer. Further, the consumables container loading/unloading system may prevent shortage of the liquid consumables during the analysis of the patient samples.

Further, as some of the liquid consumables is being delivered to the automated analyzer when the at least one fluid supply line is connected with a consumables container at the at least one analyzer supply station, the operator is allowed to replace a used or empty consumables container with a new consumables container at the at least one operator accessible container station. This may further decrease a time required to load the consumables containers into the consumables containers loading/unloading unit, so that the liquid consumables contained in the consumables containers may be used when required for the analysis of the patient samples. In some cases, the operator may load or unload a consumables container at the single operator accessible container station. In some cases, the operator may load or unload a consumables container at the pair of operator accessible container stations at different time periods.

Moreover, since the operator may not have to wait until completion of one or more operations before loading the consumables containers into the automated analyzer, the operator may carry out other necessary tasks. This may also save a time of the operator. Further, the consumables container loading/unloading system may ensure operational safety. Therefore, the automated analyzer may further be user friendly.

In some cases, the second lock assembly of the consumables containers loading/unloading system allows sealing of the consumables containers at the analyzer supply station during the transfer of the liquid consumables from the consumables containers to the automated analyzer. In some cases, the first lock assembly of the consumables containers loading/unloading system allows sealing of the consumables containers at the operator accessible container station during the transfer of the liquid consumables from the consumables containers (at the analyzer supply station) to the automated analyzer. Therefore, the consumables containers loading/unloading system of the present disclosure may limit the ingress of gases, such as oxygen and carbon dioxide, to a great extent into the consumables containers at the first container holding position and/or the second container holding position. Thus, constant or continuous diffusion or at least constant or continuous diffusion of gases into liquid consumables within the consumables containers is avoided.

Further, the second lock assembly also comprises the second check valve which allows the flow of the at least one gas (e.g., ambient air or inert gas, such as argon) into a consumables container at the at least one analyzer supply station when the at least one fluid supply line is connected with that consumables container. This may prevent significant vacuum formation during the transfer of the liquid consumables from that consumables container to the automated analyzer. However, the second check valve does not allow constant or continuous diffusion of gas (e.g., oxygen and/or carbon dioxide) from the atmosphere into the liquid consumables (e.g., substrate) of the consumables containers (e.g., substrate container), which may otherwise lead to formation of carbonic acid, reduced pH of the substrate, and erroneous test results. The second lock assembly may further prevent excessive loss of liquid due to evaporation.

In cases where the consumables container loading/unloading system comprises the pair of analyzer supply stations and the pair of operator accessible container stations, the first check valve allows the flow of the at least one gas into a consumables container at one of the pair of analyzer supply stations when one of the pair of fluid supply lines is connected with the consumables container at the one of the pair of analyzer supply stations, and the second check valve allows the flow of the at least one gas into another consumables container at the other of the pair of analyzer supply stations when the other of the pair of fluid supply lines is connected with the another consumables container at the other of the pair of analyzer supply stations. Therefore, irrespective of number of analyzer supply stations (e.g., the single analyzer supply station or the pair of analyzer supply stations), the consumables container loading/unloading system may prevent the significant vacuum formation during the transfer of the liquid consumables from the consumables containers to the automated analyzer.

A variety of additional aspects will be set forth in the description that follows. These aspects can relate to individual features and to combinations of features. It is to be understood that both the foregoing summary and the following detailed description are exemplary and explanatory only and are not restrictive of the broad concepts upon which the embodiments disclosed herein are based.

### BRIEF DESCRIPTION OF THE FIGURES

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a perspective view of an automated analyzer including a consumables container loading/unloading system, according to an embodiment of the present disclosure;

FIG. 2 is a block diagram of the consumables container loading/unloading system suitable for use in the automated analyzer of FIG. 1, according to an embodiment of the present disclosure;

FIGS. 3A through 3C are different views of the consumables container loading/unloading system of FIG. 2, with some components not shown, according to an example embodiment of the present disclosure;

FIG. 3D is a perspective view of a barrier of the consumables container loading/unloading system of FIG. 2;

FIG. 4A is a side view of the consumables container loading/unloading system of FIG. 3A when an access member is in a closed position, according to an embodiment of the present disclosure;

FIG. 4B is a side view of the consumables container loading/unloading system of FIG. 3A when the access member is in a lockout position, according to an embodiment of the present disclosure;

FIG. 4C is a side view of the consumables container loading/unloading system of FIG. 3A when the access member is in an open position, according to an embodiment of the present disclosure;

FIG. 5 is an enlarged view of a portion of the consumables container loading/unloading system of FIG. 3B, according to an embodiment of the present disclosure;

FIGS. 6A through 6C are different views of a first arm and a first lock assembly of the consumables container loading/unloading system of FIG. 3B, according to an embodiment of the present disclosure;

FIGS. 7A through 7D are different views of a second arm and a second lock assembly of the consumables container loading/unloading system of FIG. 3B, according to an embodiment of the present disclosure;

FIG. 8 is a timing diagram depicting various operations in the consumables container loading/unloading system for loading/unloading of consumables containers, according to an embodiment of the present disclosure;

FIG. 9 is a top view of a consumables container loading/unloading system for an automated analyzer, according to another embodiment of the present disclosure;

FIGS. 10A through 10D are different views of a consumables container loading/unloading system for an automated analyzer, according to yet another embodiment of the present disclosure;

FIGS. 11A through 11C are different views of a first arm and a first lock assembly of the consumables container loading/unloading system of FIG. 10A, according to an embodiment of the present disclosure;

FIGS. 12A and 12B are perspective views of the consumables container loading/unloading system of FIGS. 3A through 3C that illustrate a tubing guide, according to an embodiment of the present disclosure;

FIG. 13A is a perspective view of another example of a first lock assembly for use with the consumables container loading/unloading system of FIG. 3B;

FIG. 13B is an exploded perspective view of the first lock assembly of FIG. 13A;

FIG. 14A is a perspective view of another example of a second lock assembly for use with the consumables container loading/unloading system of FIG. 3B;

FIG. 14B is an exploded perspective view of the second lock assembly of FIG. 14A;

FIG. 14C is a cross-sectional view of the second lock assembly of FIG. 14A, taken along line 14C-14C in FIG. 14A;

FIG. 15 is a flowchart depicting an example of a procedure for sealing a desired consumables container at the analyzer supply station of the consumables container loading/unloading system of FIG. 3B;

FIG. 16 is a flowchart depicting an example of a procedure for unsealing a spent consumables container at the analyzer supply station of the consumables container loading/unloading system of FIG. 3B;

FIG. 17 is a flowchart depicting an example of a procedure for sealing a standby consumables container at the operator accessible container station of the consumables container loading/unloading system of FIG. 3B;

FIG. 18 is a flowchart depicting an example of a procedure for unsealing a standby consumables container at the operator accessible container station of the consumables container loading/unloading system of FIG. 3B;

FIG. 19 is a flowchart depicting an example of a procedure for moving the rotary platform while changing a consumables container at the operator accessible container station of the consumables container loading/unloading system of FIG. 3B;

FIG. 20 is a flowchart depicting an example of a procedure for automatically aligning consumables containers at the operator accessible container station and the analyzer supply station with the respective lock assemblies of the consumables container loading/unloading system of FIG. 3B; and

FIGS. 21A-21D are a flowchart depicting another example of a procedure for automatically aligning consumables containers at the operator accessible container station and the analyzer supply station with the respective lock assemblies of the consumables container loading/unloading system of FIG. 3B.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

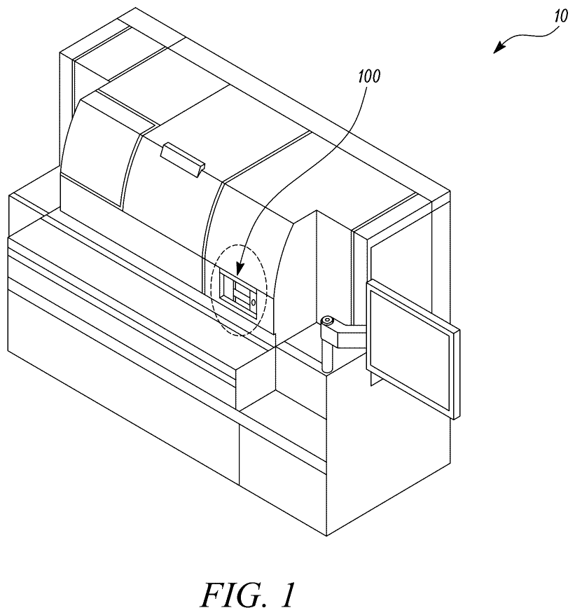

Referring now to the Figures, FIG. 1 illustrates a perspective view of an automated analyzer 10, according to an embodiment of the present disclosure. The automated analyzer 10, as shown at FIG. 1, may be used by an operator. The automated analyzer 10 may conduct qualitative and quantitative analysis on one or more chemical components contained in a biological sample, or upon biologically derived substances contained in the biological sample, such as blood, urine, spinal fluid, and the like. The automated analyzer 10 may conduct qualitative and/or quantitative analysis on one or more antibody or antigen components contained in a biological sample, or upon biologically derived substances contained in the biological sample, such as blood. Further, FIG. 1 partially illustrates a consumables container loading/unloading system 100 for the automated analyzer 10.

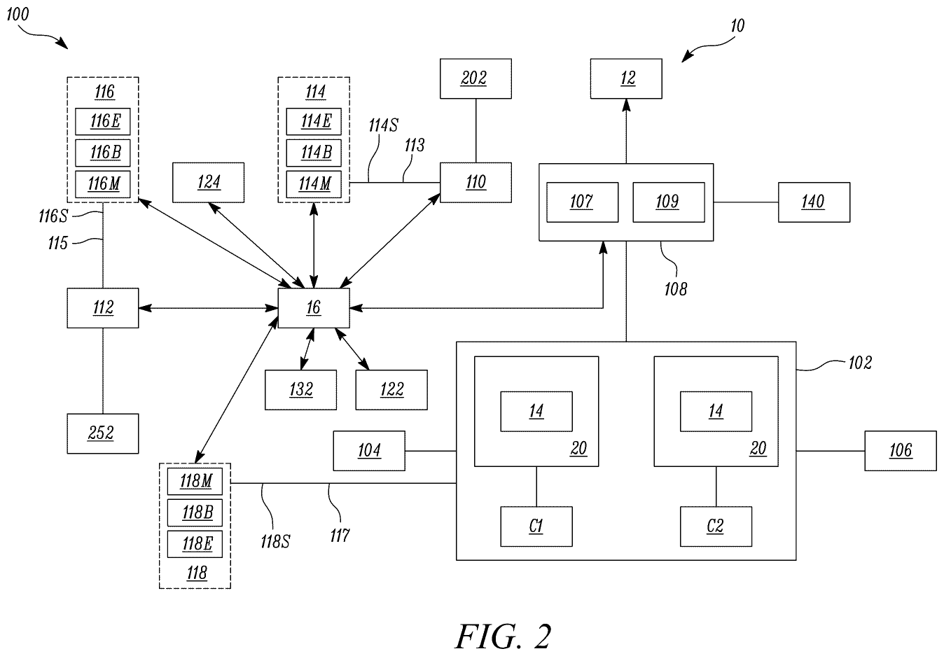

FIG. 2 illustrates a block diagram of the consumables container loading/unloading system 100 for the automated analyzer 10, according to an embodiment of the present disclosure. The automated analyzer 10 has an analyzer arrangement 12 with a cycle time. In general, the cycle time of the analyzer arrangement 12 may refer to a minimum time between test results, and all of the sub-systems of the automated analyzer 10 are synchronized in time by operating at the same cycle time. In some cases, the cycle time of the analyzer arrangement 12 may be about 8 seconds, 12 seconds, a range of 6 to 12 seconds, or a range of 6 to 10 seconds.

The analyzer arrangement is configured to consume at least liquid consumables 14. The automated analyzer 10 may analyze the one or more chemical components by measuring optical characteristics of a reaction solution obtained by mixing and combining the biological sample and at least the liquid consumables 14. The automated analyzer 10 may analyze the one or more antibody or antigen components by measuring light output from a reaction obtained by mixing and combining and incubating the biological sample and at least the liquid consumables 14. At least some of the liquid consumables 14 is delivered to the automated analyzer 10 via consumables containers 20. In some embodiments, the liquid consumables 14 may include reagents. In some embodiments, the liquid consumables 14 may include substrates. In some embodiments, the liquid consumables 14 may include patient samples. In some embodiments, the automated analyzer 10 may be an immunoassay analyzer or a clinical chemistry analyzer. In some embodiments, the automated analyzer 10 may be located within a clinical laboratory.

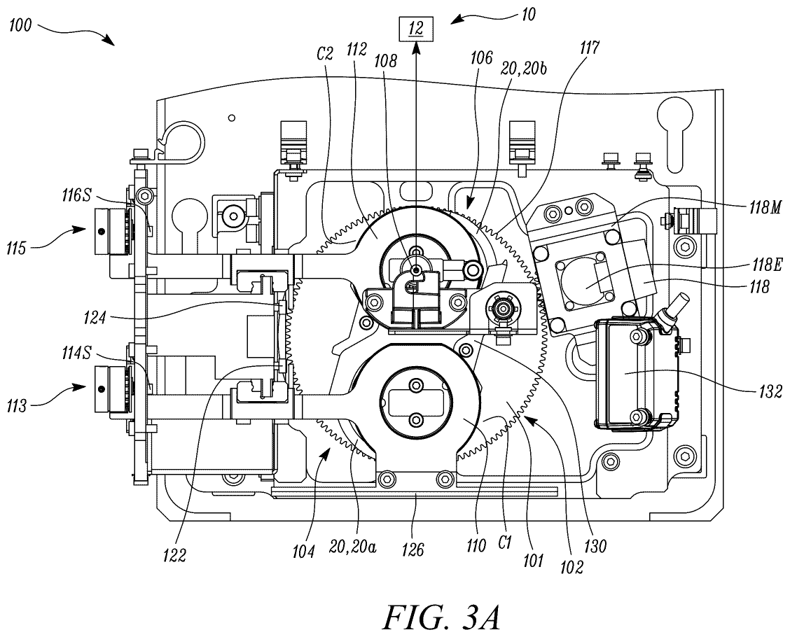

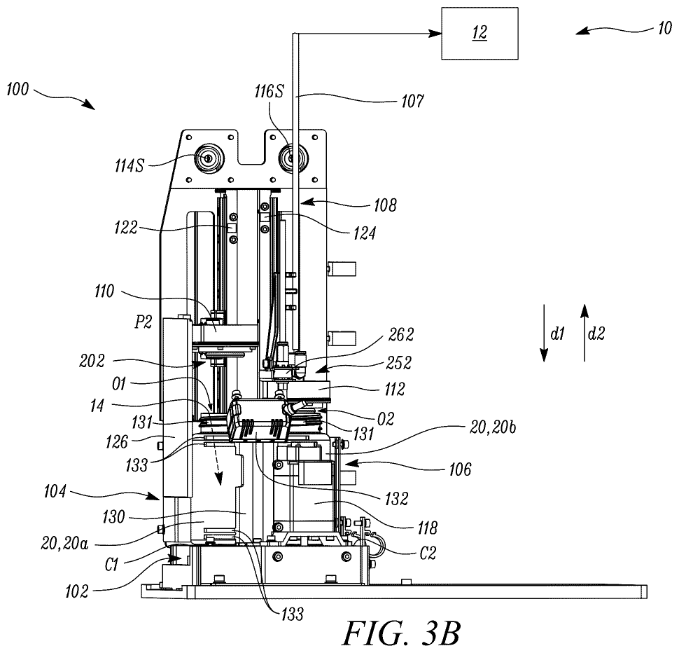

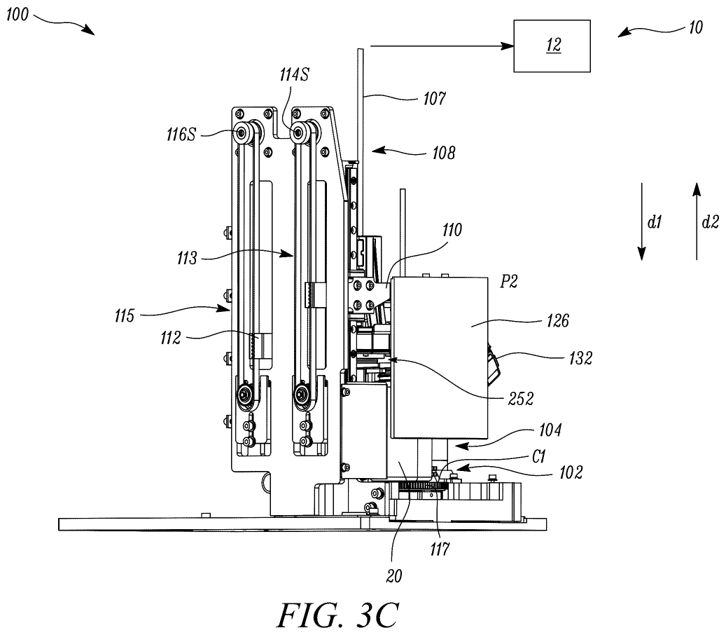

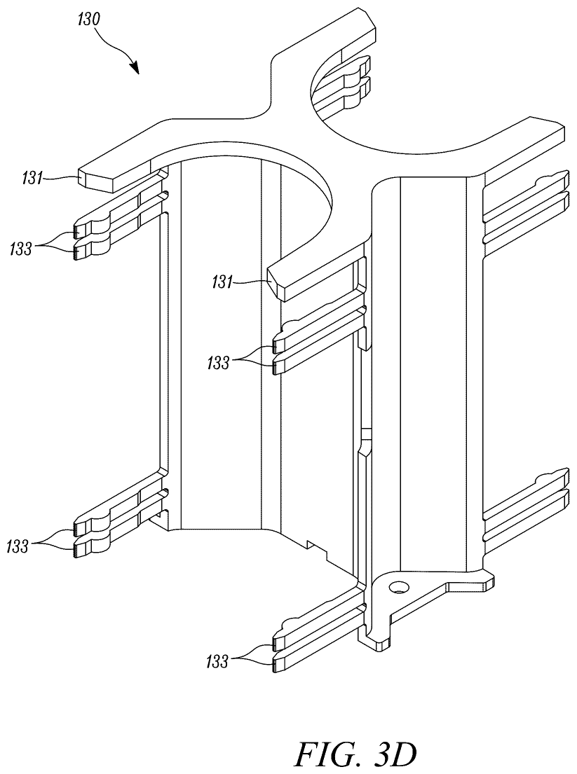

FIGS. 3A through 3C are different views of the consumables container loading/unloading system 100, according to an example embodiment of the present disclosure. Some of the components of the consumables container loading/unloading system 100 are not shown at FIGS. 3A through 3C for illustrative purposes. FIG. 3A is a top view of the consumables container loading/unloading system 100. FIG. 3B is a side view of the consumables container loading/unloading system 100. FIG. 3C is a perspective view of the consumables container loading/unloading system 100 from another angle.

Referring to FIGS. 2 through 3C, the consumables container loading/unloading system 100 includes a consumables container loading/unloading unit 102 (i.e., a consumables container loading/unloading apparatus) including at least a first container holding position C1 and a second container holding position C2. In some embodiments, the consumables container loading/unloading unit 102 can be interchangeably referred to herein as “a consumables container loading/unloading apparatus 102”. Each of the first container holding position C1 and the second container holding position C2 is configured to removably hold at least one of the consumables containers 20. The consumables container loading/unloading unit 102 is configured to receive the consumables containers 20 from the operator of the automated analyzer 10. As shown at FIG. 3A, the first container holding position C1 is configured to removably hold a first consumables container 20a from the consumables containers 20. The second container holding position C2 is configured to removably hold a second consumables container 20b from the consumables containers 20. As illustrated at FIG. 3B, the first consumables container 20a has a first opening O1 and the second consumables container 20b has a second opening O2.

The consumables container loading/unloading system 100 further includes at least one operator accessible container station 104 accessible by the operator. At least one of the first container holding position C1 and the second container holding position C2 is configured to directly receive the consumables containers 20 at the at least one operator accessible container station 104 from the operator. In the illustrated embodiment of FIGS. 3A through 3C, the at least one operator accessible container station 104 includes only a single operator accessible container station 104 serving at one of the first container holding position C1 and the second container holding position C2. Within a cycle time of the analyzer arrangement 12, the first container holding position C1 serves at the single operator accessible container station 104 (e.g., as shown at FIG. 3A). In a next cycle time of the analyzer arrangement 12, the second container holding position C2 may serve at the single operator accessible container station 104. In some embodiments, the single operator accessible container station 104 can be interchangeably referred to as “the operator accessible container station 104”. Thus, it can be stated that the operator accessible container station 104 is accessible by the operator of the automated analyzer 10, such that at least one of the first container holding position C1 and the second container holding position C2 is configured to directly receive the consumables containers 20 at the operator accessible container station 104 from the operator.

The consumables container loading/unloading system 100 further includes at least one analyzer supply station 106. The liquid consumables 14 are delivered from the at least one analyzer supply station 106 to the automated analyzer 10. In the illustrated embodiment of FIGS. 3A through 3C, the at least one analyzer supply station 106 includes only a single analyzer supply station 106 spaced apart from the single operator accessible container station 104 and serving at the other of the first container holding position C1 and the second container holding position C2.

In one cycle time of the analyzer arrangement 12, the second container holding position C2 serves at the single analyzer supply station 106 (e.g., as shown at FIG. 3A). However, in another cycle time of the analyzer arrangement 12, the first container holding position C1 may serve at the single analyzer supply station 106. In some embodiments, the single analyzer supply station 106 can be interchangeably referred to as “an analyzer supply station 106”. Further, in the illustrated embodiment of FIGS. 3A through 3C, the single analyzer supply station 106 or the analyzer supply station 106 is not accessible by the operator of the automated analyzer 10. Thus, it can be stated that the liquid consumables 14 are delivered from the analyzer supply station 106 to the automated analyzer 10.

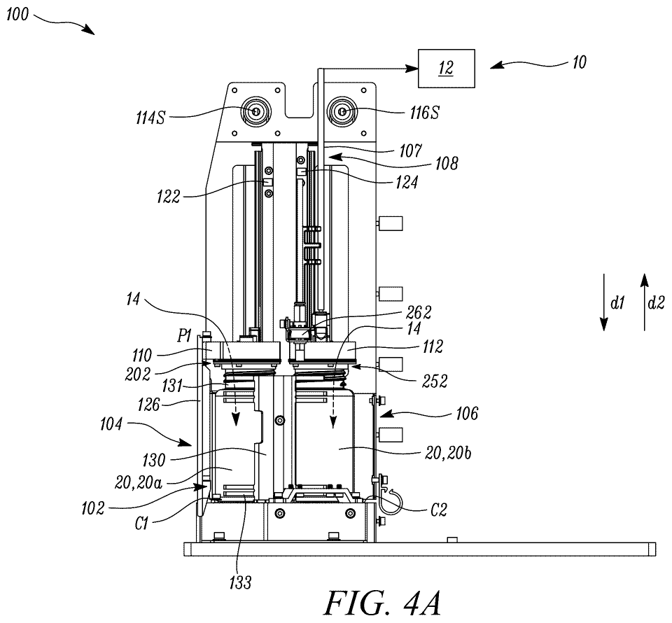

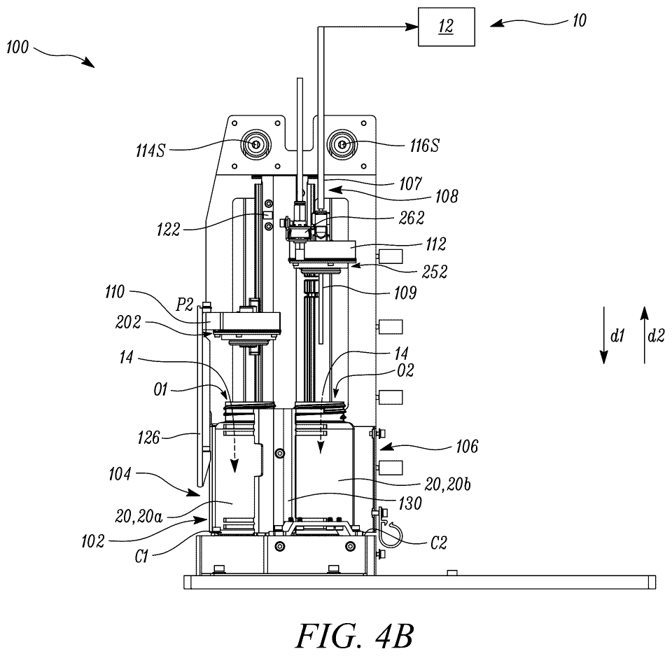

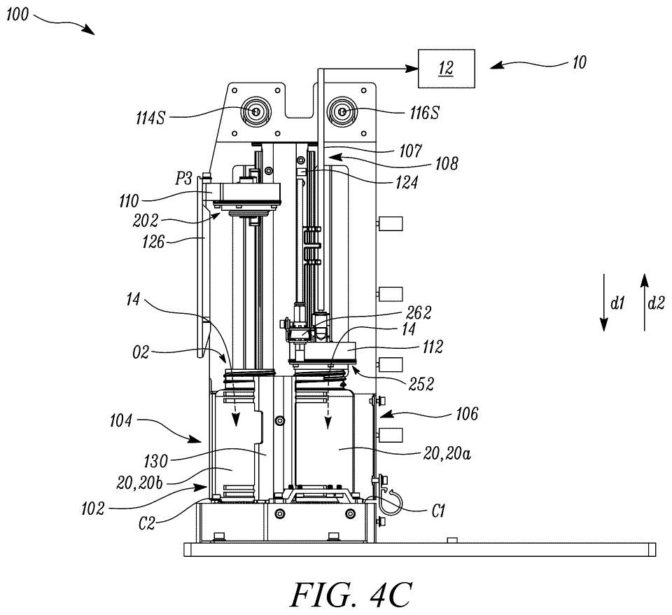

The consumables container loading/unloading system 100 further includes at least one fluid supply line 108 disposed at the at least one analyzer supply station 106. The at least one fluid supply line 108 is configured to connect with the consumables containers 20 and thereby deliver some of the liquid consumables 14 from the consumables containers 20 to the automated analyzer 10. In some embodiments, each of the at least one fluid supply line 108 includes a suction straw 109 (shown at FIG. 4B). The liquid consumables 14 are accessed by the suction straw 109 and delivered to the automated analyzer 10 when the at least one fluid supply line 108 is connected with the at least one of the consumables containers 20 at the at least one analyzer supply station 106. The suction straw 109 may be repaired or serviced in case of any faulty observation in the suction straw 109. In some embodiments, a portion of the suction straw 109 is surrounded by a sleeve 107 configured to limit exposure of the liquid consumables 14 to ambient light. As the liquid consumables 14 may be sensitive to the ambient light, the sleeve 107 acts as a shield cover for the suction straw 109 for limited exposure of the liquid consumables 14 to the ambient light. Further, the sleeve 107 may not present any chemical compatibility issues with the suction straw 109. Each of the at least one fluid supply line 108 is connected with the analyzer arrangement 12 to deliver the liquid consumables 14 to the analyzer arrangement 12 of the automated analyzer 10.

In the illustrated embodiment of FIGS. 3A through 3C, the at least one fluid supply line 108 includes a single fluid supply line 108 disposed or positioned at the single analyzer supply station 106. In some embodiments, the single fluid supply line 108 can be interchangeably referred to herein as “the fluid supply line 108”. Thus, the liquid consumables 14 are accessed by the suction straw 109 and delivered to the automated analyzer 10 when the single fluid supply line 108 is connected with one of the consumables containers 20 at the single analyzer supply station 106.

In some embodiments, the consumables container loading/unloading unit 102 includes a barrier 130 positioned on the rotary platform 101 in order to allow loading of only consumables containers 20 with predetermined dimensions and/or uncapped consumables containers 20. The barrier 130 may include an opening of a specific shape so as to receive the consumables containers with predetermined dimensions and/or uncapped consumables containers 20. For example, in the illustrated embodiment of FIG. 3D, the barrier 130 includes at least one pair of upper prongs 131 spaced apart from each other to define an opening that is sized and configured to receive a neck portion of an uncapped consumables container 20 with predetermined dimensions. More particularly, the opening defined by the at least one pair of upper prongs 131 may be sufficiently wide to permit receipt of the neck portion of an uncapped consumables container 20 between the at least one pair of upper prongs 131, while also being sufficiently narrow to prevent receipt of a cap of a capped consumables container 20 between the at least one pair of upper prongs 131, to thereby inhibit inadvertent loading of a capped consumables container 20. In the example shown, the barrier 130 also includes at least one pair of lower prongs 133 spaced apart from each other to define an opening that is sized and configured to receive a body portion of a consumables container with predetermined dimensions. More particularly, the opening defined by the at least one pair of lower prongs 133 may be sufficiently wide to permit receipt of the body portion of a consumables container 20 between the at least one pair of lower prongs 133. In some versions, the at least one pair of lower prongs 133 may be configured to grip the body portion of a loaded consumables container 20. In addition, or alternatively, the opening defined by the at least one pair of upper prongs 131 may be sufficiently narrow to prevent receipt of the body portion of a consumables container 20 between the at least one pair of upper prongs 131, to thereby inhibit inadvertent lifting of a loaded consumables container 20. For example, lower surfaces of the at least one pair of upper prongs 131 may confront and/or abut an upper surface of the body portion of a loaded consumables container 20.

In some embodiments, the consumables container loading/unloading system 100 further includes at least one reader 132 configured to read identifiers of the consumables containers 20 at the at least operator accessible container station 104. In the illustrated embodiment of FIGS. 3A through 3C, the at least one reader 132 includes a single reader 132 (can be interchangeably referred to herein as “a reader”). The reader 132 is configured to read identifiers of the consumables containers 20 at the operator accessible container station 104. Each of the at least one reader 132 may be a scanner, for example, a barcode reader, a QR code reader, or an RFID reader which may read out information from the identifiers of the consumables containers 20. The identifiers may include information related to the liquid consumables 14 contained in the consumables container 20. The information may include one or more analyses in which the liquid consumables 14 contained in consumables containers 20 may be used, the name of the liquid consumables 14, the expiration date of the liquid consumables 14, the volume of the liquid consumables 14, lot information, container information, and the like. In some embodiments, the identifiers may include a bar code, which may include encoded information and is optically read, as well as an RFID tag that may transmit the information stored via radio waves. As shown at FIG. 3A, the reader 132 is configured to read identifiers of the first consumables container 20a.

The consumables container loading/unloading system 100 further includes a controller 16 (shown at FIG. 2) communicably coupled to the consumables container loading/unloading unit 102 and the at least one fluid supply line 108. The controller 16 may be a programmable analog and/or digital device that can store, retrieve, and process data. In an application, the controller 16 may include a processor, a control circuit, a computer, a workstation, a microprocessor, a microcomputer, a central processing unit, a server, and/or any suitable device or apparatus.

In the illustrated embodiment of FIGS. 3A through 3C, the consumables container loading/unloading apparatus 102 is configured to move the first container holding position C1 between the operator accessible container station 104 and the analyzer supply station 106 and is further configured to move the second container holding position C2 between the analyzer supply station 106 and the operator accessible container station 104. In other words, the controller 16 is configured to control the consumables container loading/unloading unit 102 to move the first container holding position C1 between the operator accessible container station 104 and the analyzer supply station 106. The controller 16 is further configured to control the consumables container loading/unloading unit 102 to move the second container holding position C2 between the analyzer supply station 106 and the operator accessible container station 104.

The consumables container loading/unloading system 100 or the consumables container loading/unloading apparatus 102 further includes an actuator 118 (e.g., an actuator stack) communicably coupled to the controller 16. The controller 16 is configured to control the actuator stack 118 to move the first container holding position C1 between the operator accessible container station 104 and the analyzer supply station 106. The controller 16 is further configured to control the actuator stack 118 to move the second container holding position C2 between the analyzer supply station 106 and the operator accessible container station 104. In some embodiments, the actuator stack 118 can be interchangeably referred to herein as “a third actuator stack 118”. In other words, the actuator 118 is configured to simultaneously move the first container holding position C1 between the operator accessible container station 104 and the analyzer supply station 106 and the second container holding position C2 between the analyzer supply station 106 and the operator accessible container station 104.

Specifically, the third actuator stack 118 includes a third drive motor 118M, a third shaft 118S, a third brake 118B (shown at FIG. 2), and a third encoder 118E. The third drive motor 118M moves the first container holding position C1 between the operator accessible container station 104 and the analyzer supply station 106, and further moves the second container holding position C2 between the analyzer supply station 106 and the operator accessible container station 104. The third drive motor 118M may be a stepper motor, or a servo motor.

The third drive motor 118M moves the first container holding position C1 and the second container holding position C2 through the third shaft 118S and a gear train 117. The controller 16 may further control the third brake 118B to hold the first container holding position C1 and the second container holding position C2 in a desirable position based on various operations being performed in the consumables container loading/unloading system 100 and the automated analyzer 10. While the third actuator stack 118 of the present example includes a third brake 118B, it will be appreciated that the third brake 118B may be omitted, such as in cases where the friction within the third drive motor 118M is sufficient to prevent rotation of the third shaft 118S and thereby hold the first container holding position C1 and the second container holding position C2 in a desirable position when the third drive motor 118M is inactive.

The third encoder 118E is attached to the third drive motor 118M and may determine a position of the third shaft 118S by measuring degrees of rotation of the third shaft 118S. The third encoder 118E may provide an output corresponding to the rotation of the third shaft 118S, either in terms of voltage pulses or absolute angular position. The third encoder 118E may provide a signal indicating a position of the first container holding position C1 and the second container holding position C2.

In the illustrated embodiment of FIGS. 3A through 3C, the third actuator stack 118 comprises a rotary actuator configured to move the first container holding position C1 between the operator accessible container station 104 and the analyzer supply station 106 by rotating the first container holding position C1 by 180 degrees. The rotary actuator is further configured to move the second container holding position C2 between the analyzer supply station 106 and the operator accessible container station 104 by rotating the second container holding position C2 by 180 degrees. In other words, the rotary actuator moves the first and second container holding positions C1, C2 a half spin. In the depicted embodiment, the consumables container loading/unloading unit 102 includes a rotary platform 101 on which each of the first container holding position C1 and the second container holding position C2 rotate by 180 degrees simultaneously. Therefore, the third actuator stack 118 may move (i.e., rotate) the first container holding position C1 and the second container holding position C2 on the rotary platform 101 by transmitting power to the rotary platform 101 through the gear train 117 and the third shaft 118S.

In the illustrated embodiment of FIGS. 3A through 3C, the consumables container loading/unloading system 100 further includes an access member 126 (e.g., a door) configured to move vertically between an open position P3, a lockout position P2, and a closed position P1. FIG. 4A is a side view of the consumables container loading/unloading system 100, when the access member 126 is in the closed position P1. FIG. 4B is a side view of the consumables container loading/unloading system 100, when the access member 126 is in the lockout position P2. FIG. 4C is a side view of the consumables container loading/unloading system 100, when the access member 126 is in the open position P3. The first container holding position C1 and the second container holding position C2 are disposed opposite to each other when viewed from the access member 126. For movement of the access member 126 from the open position P3 to the closed position P1 or the lockout position P2, the access member 126 moves at least vertically along a first direction d1. For movement of the access member 126 from the closed position P1 to the open position P3 or the lockout position P2, the access member 126 moves at least vertically along a second direction d2 opposite to the first direction d1. The access member 126 may be a slidable door that controls access to the operator accessible container station 104.

With reference to FIG. 4A, in the closed position P1 of the access member 126, the access member 126 is disposed adjacent to the operator accessible container station 104 and opposite to the analyzer supply station 106, such that the operator is not allowed to load/unload the consumables containers 20 to/from the consumables container loading/unloading unit 102. Therefore, in the closed position P1 of the access member 126, none of the first container holding position C1 and the second container holding position C2 can directly receive the consumables containers 20 at the operator accessible container station 104 from the operator. In the illustrated embodiment of FIG. 4A, the first consumables container 20a is received in the first container holding position C1 at the operator accessible container station 104 and the second consumables container 20b is received in the second container holding position C2 at the analyzer supply station 106.

With reference to FIG. 4B, in at least the lockout position P2 and not in the closed position P1 of the access member 126, the first container holding position C1 is moved between the operator accessible container station 104 and the analyzer supply station 106, and the second container holding position C2 is moved between the analyzer supply station 106 and the operator accessible container station 104. In some embodiments, in at least the lockout position P2 and not in the closed position P1 of the access member 126, the first container holding position C1 is rotated by 180 degrees between the operator accessible container station 104 and the analyzer supply station 106, and the second container holding position C2 is rotated by 180 degrees between the analyzer supply station 106 and the operator accessible container station 104. In the illustrated embodiment of FIG. 4B, each of the first container holding position C1 and the second container holding position C2 is illustrated as being moved between the operator accessible container station 104 and the analyzer supply station 106.

With reference to FIG. 4C, in the open position P3 of the access member 126, the operator is allowed to load/unload the consumables containers 20 to/from the consumables container loading/unloading unit 102 at the operator accessible container station 104. In response to the movement of the first container holding position C1 from the operator accessible container station 104 to the analyzer supply station 106, the first container holding position C1 is illustrated as serving at the analyzer supply station 106, and the access member 126 is in the open position P3. In response to the movement of the second container holding position C2 from the analyzer supply station 106 to the operator accessible container station 104, the second container holding position C2 is illustrated as serving at the operator accessible container station 104, and the access member 126 is in the open position P3. When the access member 126 is in the open position P3, the operator is allowed to load/unload the consumables containers 20 to/from the consumables container loading/unloading unit 102.

With reference to FIGS. 4A through 4C, the controller 16 is further configured to control the fluid supply line 108 to disconnect the fluid supply line 108 from a first one of the consumables containers 20 (i.e., the second consumables container 20b) positioned at the analyzer supply station 106. The controller 16 is further configured to control the consumables container loading/unloading unit 102 to move the first one of the consumables containers 20 (i.e., the second consumables container 20b) away from the analyzer supply station 106 by moving a corresponding one of the first container holding position C1 and the second container holding position C2 (i.e., the second container holding position C2 with reference to FIGS. 4A and 4B) located at the analyzer supply station 106 to the operator accessible container station 104. The controller 16 is further configured to control the consumables container loading/unloading unit 102 to move a second one of the consumables containers 20 (i.e., the first consumables container 20a) to the analyzer supply station 106 by moving the corresponding other of the first container holding position C1 and the second container holding position C2 (i.e., the first container holding position C1 with reference to FIGS. 4A and 4B) located at the operator accessible container station 104 to the analyzer supply station 106. The controller 16 is further configured to control the fluid supply line 108 to connect the fluid supply line 108 with the second one of the consumables containers (i.e., the first consumables container 20a) positioned at the analyzer supply station 106. Therefore, the controller 16 is configured to control the consumables container loading/unloading unit 102 and the fluid supply line 108 to perform the aforementioned steps within the cycle time of the analyzer arrangement 12 and thereby provide loading/unloading of the consumables containers 20 during the cycle time of the analyzer arrangement 12. Hence, once the fluid supply line 108 is connected with the first consumables container 20a positioned at the analyzer supply station 106, the operator is allowed to replace the first one of the consumables containers 20 (i.e., the second consumables container 20b) positioned at the operator accessible container station 104 with another consumables container 20. The operator may replace the consumables containers 20 within the cycle time of the analyzer arrangement 12. However, the operator may take much longer than the cycle time to replace the consumables containers 20. For example, the operator may wait for the liquid consumables 14 of the consumables container 20 at the analyzer supply station 106 to be drawn down and then replace the consumables container 20 at the operator accessible container station 104 shortly before the consumables container 20 at the analyzer supply station 106 is empty. As long as the consumables container 20 at the analyzer supply station 106 continues to have a serviceable amount of the liquid consumables 14, the automated analyzer 10 can continue running without missing a cycle or needing to be shut down.

The operation in the above paragraph can also be summarized by stating that the consumables container loading/unloading apparatus 102 is configured to sequentially (with steps b and c optionally occurring simultaneously):
a) disconnect the fluid supply line 108 from the first one of the consumables containers positioned at the analyzer supply station 106,
b) move the first one of the consumables containers 20 away from the analyzer supply station 106,
c) move the second one of the consumables containers 20 to the analyzer supply station 106, and
d) connect the fluid supply line 108 to the second one of the consumables containers 20 when positioned at the analyzer supply station 106
   all within the cycle time and thereby provide loading of the consumables containers 20 to the automated analyzer 10 on-the-fly. The term “on-the-fly” indicates that the automated analyzer 10 may continue to run without interruption, delay, etc. and in its regular fashion while the consumables container loading/unloading system 100 is manipulating the consumables containers 20 to supply the liquid consumables 14 to the automated analyzer.

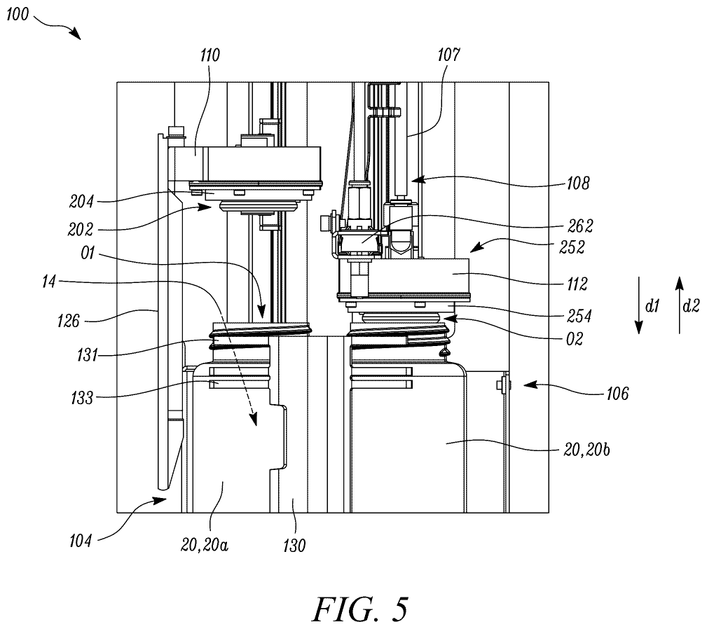

FIG. 5 is an enlarged view of a portion of the consumables container loading/unloading system 100 shown at FIG. 3B, according to an embodiment of the present disclosure. Referring to FIGS. 4A through 5, the consumables container loading/unloading system 100 further includes a first arm 110 fixedly attached to the access member 126 and communicably coupled to the controller 16 (shown at FIG. 2). The first arm 110 is configured to move at least vertically along the first direction d1 in order to move the access member 126 from the open position P3 towards the lockout position P2 and/or the closed position P1. The first arm 110 is further configured to move at least vertically along the second direction d2 opposite to the first direction d1 in order to move the access member 126 from the closed position P1 towards the lockout position P2 and/or the open position P3.

Referring to FIGS. 2 through 5, in some embodiments, the consumables container loading/unloading system 100 further includes a first actuator 114 (e.g., an actuator stack) communicably coupled to the controller 16 (shown at FIG. 2). The controller 16 is further configured to control the first actuator stack 114 to move the first arm 110 at least vertically along the first direction d1 and the second direction d2 in order to move the access member 126 between the open position P3, the lockout position P2, and the closed position P1. Specifically, the first actuator stack 114 includes a first drive motor 114M, a first shaft 114S, a first brake 114B, and a first encoder 114E. The first drive motor 114M moves the first arm 110 at least vertically along the first direction d1 and the second direction d2 in order to move the access member 126 between the open position P3, the lockout position P2, and the closed position P1. The first drive motor 114M may be a stepper motor, or a servo motor.

In some embodiments, the first drive motor 114M actuates a first belt pulley mechanism 113 (shown at FIG. 3C) to move the first arm 110 at least vertically along the first direction d1 and the second direction d2 along a linear rail. The first arm 110 as well as the access member 126 move at least vertically along the first direction d1 or the second direction d2 upon actuation of the first belt pulley mechanism 113 by the first drive motor 114M. In other words, the first drive motor 114M transmits power to the first arm 110 through the first belt pulley mechanism 113 and the first shaft 114S. The controller 16 may further control the first brake 114B to hold the first arm 110 in a desirable position based on various operations being performed in the consumables container loading/unloading system 100 and the automated analyzer 10. In some cases where there is power outage, the first brake 114B may hold the first arm 110, such that the opening O1 of the first consumables container 20a is being sealed, which will be described later in the description. While the first actuator stack 114 of the present example includes a first brake 114B, it will be appreciated that the first brake 114B may be omitted, such as in cases where the friction within the first drive motor 114M is sufficient to prevent rotation of the first shaft 114S and thereby hold the first arm 110 in a desirable position when the first drive motor 114M is inactive.

The first encoder 114E is attached to the first drive motor 114M and may determine a position of the first shaft 114S by measuring degrees of rotation of the first shaft 114S. The first encoder 114E may provide an output corresponding to the rotation of the first shaft 114S, either in terms of voltage pulses or absolute angular position. In some applications, the first encoder 114E may consist of two plates, with one plate fixed and another plate with unique coding attached to the first shaft 114S. As the first shaft 114S rotates, these plates rotate relative to each other without making contact. An electric field between these plates is influenced in response to the relative rotation and that variation represents the angular position of the first shaft 114S in the form of an electric signal. The first encoder 114E may provide a signal indicating a position of the first arm 110 relative to the consumables container 20 at the operator accessible container station 104.

The consumables container loading/unloading system 100 further includes a first home sensor 122 disposed on the first arm 110 or disposed on a frame adjacent to the first arm 110 to sense a position of the first arm 110. The first home sensor 122 does not move relative to the movement of the first arm 110. The first home sensor 122 may sense a presence or absence of the first arm 110 at a home position (not shown). In other words, the first home sensor 122 is used for homing the first arm 110. A physical location of the first home sensor 122 is unchanged when the first arm 110 moves at least vertically along the first direction d1 as well as when the first arm 110 moves at least vertically along the second direction d2. In some embodiments, the first home sensor 122 may be a proximity sensor, a magnetic sensor, or a capacitive sensor. In other embodiments, the first home sensor 122 may be a slotted optical sensor or a limit switch. As the first home sensor 122 is configured to sense the presence or absence of the first arm 110 at the home position, the first home sensor 122 is used as a position reference for sensing a movement of the first arm 110. In this way, a position of the first arm 110 may be determined by the first home sensor 122. The controller 16 may precisely adjust a timing of the movement of the first arm 110 based on the position of the first arm 110 determined by the first home sensor 122.

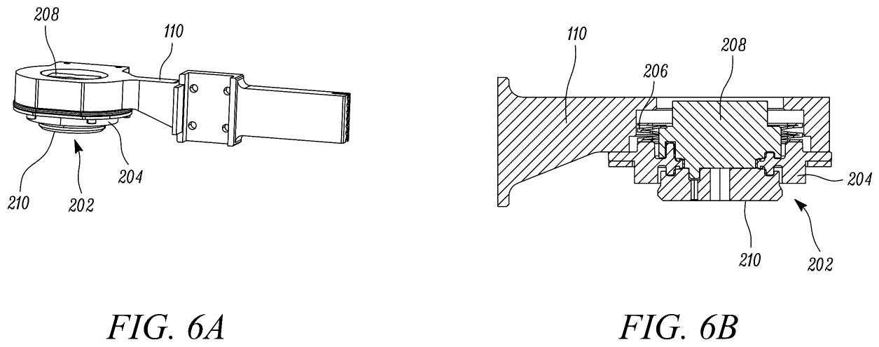

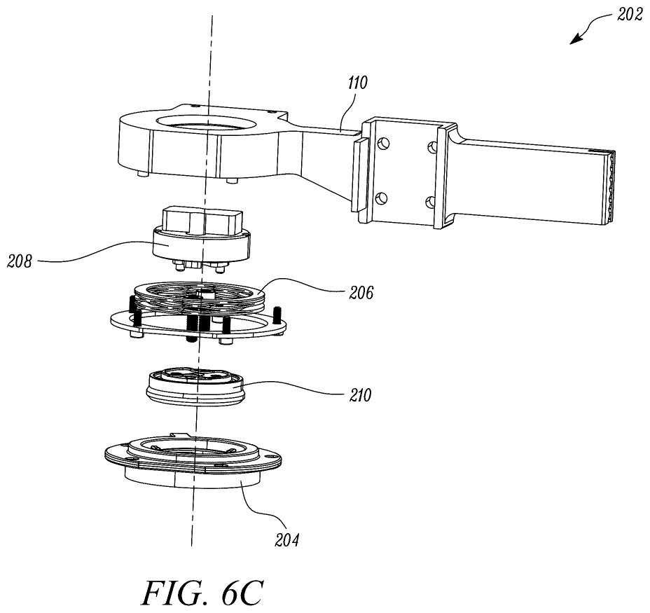

The consumables container loading/unloading system 100 further includes a first lock assembly 202 fixedly attached to the first arm 110. Since the access member 126 is also fixedly attached to the first arm 110, movements of the first arm 110 causes corresponding movements of the first lock assembly 202 and the access member 126. FIGS. 6A through 6C are different views of the first arm 110 and the first lock assembly 202, according to an embodiment of the present disclosure. FIG. 6A is a perspective view of the first lock assembly 202 and a portion of the first arm 110. FIG. 6B is a cross-sectional view of the first lock assembly 202 and the first arm 110. FIG. 6C is an exploded view of the first lock assembly 202 and the first arm 110.

Referring to FIGS. 4A through 6C, the first lock assembly 202 includes a first sealing ring 204 configured to seal an opening (e.g., the first opening O1 or the second opening O2) of one of the consumables containers 20 held in one of the first container holding position C1 and the second container holding position C2 at the operator accessible container station 104 when the fluid supply line 108 is connected with the other of the consumables containers 20 at the analyzer supply station 106 and when the access member 126 is in the closed position P1. In other words, with reference to FIG. 4A, the first sealing ring 204 is configured to seal the first opening O1 of the first consumables container 20a held in one of the first container holding position C1 and the second container holding position C2 (i.e., the first container holding position C1 as shown at FIG. 4A) at the operator accessible container station 104.

The first lock assembly 202 further includes a first spring 206 to bias the first sealing ring 204 towards the opening of the one of the consumables containers 20. Specifically, with reference to FIG. 4A, the first spring 206 biases the first sealing ring 204 towards the first opening O1 of the first consumables container 20a. The first lock assembly 202 further includes first upper and lower manifolds 208, 210 configured to hold the first sealing ring 204 therebetween.

Further, the first sealing ring 204 is not configured to seal the opening (the first opening O1 or the second opening O2) of the one of the consumables containers 20 when the access member 126 is in one of the lockout position P2 (as shown at FIG. 4B) and the open position P3 (as shown at FIG. 4C). Therefore, the first sealing ring 204 does not seal the first opening O1 of the first consumables container 20a when the access member 126 is in one of the lockout position P2 and the open position P3. Since the first scaling ring 204 does not seal the first opening O1 of the first consumables container 20a when the access member 126 is in one of the lockout position P2 and the open position P3, the first consumables container 20a is free to move between the operator accessible container station 104 and the analyzer supply station 106 in the lockout position P2. The first opening O1 of the first consumables container 20a is sealed in the closed position P1 of the access member 126. The movement of the first arm 110 to unseal the first consumables container 20a causes a corresponding movement of the access member 126 from the closed position P1 to the lockout position P2. The lockout position P2 is between the open position P3 and the closed position P1 relative to a vertical axis.

The first lock assembly 202 including the first sealing ring 204 may also limit the ingress of gases, such as oxygen and carbon dioxide, to a great extent into the consumables containers 20 at the first container holding position C1 and/or the second container holding position C2. Therefore, the first lock assembly 202 may reduce an exposure of the liquid consumables 14 in a consumables container 20 at the operator accessible container station 104 to the gases, such as oxygen, carbon dioxide, and so on. Thus, constant or continuous diffusion of gas (e.g., oxygen and/or carbon dioxide) from the atmosphere into the liquid consumables (e.g., substrate) of the consumables containers (e.g., substrate container), which may otherwise lead to formation of carbonic acid, reduced pH of the substrate, erroneous test results, etc. is prevented. This has been found to be effective even in environments with poor air quality (e.g., 5,000 ppm CO₂). Significant loss of liquid due to evaporation is also prevented.

The consumables container loading/unloading system 100 further includes a second arm 112 fixedly attached to the at least one fluid supply line 108 (i.e., the fluid supply line 108) and communicably coupled to the controller 16 (shown at FIG. 2). The second arm 112 is configured to move at least vertically along the first direction d1 in order to connect the at least one fluid supply line 108 with the second consumables container 20b at the at least one analyzer supply station 106. In other words, the second arm 112 is configured to move at least vertically along the first direction d1 in order to connect the fluid supply line 108 with one of the consumables containers 20 (i.e., the second consumables container 20b shown at FIG. 4A) at the analyzer supply station 106. Specifically, as shown at FIG. 4A, the fluid supply line 108 is connected with one of the consumables containers 20 (i.e., the second consumables container 20b) due to movement of the second arm 112 at least vertically along the first direction d1. The second arm 112 is further configured to move at least vertically along the second direction d2 in order to disconnect the at least one fluid supply line 108 from the second consumables container 20b. In other words, the second arm 112 is configured to move at least vertically along the second direction d2 in order to disconnect the fluid supply line 108 from the one of the consumables containers 20 (i.e., the second consumables container 20b shown at FIG. 4B). As shown at FIG. 4B, the fluid supply line 108 is disconnected from the one of the consumables containers 20 (i.e., the second consumables container 20b) due to movement of the second arm 112 at least vertically along the second direction d2.

Referring to FIGS. 2 through 6B, in some embodiments, the consumables container loading/unloading system 100 further includes a second actuator 116 (e.g., an actuator stack) communicably coupled to the controller 16 (shown at FIG. 2). The controller 16 is further configured to control the second actuator stack 116 to move the second arm 112 at least vertically along the first direction d1 in order to connect the fluid supply line 108 with the one of the consumables containers 20 (i.e., the second consumables container 20b shown at FIG. 4A) at the analyzer supply station 106. The controller 16 is further configured to control the second actuator stack 116 to move the second arm 112 at least vertically along the second direction d2 in order to disconnect the fluid supply line 108 from the one of the consumables containers 20 (i.e., the second consumables 20b shown at FIG. 4B) at the analyzer supply station 106. Specifically, the second actuator stack 116 includes a second drive motor 116M, a second shaft 116S, a second brake 116B, and a second encoder 116E, the second drive motor 116M moves the second arm 112 at least vertically along the first direction d1 and the second direction d2 in order to connect and disconnect the fluid supply line 108 to and from the consumables container 20 at the analyzer supply station 106. The second drive motor 116M may be a stepper motor, or a servo motor.

In some embodiments, the second drive motor 116M actuates a second belt pulley mechanism 115 (shown at FIG. 3C) to move the second arm 112 at least vertically along the first direction d1 and the second direction d2 along a linear rail. The second arm 112 moves at least vertically along the first direction d1 and the second direction d2 upon actuation of the second belt pulley mechanism 115 by the second drive motor 116M. In other words, the second drive motor 115M transmits power to the second arm 112 through the second belt pulley mechanism 115 and the second shaft 116S. The controller 16 may further control the second brake 116B to hold the second arm 112 in a desirable position based on various operations being performed in the consumables container loading/unloading system 100 and the automated analyzer 10. In some cases where there is power outage, the second brake 116B may hold the second arm 112, such that the opening O2 of the second consumables container 20b is being sealed, which will be described later in the description. While the second actuator stack 116 of the present example includes a second brake 116B, it will be appreciated that the second brake 116B may be omitted, such as in cases where the friction within the second drive motor 116M is sufficient to prevent rotation of the second shaft 116S and thereby hold the second arm 112 in a desirable position when the second drive motor 116M is inactive.

The second encoder 116E is attached to the second drive motor 116M and may determine a rotational position of the second shaft 116S by measuring degrees of rotation of the second shaft 116S. The second encoder 116E may provide an output corresponding to the rotation of the second shaft 116S, either in terms of voltage pulses or absolute angular position. The second encoder 116E may provide a signal indicating a position of the second arm 112 relative to the consumables container 20 at the analyzer supply station 106.

The consumables container loading/unloading system 100 further includes a second home sensor 124 (shown at FIGS. 4A and 4C) disposed on the second arm 112 or disposed on the frame adjacent to the second arm 112 to sense a position of the second arm 112. The second home sensor 124 does not move relative to the movement of the second arm 110. The second home sensor 124 may sense a presence or absence of the second arm 112 at a corresponding home position (not shown) pertaining to the second home sensor 124. The second home sensor 124 may be functionally equivalent to the first home sensor 122. The controller 16 may precisely adjust a timing of the movement of the second arm 112 based on the position of the second arm 112 determined by the second home sensor 124.

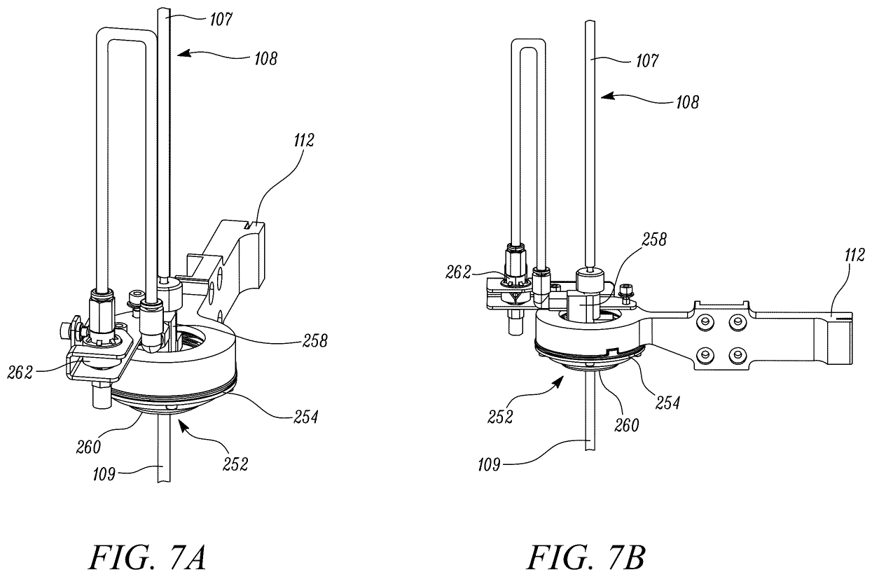

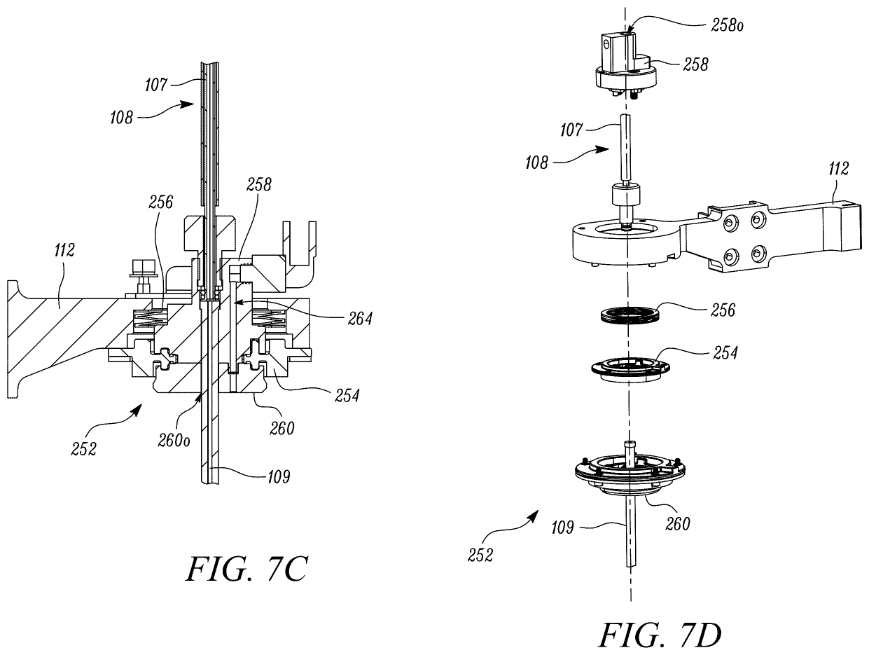

The consumables container loading/unloading system 100 further includes a second lock assembly 252 fixedly attached to the second arm 112. FIGS. 7A through 7D are different views of the second arm 112 and the second lock assembly 252, according to an embodiment of the present disclosure. FIGS. 7A and 7B are different perspective views of the second lock assembly 252 and a portion of the second arm 112. FIG. 7C is a cross-sectional view of the second lock assembly 252 and the second arm 112. FIG. 7D is an exploded view of the second lock assembly 252 and the second arm 112.

Referring to FIGS. 4A through 7D, the second lock assembly 252 includes a second sealing ring 254 configured to seal an opening of one of the consumables containers 20 held in one of the first container holding position C1 and the second container holding position C2 at the analyzer supply station 106 when the fluid supply line 108 is connected with the one of the consumables containers 20 at the analyzer supply station 106. In other words, with reference to FIG. 4A, the second sealing ring 254 is configured to seal the second opening O2 of the second consumables container 20b held in one of the first container holding position C1 and the second container holding position C2 (i.e., the rust second container holding position C2 as shown at FIG. 4A) at the analyzer supply station 106.

The second lock assembly 252 further includes a second spring 256 to bias the second sealing ring 254 towards the opening of the one of the consumables containers 20. Specifically, with reference to FIG. 4A, the second spring 256 biases the second sealing ring 254 towards the second opening O2 of the second consumables container 20b. The second lock assembly 252 further includes second upper and lower manifolds 258, 260 configured to hold the second sealing ring 254 therebetween. Each of the second upper and lower manifolds 258, 260 includes an opening for receiving the suction straw 109 therethrough. The second upper manifold 258 includes an opening 258o and the second lower manifold 260 includes an opening 260o for receiving the suction straw 109 therethrough.

The second lock assembly 252 including the second sealing ring 254 may limit the ingress of gases, such as oxygen and carbon dioxide, to a great extent into the consumables containers 20 at the first container holding position C1 and/or the second container holding position C2. Therefore, the second lock assembly 252 may reduce an exposure of the liquid consumables 14 in a consumables container 20 at the analyzer supply station 106 to the gases, such as oxygen, carbon dioxide, and so on. Thus, constant or continuous diffusion of gas (e.g., oxygen and/or carbon dioxide) from the atmosphere into the liquid consumables (e.g., substrate) of the consumables containers (e.g., substrate container), which may otherwise lead to formation of carbonic acid, reduced pH of the substrate, erroneous test results, etc. is prevented. This has been found to be effective even in environments with poor air quality (e.g., 5,000 ppm CO₂). Significant loss of liquid due to evaporation is also prevented.

In some embodiments, the second lock assembly 252 further includes a second check valve 262 configured to allow a flow of at least one gas into one of the consumables containers 20 at the analyzer supply station 106 when the fluid supply line 108 is connected with the one of the consumables containers 20 and some of the liquid consumables 14 is being delivered to the automated analyzer 10. In some embodiments, the second check valve 262 can be interchangeably referred to herein as “a check valve 262”. Specifically, with reference to FIG. 4A, the second check valve 262 is configured to allow the flow of the at least one gas into the second consumables container 20b at the at least one analyzer supply station 106 when the at least one fluid supply line 108 is connected with the second consumables container 20b and some of the liquid consumables 14 is being delivered to the automated analyzer 10. The flow of the at least one gas into the second consumables container 20b may prevent vacuum or negative internal pressure from forming within the second consumables container 20b during the connection of the fluid supply line 108 with the second consumables container 20b. The at least one gas may include ambient air, or an inert gas, such as argon. However, the second check valve 262 does not allow constant diffusion of gas (e.g., oxygen and/or carbon dioxide) from the atmosphere into the liquid consumables 14 of the consumables containers 20, which may otherwise lead to formation of carbonic acid, reduced pH of the liquid, and erroneous test results. The second lock assembly 252 may further prevent excessive loss of liquid due to evaporation. The second check valve 262 may be an electrically actuated valve.

The second lock assembly 252 further includes a second vent 264 (shown at FIG. 7C) disposed in fluid communication with the second check valve 262. In some embodiments, the second vent 264 can be interchangeably referred to herein as “a vent 264”. The second vent 264 extends at least partially through at least one of the second upper and lower manifolds 258, 260. The second vent 264 is disposed in fluid communication with one of the consumables containers when the fluid supply line 108 is connected with the one of the consumables containers 20 at the analyzer supply station 106. Specifically, the second vent 264 is disposed in fluid communication with the second consumables container 20b when the at least one fluid supply line 108 is connected with the second consumables container 20b at the at least one analyzer supply station 106. The second vent 264 allows the air trapped inside the second check valve 262 to flow out of the second lock assembly 252.

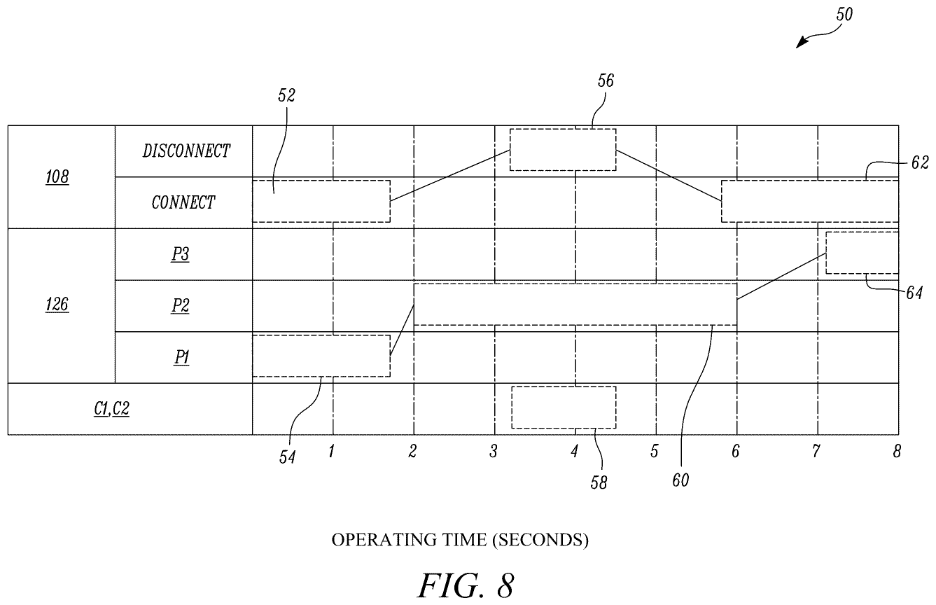

FIG. 8 is a timing diagram 50 depicting various operations in the consumables container loading/unloading system 100 for loading/unloading of the consumables containers 20, according to an embodiment of the present disclosure. The timing diagram 50 depicts the operations within an operating cycle of the consumables container loading/unloading system 100 (which, when activated, is coincident with an operating cycle of the automated analyzer 10). For example, the operating cycle time in this exemplary embodiment is 8 seconds. However, in other exemplary embodiments, the operating cycle time may be 12 seconds or 16 seconds. In the illustrated exemplary embodiment of FIG. 8, the timing diagram 50 depicts operations 52, 54, 56, 58, 60, 62, 64.

Referring to FIGS. 4A through 8, the controller 16 is configured to control the second arm 112 to move the second arm 112 at least vertically along the first direction d1 in order to connect the fluid supply line 108 with one of the consumables containers 20 at the analyzer supply station 106 and seal, via the second lock assembly 252, the opening of the one of the consumables containers 20 at the analyzer supply station 106. Specifically, as shown at FIG. 4A, the second lock assembly 252 seals the second opening O2 of the second consumables container 20b at the analyzer supply station 106. The controller 16 is further configured to control the fluid supply line 108 to deliver the liquid consumables 14 to the automated analyzer 10 when the fluid supply line 108 is connected with the one of the consumables containers 20 (i.e., the second consumables container 20b shown at FIG. 4A) at the analyzer supply station 106.

Therefore, at the operation 52, the second lock assembly 252 seals the second opening O2 of the second consumables container 20b and the fluid supply line 108 delivers the liquid consumables 14 from the second consumables container 20b to the automated analyzer 10. The controller 16 is further configured to move the first arm 110 at least vertically along the first direction d1 in order to seal, via the first lock assembly 202, the opening of the other of the consumables containers 20 at the operator accessible container station 104 during the transfer of the liquid consumables 14 to the automated analyzer 10. In other words, the controller 16 is further configured to move the first arm 110 at least vertically along the first direction d1 in order to move the access member 126 to the closed position P1 and seal, via the first lock assembly 202, the first opening O1 of the first consumables container 20a at the operator accessible container station 104. The operation 54 is performed concurrently and over the same time duration as the operation 52. At the operation 54, the access member 126 is in the closed position P1 (shown at FIG. 4A) and as a result, the first lock assembly 202 seals the first opening O1 of the first consumables container 20a.

The controller 16 is further configured to control each of the first arm 110 and the second arm 112 to move each of the first arm 110 and the second arm 112 at least vertically along the second direction d2 when the transfer of the liquid consumables 14 from the one of the consumables containers 20 (i.e., the second consumables container 20b) to the automated analyzer 10 is completed. As shown at FIG. 4B, each of the first arm 110 and the second arm 112 is moved at least vertically along the second direction d2 relative to their positions shown at FIG. 4A. Particularly, the controller 16 is configured to control the first arm 110 to move the first arm 110 at least vertically along the second direction d2 in order to move the access member 126 from the closed position P1 to the lockout position P2. At the operation 60, the access member 126 is in the lockout position P2. The controller 16 is configured to control the second arm 112 to move the second arm 112 at least vertically along the second direction d2 in order to disconnect the fluid supply line 108 from the second consumables container 20b. At the operation 56, the fluid supply line 108 is disconnected from the second consumables container 20b.

Once the fluid supply line 108 is disconnected from the second consumables container 20b and the access member 126 is in the lockout position P2, the controller 16 is further configured to control the consumables container loading/unloading unit 102 to move the first container holding position C1 between the operator accessible container station 104 and the analyzer supply station 106 and to move the second container holding position C2 between the analyzer supply station 106 and the operator accessible container station 104, such that the other of the consumables container 20 (i.e., the first consumables container 20a) is positioned at the analyzer supply station 106. Therefore, the second consumables container 20b is positioned at the operator accessible container station 104, as shown at FIG. 4C. At the operation 58, the first container holding position C1 moves between the operator accessible container station 104 and the analyzer supply station 106, and the second container holding position C2 moves between the analyzer supply station 106 and the operator accessible container station 104.

Once the first consumables container 20a is positioned at the analyzer supply station 106 (shown at FIG. 4C), the controller 16 is further configured to control the second arm 112 to move the second arm 112 at least vertically along the first direction d1 in order to connect the fluid supply line 108 with the other of the consumables containers 20 (i.e., the first consumables container 20a) at the analyzer supply station 106 and seal, via the second lock assembly 252, the opening (i.e., the first opening O1) of the other of the consumables containers 20 (i.e., the first consumables container 20a) at the analyzer supply station 106. The controller 16 is further configured to control the fluid supply line 108 to deliver the liquid consumables 14 to the automated analyzer 10 when the fluid supply line 108 is connected with the other of the consumables containers 20 (i.e., the first consumables container 20a) at the analyzer supply station 106. At the operation 62, the second lock assembly 252 seals the first opening O1 of the first consumables container 20a and the fluid supply line 108 delivers the liquid consumables 14 from the first consumables container 20a to the automated analyzer 10.

Once the fluid supply line 108 is connected with the first consumables container 20a at the analyzer supply station 106, the controller 16 is further configured to control the first arm 110 to further move the first arm 110 at least vertically along the first direction d1 in order to move the access member 126 from the lockout position P2 to the open position P3, such that the operator is allowed to replace the one of the consumables containers 20 (i.e., the second consumables container 20b) at the operator accessible container station 104 with a new consumables container 20. At the operation 64, the access member 126 is in the open position P3. Moreover, during the operation 64, the new consumables container 20 is received in the one of the first container holding position C1 and the second container holding position C2 at the operator accessible container station 104. With reference to FIG. 4C, the new consumables container 20 would be received in the second container holding position C2 at the operator accessible container station 104.

In the illustrated embodiment of FIGS. 3A through 8, the consumables container loading/unloading unit 102 includes two container holding positions, i.e., the first container holding position C1 and the second container holding position C2. In some embodiments, the consumables container loading/unloading unit 102 includes at least one additional container holding position in addition to the first container holding position C1 and the second container holding position C2. In other words, in some embodiments, the consumables container loading/unloading apparatus 102 includes three or more container holding positions C1, C2.

The consumables container loading/unloading system 100 may enable manually loading/unloading of the consumables containers into or from the automated analyzer 10 while the analyzer arrangement is in the active mode. Therefore, the operator may not have to pause or interrupt one or more operations of the automated analyzer 10 in order to load/unload the one or more of the consumables containers 20 into or from the automated analyzer 10. This may prevent delays in a workflow of the automated analyzer 10 and subsequently improve a throughput of the automated analyzer 10. Further, the consumables container loading/unloading system 10 may prevent shortage of the liquid consumables 14 during the analysis of patient samples.

Further, as some of the liquid consumables 14 is being delivered to the automated analyzer 10 when the at least one fluid supply line 108 is connected with a consumables container 20 at the at least one analyzer supply station 106, the operator is allowed to replace a used or empty consumables container 20 with a new consumables container 20 at the at least one operator accessible container station 104. This may further decrease a time required to load the consumables containers 20 into the consumables containers loading/unloading unit 102, so that the liquid consumables 14 contained in the consumables containers 20 may be used when required for the analysis of the patient samples. In some cases, the operator may load or unload a consumables container 20 at the single operator accessible container station 104. However, in typical cases, the operator may take multiple cycles to remove the consumables container 20 at the single operator accessible container station 104 and replace it with a new consumables container 20.

Moreover, since the operator may not have to wait until completion of one or more operations before loading the consumables containers 20 into the automated analyzer 10, the operator may carry out other necessary tasks. This may also save time of the operator. Further, the consumables container loading/unloading system 100 may ensure operational safety. Therefore, the automated analyzer 10 may further be user friendly.

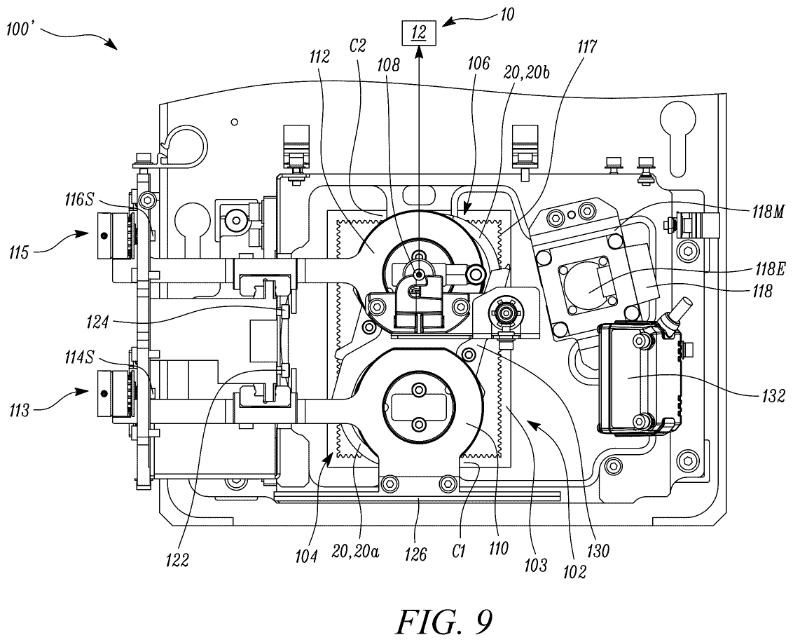

FIG. 9 is a top view of a consumables container loading/unloading system 100′ for the automated analyzer 10, according to another embodiment of the present disclosure. The consumables container loading/unloading system 100′ is substantially similar to the consumables container loading/unloading system 100 of FIG. 3A, with common components being referred to by the same numerals. However, in the consumables container loading/unloading system 100′, the third actuator 118 (e.g., the third actuator stack) comprises a linear actuator configured to move the first container holding position C1 at least piecewise linearly between the operator accessible container station 104 and the analyzer supply station 106. The linear actuator is further configured to move the second container holding position C2 at least piecewise linearly between the analyzer supply station 106 and the operator accessible container station 104. For such movement of the first container holding position C1 and the second container holding position C2, the gear train 117 may also be varied based on desirable application attributes. As shown at FIG. 9, the consumables container loading/unloading unit includes a track 103 (instead of a rotary platform) on which the first container holding position C1 moves at least piecewise linearly between the operator accessible container station 104 and the analyzer supply station 106, and the second container holding position C2 moves at least piecewise linearly between the analyzer supply station 106 and the operator accessible container station 104. In other embodiments, a linear actuator (e.g., an air cylinder) may be used. A functional advantage of the consumables container loading/unloading system 100′ is the same as that of the consumables container loading/unloading system 100 of FIG. 3A.

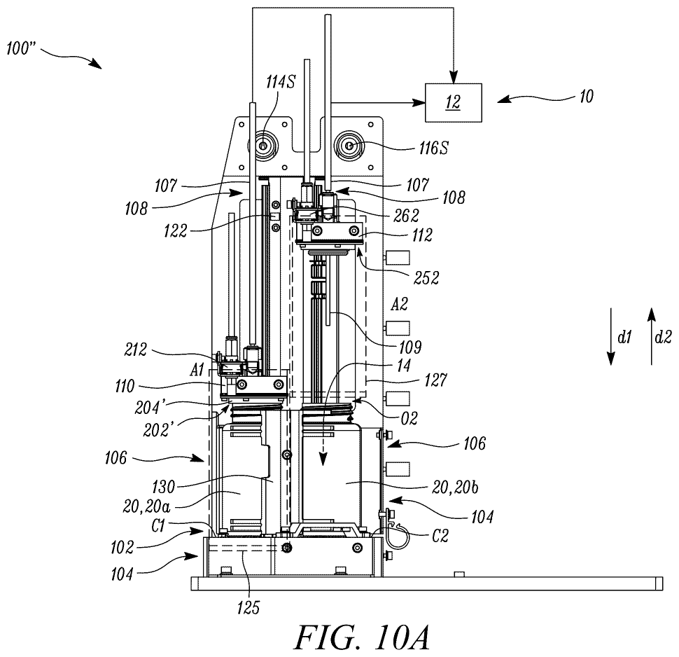

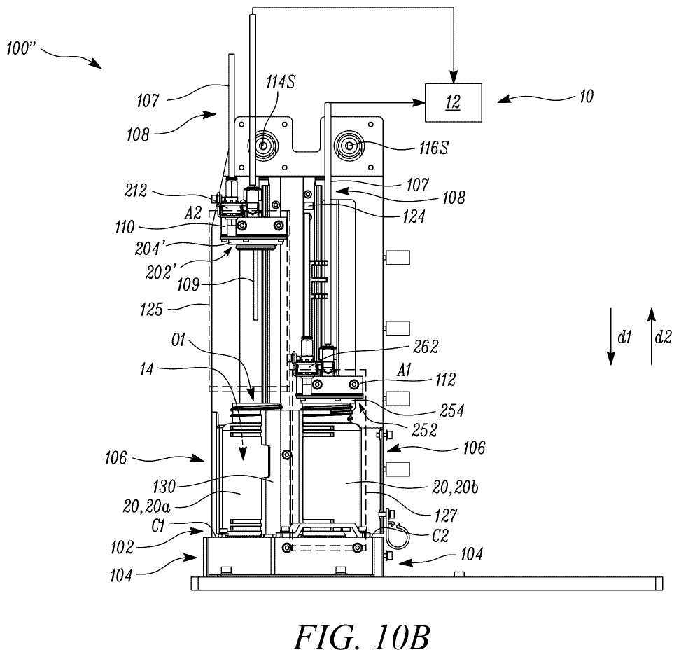

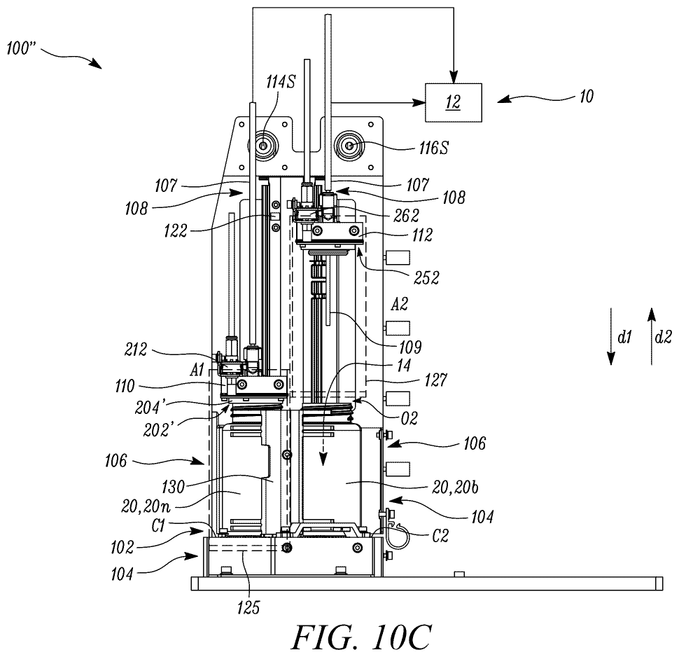

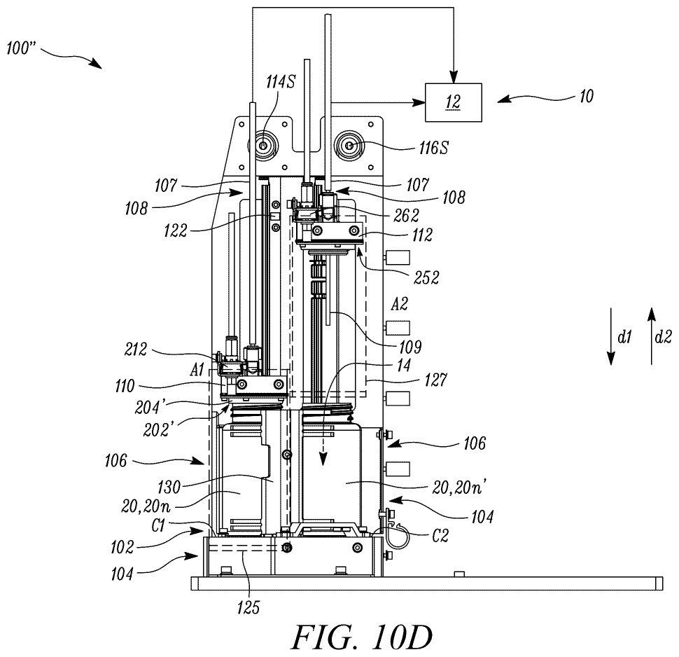

FIGS. 10A through 10D are different views of a consumables container loading/unloading system 100″ for the automated analyzer 10, according to another embodiment of the present disclosure. The consumables container loading/unloading system 100″ is substantially similar to the consumables container loading/unloading system 100 of FIG. 3B, with common components being referred to by the same numerals. However, in the consumables container loading/unloading system 100″, the at least one operator accessible container station 104 includes a pair of operator accessible container stations 104 (instead of the single operator accessible container station 104) spaced apart from each other. One of the pair of operator accessible container stations 104 serves at one of the first container holding position C1 and the second container holding position C2. The other of the pair of operator accessible container stations 104 serves at the other of the first container holding position C1 and the second container holding position C2.

Further, in the consumables container loading/unloading system 100″, the at least one analyzer supply station 106 includes a pair of analyzer supply stations 106 (instead of the single analyzer supply station 106) spaced apart from each other. One of the pair of analyzer supply stations 106 serves at the one of the first container holding position C1 and the second container holding position C2. The other of the pair of analyzer supply stations 106 serves at the other of the first container holding position C1 and the second container holding position C2. Moreover, the at least one fluid supply line 108 includes a pair of fluid supply lines 108 (instead of the single fluid supply line 108). Each of the pair of fluid supply lines 108 is disposed at a corresponding analyzer supply station 106 from the pair of analyzer supply stations 106. A valve (not shown) may selectively connect an active fluid supply line 108 to the automated analyzer 10.

The one of the pair of analyzer supply stations 106 and the one of the pair of operator accessible container stations 104 serve at the first container holding position C1. Similarly, the other of the pair of analyzer supply stations 106 and the other of the pair of operator accessible container stations 104 serve at the second container holding position C2. Further, in the consumables container loading/unloading system 100″, the first container holding position C1 and the second container holding position C2 do not move relative to each other. Thus, the rotary platform 101 and associated driving components are not needed.

It is to be noted that at one time instance, only one analyzer supply station 106 from the pair of analyzer supply stations 106 serve at the first container holding position C1 and only one operator accessible container station 106 from the pair of operator accessible container stations 106 serve at the second operator accessible container station C2. Similarly, at another time instance, only one analyzer supply station 106 from the pair of analyzer supply stations 106 serve at the second container holding position C2 and only one operator accessible container station 106 from the pair of operator accessible container stations 106 serve at the first operator accessible container station C1.

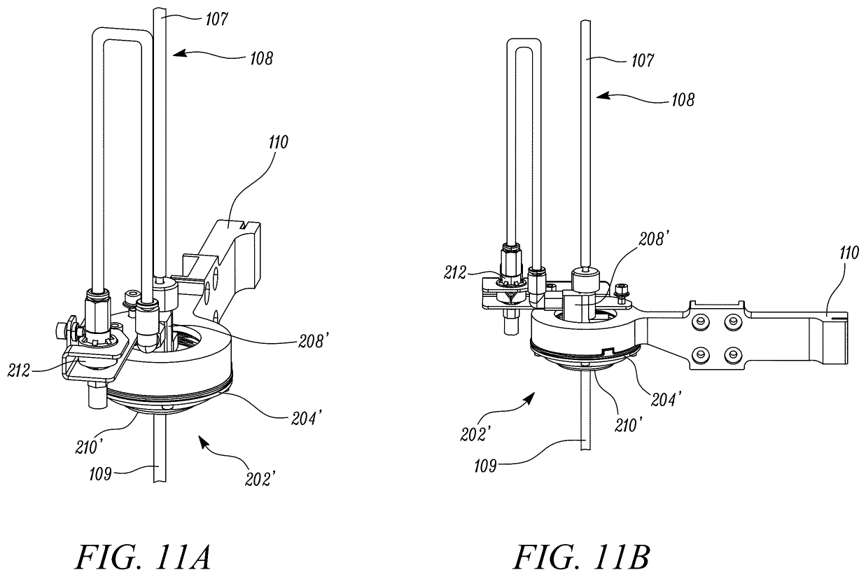

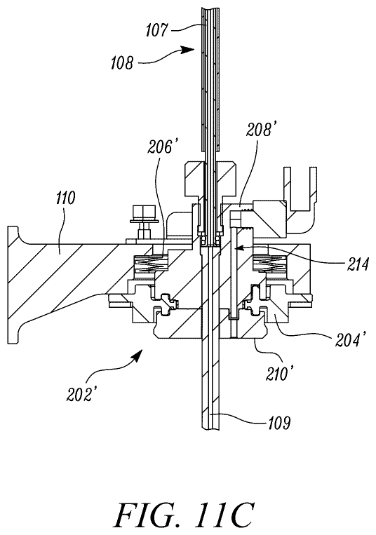

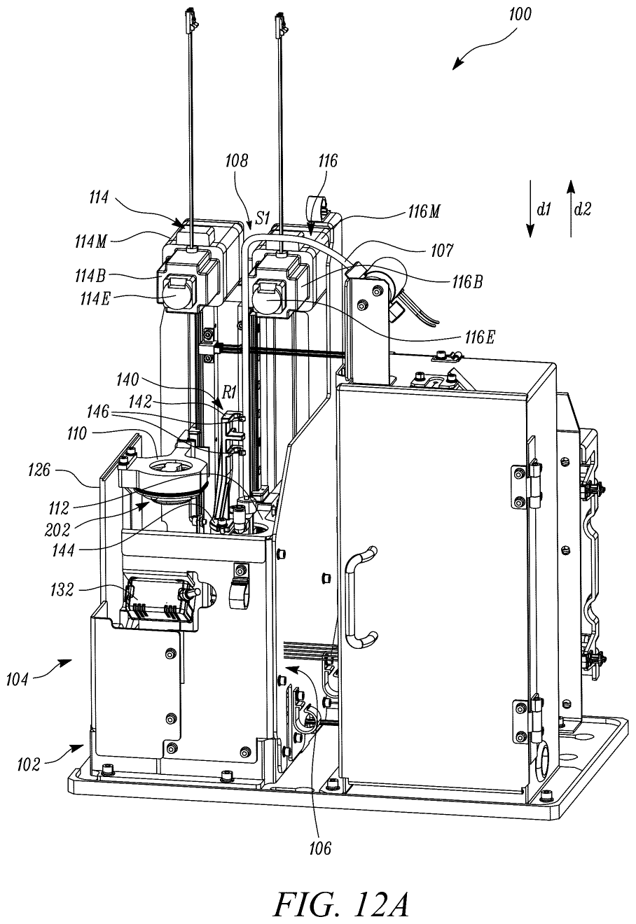

Further, the consumables container loading/unloading system 100″ includes a first lock assembly 202′ (instead of the first lock assembly 202 shown at FIG. 3B) attached to the first arm 110. FIGS. 11A and 11B are different perspective views of the first arm 110 and the first lock assembly 202′, according to an embodiment of the present disclosure. FIG. 11C is a cross-sectional view of the first lock assembly 202′ and the first arm 110. The first lock assembly 202′ is functionally equivalent to the second lock assembly 252.

Referring to FIGS. 10A, 11A, 11B, and 11C, the first lock assembly 202′ includes a first sealing ring 204′ configured to seal the first opening O1 of the first consumables container 20a held in one of the first container holding position C1 and the second container holding position C2. The first sealing ring 204′ is the same as the second sealing ring 254 of the second lock assembly 252. The first lock assembly 202′ further includes a spring 206′ (same as the second spring 256) to bias the first sealing ring 204′ towards the first opening O1 of the first consumables container 20a.

The first lock assembly 202′ further includes first upper and lower manifolds 208′, 210′ configured to hold the first sealing ring 204′ therebetween. The first upper and lower manifolds 208′, 210′ are the same as the respective second upper and lower manifolds 258, 260 of the second lock assembly 252.

The first lock assembly 202′ further includes a first vent 214 (shown at FIG. 11C) extending at least partially through at least one of the first upper and lower manifolds 208′, 210′. The first vent 214 is the same as the second vent 264 (shown at FIG. 7C) of the second lock assembly 252. The first vent 214 is disposed in fluid communication with the first consumables container 20a when the at least one fluid supply line 108 is connected with the first consumables container 20a at the at least one analyzer supply station 106. In other words, the first vent 214 is disposed in fluid communication with the first consumables container 20a when one of the pair of fluid supply lines 108 is connected with the first consumables container 20a at the corresponding one of the analyzer supply stations 106.

The first lock assembly 202′ further includes a first check valve 212 disposed in fluid communication with the first vent 214. The first check valve 212 is the same as the second check valve 262 of the second lock assembly 252. The first check valve 212 is configured to allow a flow of the at least one gas into the first consumables container 20a at the at least one analyzer supply station 106 when the at least one fluid supply line 108 is connected with the first consumables container 20a and some of the liquid consumables 14 is being delivered to the automated analyzer 10. In other words, the first check valve 212 is configured to allow the flow of the at least one gas into the first consumables container 20a at the one of the pair of analyzer supply stations 106 when the one of the pair of fluid supply lines 108 is connected with the first consumables container 20a and some of the liquid consumables 14 is being delivered to the automated analyzer 10. The first check valve 212 may be an electrically actuated valve.

Further, in the consumables container loading/unloading system 100″, the first arm 110 is fixedly attached to the at least one fluid supply line 108. Specifically, the first arm 110 is fixedly attached to the one of the pair of fluid supply lines 108. The first arm 110 is configured to move at least vertically along the first direction d1 in order to connect the at least one fluid supply line 108 with the first consumables container 20a at the at least one analyzer supply station 106. Specifically, the first arm 110 is configured to move at least vertically along the first direction d1 in order to connect the one of the pair of fluid supply lines 108 with the first consumables container 20a at the one of the pair of analyzer supply stations 106. The first arm 110 is configured to move at least vertically along the second direction d2 opposite to the first direction d1 in order to disconnect the at least one fluid supply line 108 from the first consumables container 20a. Specifically, the first arm 110 is configured to move at least vertically along the second direction d2 in order to disconnect the one of the pair of fluid supply lines 108 from the first consumables container 20a.

Further, the consumables container loading/unloading system 100″ includes a first access member 125 and a second access member 127 (instead of the access member 126 shown at FIG. 3B). The first access member 125 and the second access member 127 are shown transparent in FIGS. 10A through 10D for illustrative purposes. Each of the first access member 125 and the second access member 127 is configured to move vertically between an open position A2 and a closed position A1. The first arm 110 is fixedly attached to the first access member 125. The rust arm 110 is configured to move vertically along the first direction d1 in order to move the first access member 125 from the closed position A1 to the open position A2. The second arm 112 is fixedly attached to the second access member 127. Further, the first arm 110 is configured to move vertically along the second direction d2 in order to move the first access member 125 from the open position A2 to the closed position A1. The second arm 112 is configured to move vertically along the first direction d1 in order to move the second access member 127 from the closed position A1 to the open position A2. Further, the second arm 112 is configured to move vertically along the second direction d2 in order to move the second access member 127 from the open position A2 to the closed position A1.

Referring again to FIGS. 10A through 10D, FIG. 10A illustrates the consumables container loading/unloading system 100″ when the first access member 125 is in the closed position A1 and the second access member 127 is in the open position A2. In other words, FIG. 10A illustrates the consumables container loading/unloading system 100″ when the first lock assembly 202′ seals the first opening O1 of the first consumables container 20a and one of the pair of fluid supply lines 108 is connected with the first consumables container 20a to deliver the liquid consumables 14 to the automated analyzer 10. Further, as shown at FIG. 10A, the second lock assembly 252 does not seal the second opening O2 of the second consumables container 20b and the other of the pair of fluid supply lines 108 is disconnected from the second consumables container 20b.

The controller 16 is configured to control the second arm 112 to move the second arm 112 at least vertically along the first direction d1 in order to connect the at least one fluid supply line 108 (i.e., the other of the pair of fluid supply lines 108) with the second consumables container 20b at the at least one analyzer supply station 106 (i.e., the other of the pair of analyzer supply stations 106) and seal, via the second lock assembly 252, the second opening O2 of the second consumables container 20b at the at least one analyzer supply station 106 (i.e., the other of the pair of analyzer supply stations 106. As shown at FIG. 10B, the other of the pair of fluid supply lines 108 is connected with the second consumables container 20b and the second lock assembly 252 seals the second opening O2 of the second consumables container 20b. The controller 16 is further configured to control the at least one fluid supply line 108 to deliver the liquid consumables 14 to the automated analyzer 10 when the at least one fluid supply line 108 is connected with the second consumables container 20b at the at least one analyzer supply station 106. The controller 16 is further configured to control the rust arm 110 to move the first arm 110 at least vertically along the second direction d2 opposite to the first direction d1 and thereby move the first access member 125 from the closed position A1 to the open position A2. As shown at FIG. 10B, the one of the pair of fluid supply lines 108 is disconnected from the first consumables container 20a and the first lock assembly 202′ does not seal the first opening O1 of the first consumables container 20b.

As a result, the operator is allowed to replace the first consumables container 20a at the at least one operator accessible container station 104 (i.e., the one of the pair of operator accessible container stations 104) with a new consumables container 20n (shown at FIG. 10C). The new consumables container 20n is received in the one of the first container holding position C1 and the second container holding position C2 at the at least one operator accessible container station 104. As shown at FIG. 10C, the new consumables container 20n is received in the first container holding position C1. Once the new consumables container 20n is loaded into the first container holding position C1, the controller 16 is further configured to control the first arm 110 to move the first arm 110 at least vertically along the first direction d1 in order to connect the at least one fluid supply line 108 (i.e., the one of the pair of fluid supply lines 108) with the new consumables container 20n at the at least one analyzer supply station 106 (i.e., the one of the pair of analyzer supply stations 106). The controller 16 is further configured to control the first arm 110 to move the first arm 110 at least vertically along the first direction d1 in order to seal, via the first lock assembly 202′, an opening of the new consumables container 20n at the at least one operator accessible container station 104 during the transfer of the liquid consumables 14 from the second consumables container 20b to the automated analyzer 10. The controller 16 is further configured to control the at least one fluid supply line 108 to deliver the liquid consumables 14 from the new consumables container 20n to the automated analyzer 10 when the transfer of the liquid consumables 14 from the second consumables container 20b to the automated analyzer 10 is completed. As shown at FIG. 10C, the one of the pair of fluid supply lines 108 is connected with the new consumables container 20n and the first lock assembly 202′ seals the opening of the new consumables container 20n.

Once the transfer of the liquid consumables 14 from the second consumables container 20b to the automated analyzer 10 is completed, the controller 16 is further configured to control the second arm 112 to move at least vertically along the second direction d2 in order to disconnect the at least one fluid supply line 108 (i.e., the other of the pair of fluid supply lines 108) from the second consumables container 20b at the at least one analyzer supply station 106 (i.e., the other of the pair of analyzer supply stations 106). As a result, the second access member 127 is moved from the closed position A1 to the open position A2. Therefore, the operator is allowed to replace the second consumables container 20b at the at least one operator accessible container station 104 with another new consumables container 20n′ when the at least one fluid supply line 108 is disconnected from the second consumables container 20b. As shown at FIG. 10D, the another new consumables container 20n′ is received in the other of the first container holding position C1 and the second container holding position C2 at the at least one operator accessible container station 104 (i.e., the other of the pair of operator accessible container stations 104). Specifically, the another new consumables container 20n′ is received in the second container holding position C2.

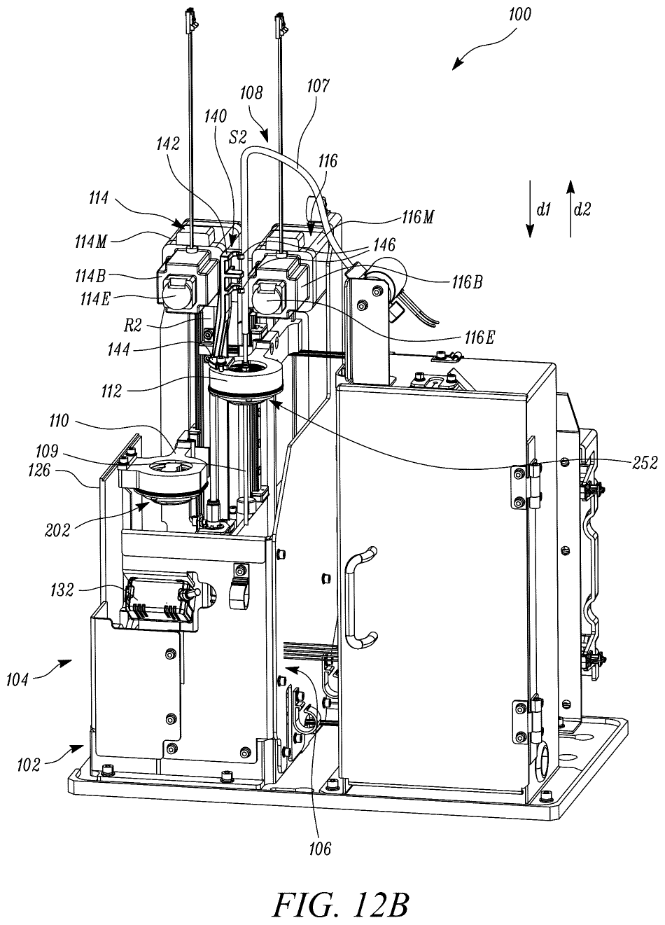

FIGS. 12A and 12B are perspective views of the consumables container loading/unloading system 100 (shown at FIGS. 3A through 3C) illustrating a tubing guide 140 for guiding the at least one fluid supply line 108 (e.g., the single fluid supply line 108) when the second arm 112 moves along the first direction d1 and the second direction d2. Some components are not shown in FIGS. 12A and 12B for illustrative purposes. The tubing guide 140 may be a low cost, injection molded, fastenerless tubing guide that does not damage the fluid supply line 108 while providing a route to the fluid supply line 108 during the movement of the second arm 112. Specifically, the tubing guide 140 may provide a route to the fluid supply line 108 that is free of interference with surrounding parts in the range of motion of the second arm 112 and surrounding parts.

FIGS. 12A and 12B depict two different positions of the second arm 112 and therefore two different positions R1, R2 of the tubing guide 140. The position R1 of the tubing guide 140 is depicted in FIG. 12A, and the position R2 of the tubing guide 140 is depicted in FIG. 12B. Only two positions R1, R2 of the tubing guide 140 are shown. However, there may be three or more different positions of the tubing guide 140, and the tubing guide 140 guides the at least one fluid supply line 108 between the various positions. The tubing guide 140 includes a free end 142 and a mounted end 144. In the depicted embodiment, the mounted end 144 is attached to the second arm 122 and the free end 142 includes hook-shaped features 146 to allow the fluid supply line 108 to pass therethrough and supply the liquid consumables 14 to the automated analyzer 10. Further, the fluid supply line 108 may contact the free end 142 of the tubing guide 140. The mounted end 144 of the tubing guide 140 may be attached to the second arm 112 by using fasteners. Moreover, as shown at FIG. 12A, the fluid supply line 108 is in a lowered position S1. As shown at FIG. 12B, the fluid supply line 108 is in a raised position S2. Therefore, the fluid supply line 108 moves from the lowered position S1 to the raised position S2 when the tubing guide 140 moves from the position R1 to the position R2. Another one of the same or similar tubing guide 140 may further be used to guide an additional fluid supply line 108 (e.g., in the embodiment illustrated at FIGS. 10A through 10D).

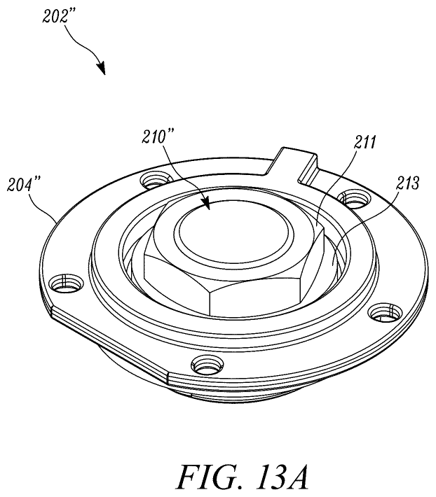

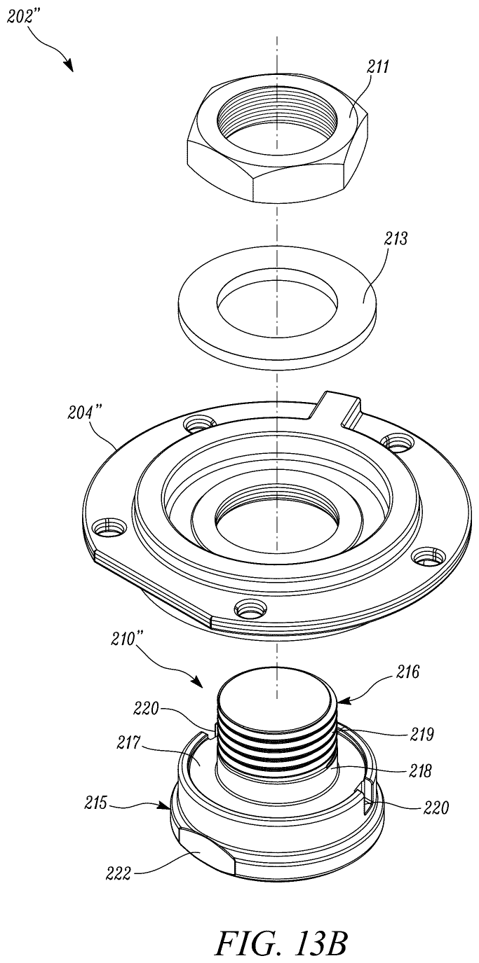

FIGS. 13A-13B depict another example of a first lock assembly 202″ which may be fixedly attached to the first arm 110 of the consumables container loading/unloading system 100 in place of the first lock assembly 202 depicted in FIGS. 6A-6C, for example. FIG. 13A is a perspective view of the first lock assembly 202″. FIG. 13B is an exploded view of the first lock assembly 202″.

The first lock assembly 202″ may be similar to the first lock assembly 202 described above, except as otherwise described below. In this regard, the first lock assembly 202″ includes a first sealing ring 204″ configured to seal an opening (e.g., the first opening O1 or the second opening O2) of one of the consumables containers 20 held in one of the first container holding position C1 and the second container holding position C2 at the operator accessible container station 104 when the fluid supply line 108 is connected with the other of the consumables containers 20 at the analyzer supply station 106 and when the access member 126 is in the closed position P1. While not shown, the first lock assembly 202″ may further include a first spring similar to the first spring 206 described above to bias the first sealing ring 204″ towards the opening of the one of the consumables containers 20. The first lock assembly 202″ further includes a first lower manifold 210″, as well as a first upper nut 211 and a first upper washer 213 configured to hold the first sealing ring 204″ between the first lower manifold 210″ and the first upper washer 213.

In this regard, first lower manifold 210″ of the present example includes a generally disc-shaped base 215 and a central shank 216 extending upwardly from the base 215 to define an annular ledge 217 therebetween. The shank 216 includes a cylindrical lower portion 218 and a threaded upper portion 219 that is configured to threadably engage first upper nut 211 to hold the first sealing ring 204″ between the base 215 and the first upper washer 213. In some versions, an adhesive may be applied to the first upper nut 211 and/or to the threaded upper portion 219 of the shank 217 to secure the first upper nut 211 to the shank 217.

In the example shown, a pair of notches 220 extend downwardly from an upper rim of the base 215 and are configured to receive corresponding protrusions (not shown) that extend downwardly from a lower surface of the first sealing ring 204″ to assist with ensuring a desired alignment of the first sealing ring 204″ relative to the base 215. For example, the notches 220 may be sized, shaped, and/or positioned relative to each other such that each of the notches 220 may only be capable of receiving the corresponding protrusion of the first sealing ring 204″ (and not the protrusion corresponding to the other of the notches 220). In this manner, the notches 220 and protrusions may cooperate with each other to prevent inadvertent misalignment of the first sealing ring 204″ relative to the base 215.

In the example shown, a pair of opposed flats 222 (one shown) are provided on the circular outer periphery of the base 215 to accommodate a fixture for tightening the first upper nut 211 against the first upper washer 213, the first sealing ring 204″, and the base 215. The flats 222 may be angularly offset from any regions of the circular outer periphery of the base 215 that might contact the consumables containers 20 (e.g., the openings O1, O2 thereof) to avoid interfering with proper alignment of the consumables containers 20 relative to the first lower manifold 210″.

In some versions, the first upper nut 211 and/or the first upper washer 213 may be constructed of a plastic material. In addition, or alternatively, the first lower manifold 210″ may be constructed as a unitary (e.g., monolithic) piece, such as via injection molding. It will be appreciated that any one or more of the aforementioned features may simplify manufacture and/or assembly of the first lock assembly 202″, at least by comparison to the first lock assembly 202 described above.

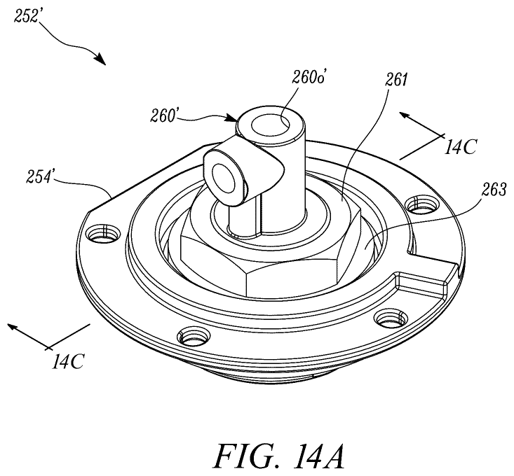

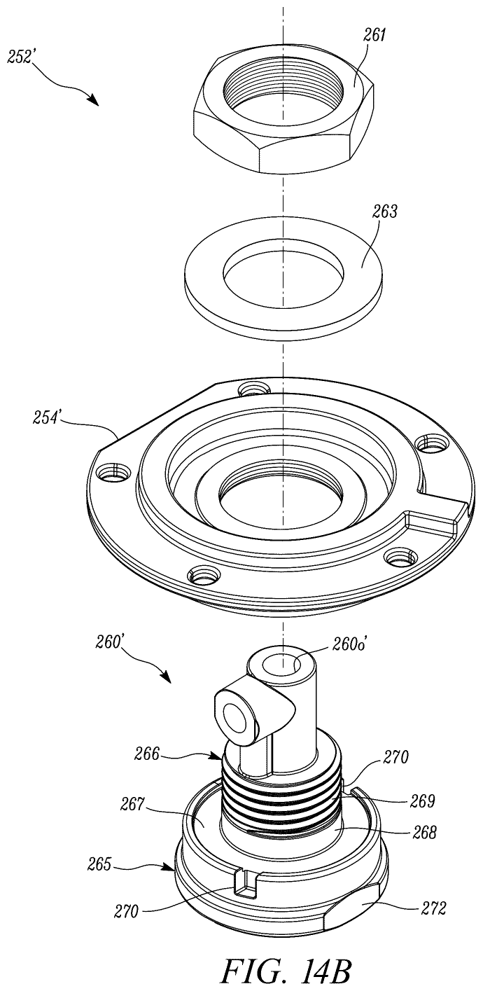

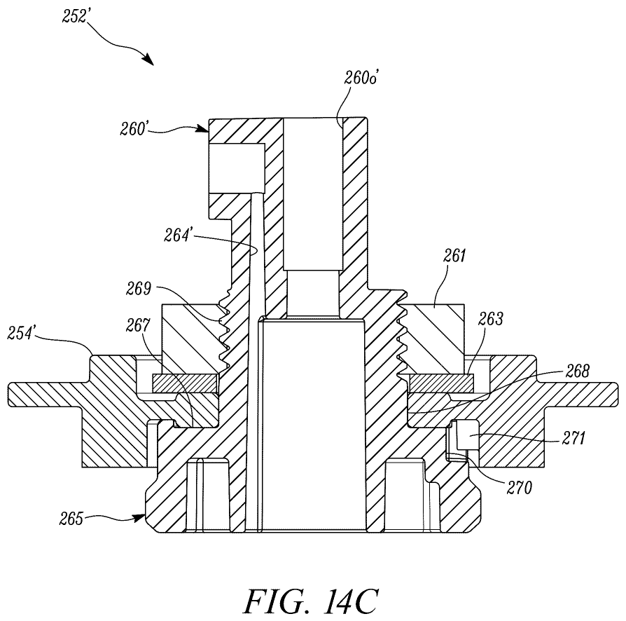

In some versions, the first sealing ring 204″ may be configured to provide a fluid-tight seal against both the annular ledge 217 and the cylindrical lower portion 218 of the shank 216, in a manner similar to that described below in connection with FIG. 14C. Thus, in addition to providing simplified manufacture and/or assembly, the first lock assembly 202″ may provide improved scaling, at least by comparison to the first lock assembly 202 described above.

FIGS. 14A-14C depict another example of a second lock assembly 252′ which may be fixedly attached to the second arm 112 of the consumables container loading/unloading system 100 in place of the second lock assembly 252 depicted in FIGS. 7A-7D, for example. FIG. 14A is a perspective view of the second lock assembly 252′. FIG. 14B is an exploded view of the second lock assembly 252′. FIG. 14C is a cross-sectional view of the second lock assembly 252′.

The second lock assembly 252′ may be similar to the second lock assembly 252 described above, except as otherwise described below. In this regard, the second lock assembly 252′ includes a second sealing ring 254′ configured to seal an opening of one of the consumables containers 20 held in one of the first container holding position C1 and the second container holding position C2 at the analyzer supply station 106 when the fluid supply line 108 is connected with the one of the consumables containers 20 at the analyzer supply station 106. While not shown, the second lock assembly 252′ may further include a second spring similar to the second spring 256 described above to bias the second sealing ring 254′ towards the opening of the one of the consumables containers 20. The second lock assembly 252′ further includes a second lower manifold 260′, as well as a second upper nut 261 and a second upper washer 263 configured to hold the second sealing ring 254′ between the second lower manifold 260′ and the second upper washer 263. The second lower manifold 260′ includes an opening 260o′ for receiving the suction straw 109 therethrough. While not shown, the second lock assembly 252′ may further include a second check valve similar to the second check valve 262 described above to allow a flow of at least one gas into one of the consumables containers 20 at the analyzer supply station 106 when the fluid supply line 108 is connected with the one of the consumables containers 20 and some of the liquid consumables 14 is being delivered to the automated analyzer 10. In this regard, the second lock assembly 252′ further includes a second vent 264′ that may be disposed in fluid communication with such a second check valve.

Second lower manifold 260′ of the present example includes a generally disc-shaped base 265 and a central shank 266 extending upwardly from the base 265 to define an annular ledge 267 therebetween. The shank 266 includes a cylindrical lower portion 268 and a threaded upper portion 269 that is configured to threadably engage second upper nut 261 to hold the second sealing ring 254′ between the base 265 and the second upper washer 263. In some versions, an adhesive may be applied to the second upper nut 261 and/or to the threaded upper portion 269 of the shank 267 to secure the second upper nut 261 to the shank 267.

In the example shown, a pair of notches 270 extend downwardly from an upper rim of the base 265 and are configured to receive corresponding protrusions 271 that extend downwardly from a lower surface of the second sealing ring 254′ to assist with ensuring a desired alignment of the second sealing ring 254′ relative to the base 265. For example, the notches 270 may be sized, shaped, and/or positioned relative to each other such that each of the notches 270 may only be capable of receiving the corresponding protrusion 271 of the second sealing ring 254′ (and not the protrusion 271 corresponding to the other of the notches 270). In this manner, the notches 270 and protrusions 271 may cooperate with each other to prevent inadvertent misalignment of the second sealing ring 254′ relative to the base 265.

In the example shown, a pair of opposed flats 272 (one shown) are provided on the circular outer periphery of the base 265 to accommodate a fixture for tightening the second upper nut 261 against the second upper washer 263, the second sealing ring 254′, and the base 265. The flats 272 may be angularly offset from any regions of the circular outer periphery of the base 265 that might contact the consumables containers 20 (e.g., the openings O1, O2 thereof) to avoid interfering with proper alignment of the consumables containers 20 relative to the second lower manifold 260′.

In some versions, the second upper nut 261 and/or the second upper washer 263 may be constructed of a plastic material. In addition, or alternatively, the second lower manifold 260′ may be constructed as a unitary (e.g., monolithic) piece, such as via injection molding. It will be appreciated that any one or more of the aforementioned features may simplify manufacture and/or assembly of the second lock assembly 252′, at least by comparison to the second lock assembly 252 described above.

As shown in FIG. 14C, the second sealing ring 254′ may be configured to provide a fluid-tight seal against both the annular ledge 267 and the cylindrical lower portion 268 of the shank 266. Thus, in addition to providing simplified manufacture and/or assembly, the second lock assembly 252′ may provide improved sealing, at least by comparison to the second lock assembly 252 described above.

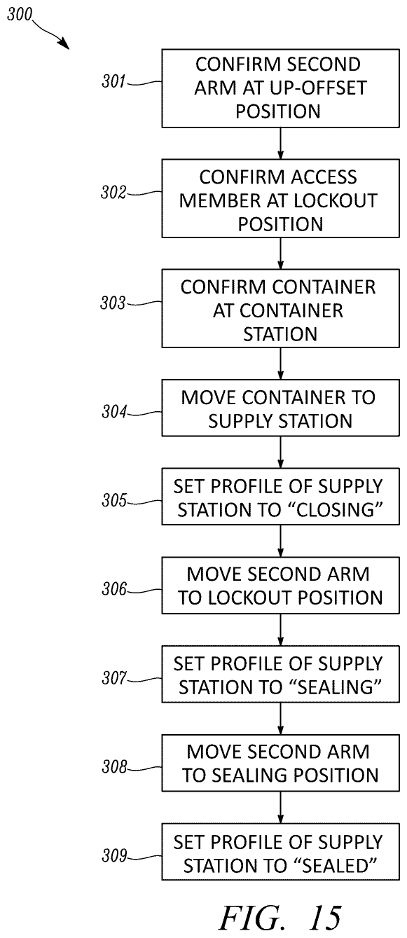

As mentioned above, the controller 16 is configured to: control the first actuator stack 114 to move the first arm 110 at least vertically along the first direction d1 and the second direction d2 in order to move the access member 126 between the open position P3, the lockout position P2, and the closed position P1; control the second actuator stack 116 to move the second arm 112 at least vertically along the first direction d1 in order to connect the fluid supply line 108 with the one of the consumables containers 20 at the analyzer supply station 106; control the second actuator stack 116 to move the second arm 112 at least vertically along the second direction d2 in order to disconnect the fluid supply line 108 from the one of the consumables containers 20 at the analyzer supply station 106; control the third actuator stack 118 to move the first container holding position C1 between the operator accessible container station 104 and the analyzer supply station 106; and control the third actuator stack 118 to move the second container holding position C2 between the analyzer supply station 106 and the operator accessible container station 104. For example, the controller 16 may be configured to control the actuator stacks 114, 116, 118 to execute any one or more of the procedures 300, 400, 500, 600, 700, 800, 900 described below in connection with FIGS. 15-21D in order to seal, unseal, and/or switch consumables containers 20 at the operator accessible container station 104 and/or analyzer supply station 106.

Referring now to FIG. 15, an example of a procedure 300 for sealing a desired consumables container 20 at the analyzer supply station 106 includes a step 301, at which the controller 16 confirms that the second arm 112 is at a corresponding up-offset position, such as a position that is at or above the corresponding home position. For example, the controller 16 may confirm that the second arm 112 is at the corresponding up-offset position based on one or more signals received by the controller 16 from the second encoder 116E and/or from the second home sensor 124. The procedure 300 also includes a step 302, at which the controller 16 confirms that the access member 126 is at the lockout position P2. For example, the controller 16 may confirm that the access member 126 is at the lockout position P2 based on one or more signals received by the controller 16 from the first encoder 114E and/or from the first home sensor 122. The procedure 300 further includes a step 303, at which the controller 16 confirms that the desired consumables container 20 is at the operator accessible container station 104. For example, the controller 16 may confirm that the desired consumables container 20 is at the operator accessible container station 104 based on one or more signals received by the controller 16 from the reader 132. While the procedure 300 is shown as proceeding from step 301 to step 302, and from step 302 to step 303, it will be appreciated that steps 301, 302, 303 may be performed in any other suitable order and/or concurrently.

In the example shown, after steps 301, 302, 303 have been completed, the procedure 300 proceeds to a step 304, at which the controller 16 moves the desired consumables container 20 from the operator accessible container station 104 to the analyzer supply station 106. For example, the controller 16 may move the desired consumables container 20 from the operator accessible container station 104 to the analyzer supply station 106 by controlling the third actuator stack 118 to release the third brake 118B and/or rotate the third shaft 118S to rotate the rotary platform 101 and thereby move the first container holding position C1 from the operator accessible container station 104 to the analyzer supply station 106. After step 304 has been completed, the procedure 300 proceeds to a step 305, at which the controller 16 sets a profile of the analyzer supply station 106 to “closing.” For example, the controller 16 may communicate such a profile to the operator via a display. In the example shown, after step 305 has been completed, the procedure 300 proceeds to a step 306, at which the controller 16 moves the second arm 112 to a corresponding lockout position, such as a position that is below the corresponding home position and/or at a same height as the first arm 110 when the access member 126 is at its lockout position P2. For example, the controller 16 may move the second arm 112 to the corresponding lockout position by controlling the second actuator stack 116 to release the second brake 116B and/or rotate the second shaft 116S and thereby lower the second arm 112 from the corresponding up-offset position to the corresponding lockout position.

In the example shown, after step 306 has been completed, the procedure 300 proceeds to a step 307, at which the controller 16 sets the profile of the analyzer supply station 106 to “sealing.” For example, the controller 16 may communicate such a profile to the operator via a display. In the example shown, after step 307 has been completed, the procedure 300 proceeds to a step 308, at which the controller 16 moves the second arm 112 to a corresponding sealing position, such as a position that is below the corresponding lockout position and/or at a same height as the first arm 110 when the access member 126 is at its closed position P1, such that the second lock assembly 252 seals the opening of the desired consumables container 20 at the analyzer supply station 106 and the fluid supply line 108 is connected with the desired consumables container 20 at the analyzer supply station 106. For example, the controller 16 may move the second arm 112 to the corresponding sealing position by controlling the second actuator stack 116 to release the second brake 116B and/or rotate the second shaft 116S and thereby lower the second arm 112 from the corresponding lockout position to the corresponding sealing position. In some versions, the controller 16 may apply the second brake 116B in response to the second arm 112 reaching the corresponding scaling position.

In the example shown, after step 308 has been completed, the procedure 300 proceeds to a step 309, at which the controller 16 sets the profile of the analyzer supply station 106 to “sealed.” For example, the controller 16 may communicate such a profile to the operator via a display. In some versions, the controller 16 may wait for a predetermined delay period (e.g., about 50 milliseconds) after step 308 has been completed before setting the profile of the analyzer supply station 106 to “sealed.” After step 309 has been completed, the liquid consumables 14 may be transferred from the desired consumables container 20 to the automated analyzer 10 via the fluid supply line 108.

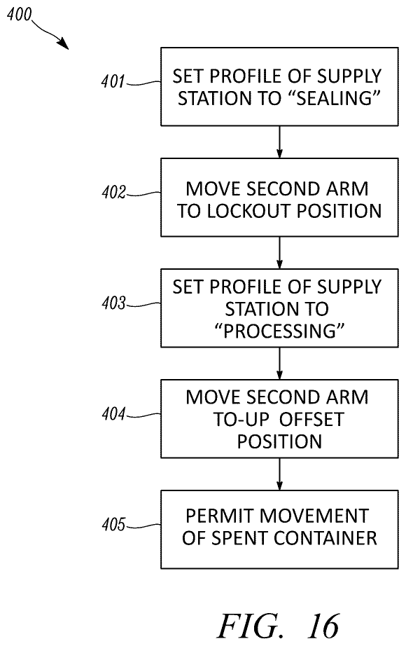

Referring now to FIG. 16, an example of a procedure 400 for unsealing a spent consumables container 20 at the analyzer supply station 106 includes a step 401, at which the controller 16 sets the profile of the analyzer supply station 106 to “sealing.” For example, the controller 16 may communicate such a profile to the operator via a display. In the example shown, after step 401 has been completed, the procedure 400 proceeds to a step 402, at which the controller 16 moves the second arm 112 to the corresponding lockout position, such that the second lock assembly 252 unseals the opening of the spent consumables container 20 at the analyzer supply station 106. For example, the controller 16 may move the second arm 112 to the corresponding lockout position by controlling the second actuator stack 116 to release the second brake 116B and/or rotate the second shaft 116S and thereby raise the second arm 112 from the corresponding sealing position to the corresponding lockout position. In some versions, the controller 16 may wait for a predetermined delay period (e.g., about 50 milliseconds) after step 401 has been completed before releasing the second brake 116B.

In the example shown, after step 402 has been completed, the procedure 400 proceeds to a step 403, at which the controller 16 sets the profile of the analyzer supply station 106 to “processing.” For example, the controller 16 may communicate such a profile to the operator via a display. In the example shown, after step 403 has been completed, the procedure 400 proceeds to a step 404, at which the controller 16 moves the second arm 112 to the corresponding up-offset position. For example, the controller 16 may move the second arm 112 to the corresponding up-offset position by controlling the second actuator stack 116 to release the second brake 116B and/or rotate the second shaft 116S and thereby raise the second arm 112 from the corresponding lockout position to the corresponding up-offset position.

In the example shown, after step 404 has been completed, the procedure 400 proceeds to a step 405, at which the controller 16 permits the spent consumables container 20 to be moved from the analyzer supply station 106 to the operator accessible container station 104. For example, the controller 16 may permit the spent consumables container 20 to be moved from the analyzer supply station 106 to the operator accessible container station 104 by controlling the third actuator stack 118 to release the third brake 118B so that the rotary platform 101 may be rotated to thereby move the first container holding position C1 from the analyzer supply station 106 to the operator accessible container station 104.

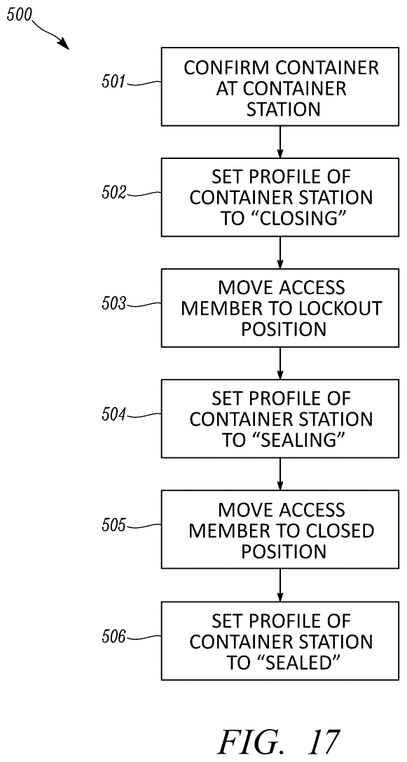

Referring now to FIG. 17, an example of a procedure 500 for sealing a standby consumables container 20 at the operator accessible container station 104 includes a step 501, at which the controller 16 confirms that the standby consumables container 20 is at the operator accessible container station 104. For example, the controller 16 may confirm that the standby consumables container 20 is at the operator accessible container station 104 based on one or more signals received by the controller 16 from the reader 132. In the example shown, after step 501 has been completed, the procedure 500 proceeds to a step 502, at which the controller 16 sets a profile of the operator accessible container station 104 to “closing.” For example, the controller 16 may communicate such a profile to the operator via a display.

In the example shown, after step 502 has been completed, the procedure 500 proceeds to a step 503, at which the controller 16 moves the access member 126 to the lockout position P2. For example, the controller 16 may move the access member 126 to the lockout position P2 by controlling the first actuator stack 114 to release the first brake 114B and/or rotate the first shaft 114S and thereby lower the access member 126 from the open position P3 to the lockout position P2.

In the example shown, after step 503 has been completed, the procedure 500 proceeds to a step 504, at which the controller 16 sets the profile of the operator accessible container station 104 to “sealing.” For example, the controller 16 may communicate such a profile to the operator via a display. In the example shown, after step 504 has been completed, the procedure 500 proceeds to a step 505, at which the controller 16 moves the access member 126 to the closed position P1, such that the first lock assembly 202 seals the opening of the standby consumables container 20 at the operator accessible container station 104. For example, the controller 16 may move the access member 126 to the closed position P1 by controlling the first actuator stack 114 to release the first brake 114B and/or rotate the first shaft 114S and thereby lower the access member 126 from the lockout position P2 to the closed position P1. In some versions, the controller 16 may apply the first brake 114B in response to the access member 126 reaching the closed position P1.

In the example shown, after step 505 has been completed, the procedure 500 proceeds to a step 506, at which the controller 16 sets the profile of the operator accessible container station 104 to “sealed.” For example, the controller 16 may communicate such a profile to the operator via a display. In some versions, the controller 16 may wait for a predetermined delay period (e.g., about 50 milliseconds) after step 505 has been completed before setting the profile of the operator accessible container station 104 to “sealed.”

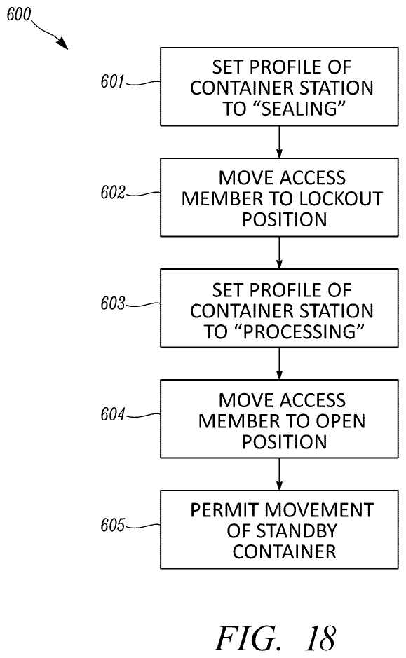

Referring now to FIG. 18, an example of a procedure 600 for unsealing a standby consumables container 20 at the operator accessible container station 104 includes a step 601, at which the controller 16 sets the profile of the operator accessible container station 104 to “sealing.” For example, the controller 16 may communicate such a profile to the operator via a display. In the example shown, after step 601 has been completed, the procedure 600 proceeds to a step 602, at which the controller 16 moves the access member 126 to the lockout position P2, such that the first lock assembly 202 unseals the opening of the standby consumables container 20 at the operator accessible container station 104. For example, the controller 16 may move the access member 126 to the lockout position P2 by controlling the first actuator stack 114 to release the first brake 114B and/or rotate the first shaft 114S and thereby raise the access member 126 from the closed position P1 to the lockout position P2. In some versions, the controller 16 may wait for a predetermined delay period (e.g., about 50 milliseconds) after step 601 has been completed before releasing the first brake 114B.

In the example shown, after step 602 has been completed, the procedure 600 proceeds to a step 603, at which the controller 16 sets the profile of the operator accessible container station 104 to “processing.” For example, the controller 16 may communicate such a profile to the operator via a display. In the example shown, after step 603 has been completed, the procedure 600 proceeds to a step 604, at which the controller 16 moves the access member 126 to the open position P3. For example, the controller 16 may move the access member 126 to the open position P3 by controlling the first actuator stack 114 to release the first brake 114B and/or rotate the first shaft 114S and thereby raise the first arm 110 from the lockout position P2 to the open position P3. In some other versions, step 604 may be omitted, such that the access member 126 may remain at the lockout position P2.

In the example shown, after step 604 has been completed, the procedure 600 proceeds to a step 605, at which the controller 16 permits the standby consumables container 20 to be moved from the operator accessible container station 104 to the analyzer supply station 106. For example, the controller 16 may permit the spent consumables container 20 to be moved from the operator accessible container station 104 to the analyzer supply station 106 by controlling the third actuator stack 118 to release the third brake 118B so that the rotary platform 101 may be rotated to thereby move the first container holding position C1 from the operator accessible container station 104 to the analyzer supply station 106.

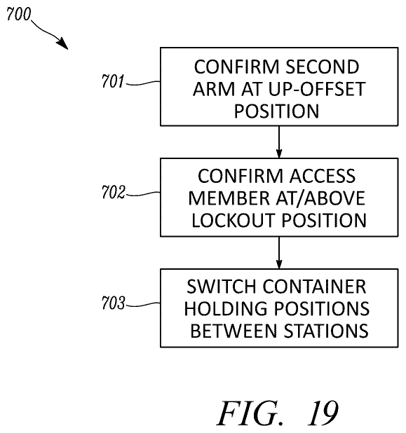

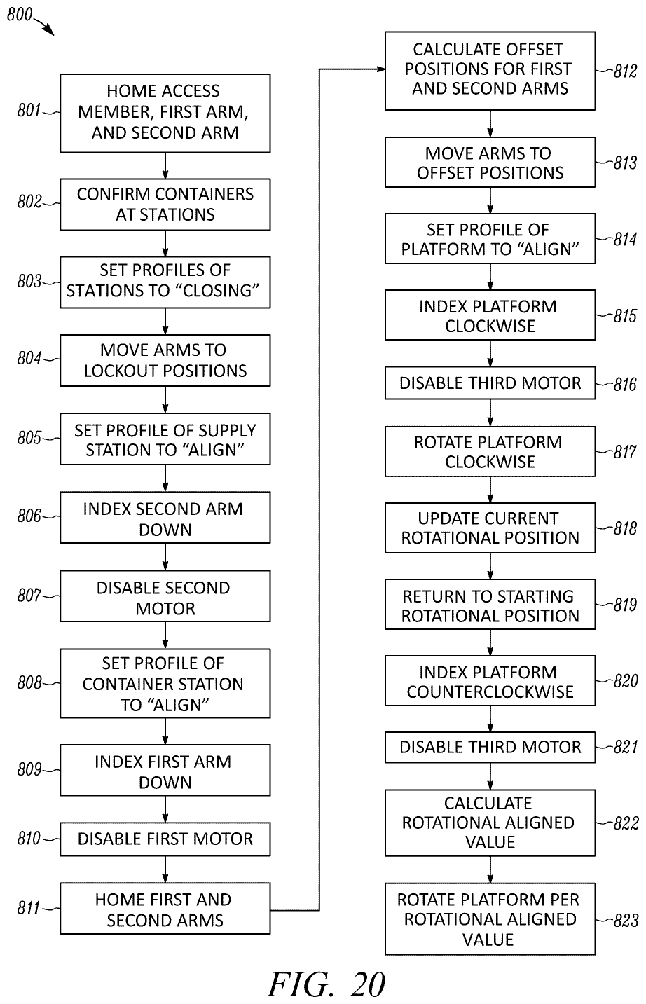

Referring now to FIG. 19, an example of a procedure 700 for moving the rotary platform 101 while changing a consumables container 20 at the operator accessible container station 104 includes a step 701, at which the controller 16 confirms that the second arm 112 is at the corresponding up-offset position. For example, the controller 16 may confirm that the second arm 112 is at the corresponding up-offset position based on one or more signals received by the controller 16 from the second encoder 116E and/or from the second home sensor 124. The procedure 700 also includes a step 702, at which the controller 16 confirms that the access member 126 is at or above the lockout position P2. For example, the controller 16 may confirm that the access member 126 is at or above the lockout position P2 based on one or more signals received by the controller 16 from the first encoder 114E and/or from the first home sensor 122. While the procedure 700 is shown as proceeding from step 701 to step 702, it will be appreciated that steps 701, 702 may be performed in any other suitable order and/or concurrently.

In the example shown, after steps 701, 702 have been completed, the procedure 700 proceeds to a step 703, at which the controller 16 moves the first and second container holding positions C1, C2 between the operator accessible container station 104 and the analyzer supply station 106. For example, the controller 16 may move the first and second container holding positions C1, C2 between the operator accessible container station 104 and the analyzer supply station 106 by controlling the third actuator stack 118 to release the third brake 118B and/or rotate the third shaft 118S to rotate the rotary platform 101.

Referring now to FIG. 20, an example of a procedure 800 for automatically aligning consumables containers 20 at the operator accessible container station 104 and the analyzer supply station 106 with the respective lock assemblies 202, 252 includes a step 801, at which the controller 16 homes each of the access member 126 (together with the first arm 110), the second arm 112, and the rotary platform 101. For example, the controller 16 may home the access member 126 by controlling the first actuator stack 114 to release the first brake 114B and/or rotate the first shaft 114S until the first arm 110 reaches the corresponding home position, such as based on one or more signals received by the controller 16 from the rust encoder 114E and/or from the first home sensor 122. The controller 16 may also home the second arm 112 by controlling the second actuator stack 116 to release the second brake 116B and/or rotate the second shaft 116S until the second arm 112 reaches the corresponding home position, such as based on one or more signals received by the controller 16 from the second encoder 116E and/or from the second home sensor 124. The controller 16 may further home the rotary platform 101 by controlling the third actuator stack 118 to release the third brake 118B and/or rotate the third shaft 118S to rotate the rotary platform 101 until the first and second container holding positions C1, C2 are at respective stations 104, 106, such as based on one or more signals received by the controller 16 from the third encoder 118E.

In the example shown, after step 801 has been completed, the procedure 800 proceeds to a step 802, at which the controller 16 confirms that consumables containers 20 are at the operator accessible container station 104 and/or the analyzer supply station 106. For example, the controller 16 may confirm that consumables containers 20 are at the operator accessible container station 104 and/or the analyzer supply station 106 based on one or more signals received by the controller 16 from the reader 132. In some versions, the controller 16 may communicate the absence of a consumables container 20 from the operator accessible container station 104 and/or the analyzer supply station 106 to the operator via a display. In the example, shown, after step 802 has been completed, the procedure 800 proceeds to a step 803, at which the controller 16 sets a profile of each of the operator accessible container station 104 and the analyzer supply station 106 to “closing.” For example, the controller 16 may communicate such a profile to the operator via a display. In the example shown, after step 803 has been completed, the procedure 800 proceeds to a step 804, at which the controller 16 moves the first and second arms 110, 112 to the corresponding lockout positions P2. For example, the controller 16 may move the first and second arms 110, 112 to the corresponding lockout positions P2 by controlling the first and second actuator stacks 114, 116 to release the first and second brakes 114B 116B and/or rotate the first and second shafts 114S, 116S and thereby lower the first and second arms 110, 112 from the corresponding home positions to the corresponding lockout positions P2.

In the example shown, after step 804 has been completed, the procedure 800 proceeds to a step 805, at which the controller 16 sets a profile of the analyzer supply station 106 to “align.” For example, the controller 16 may communicate such a profile to the operator via a display. In the example shown, after step 805 has been completed, the procedure 800 proceeds to a step 806, at which the controller 16 moves the second arm 112 down in one-step increments until slippage of a predetermined number of steps (e.g., two steps) is detected, such as based on one or more signals received by the controller 16 from the second encoder 116E. In some versions, the controller 16 may wait for a predetermined delay period (e.g., at least about 25 milliseconds) between moves. In the example shown, after step 806 has been completed, the procedure 800 proceeds to a step 807, at which the controller 16 disables a drive current for the second drive motor 116M for a predetermined time period (e.g., about 200 milliseconds) and captures a reading from the second encoder 116E for vertical alignment to determine the aligned value for the analyzer supply station 106. In some versions, the controller 16 may verify that the aligned value is less than a predetermined threshold (e.g., about −1023 steps) to confirm that no false slip was detected.

In the example shown, after step 804 has been completed, the procedure 800 also proceeds to a step 808, at which the controller 16 sets a profile of the operator accessible container station 104 to “align.” For example, the controller 16 may communicate such a profile to the operator via a display. In the example shown, after step 808 has been completed, the procedure 800 proceeds to a step 809, at which the controller 16 moves the first arm 110 down in one-step increments until slippage of a predetermined number of steps (e.g., two steps) is detected, such as based on one or more signals received by the controller 16 from the first encoder 114E. In some versions, the controller 16 may wait for a predetermined delay period (e.g., at least about 25 milliseconds) between moves. In the example shown, after step 809 has been completed, the procedure 800 proceeds to a step 810, at which the controller 16 disables a drive current for the first drive motor 114M for a predetermined time period (e.g., about 200 milliseconds) and captures a reading from the first encoder 114E for vertical alignment to determine the aligned value for the operator accessible container station 104. In some versions, the controller 16 may verify that the aligned value is less than a predetermined threshold (e.g., about −956 steps) to confirm that no false slip was detected. It will be appreciated that steps 808, 809, 810 may be performed concurrently with steps 805, 806, 807, respectively. In the example shown, after steps 807, 810 have been completed, the procedure 800 proceeds to a step 811, at which the controller 16 enables the drive currents for each of the first and second drive motors 114M, 116M to home each of the first and second arms 110, 112.

Steps 801-811 may collectively define a vertical alignment method of the procedure 800.

In the example shown, after step 811 has been completed, the procedure 800 proceeds to step 812, at which the controller 16 calculates an offset position for each of the first and second arms 110, 112 by adding a predetermined number of steps (e.g., about 15 steps) to the aligned values for the respective stations 104, 106. After step 812 has been completed, the procedure 800 proceeds to step 813, at which the controller 16 moves the first and second arms 110, 112 to the respective offset positions. In the example shown, after step 813 has been completed, the procedure 800 proceeds to a step 814, at which the controller 16 sets a profile of the rotary platform 101 to “align.” For example, the controller 16 may communicate such a profile to the operator via a display.

In the example shown, after step 814 has been completed, the procedure 800 proceeds to a step 815, at which the controller 16 rotates the rotary platform 101 from a starting rotational position clockwise in one-step increments until slippage of a predetermined number of steps (e.g., two steps) is detected, such as based on one or more signals received by the controller 16 from the third encoder 118E. In some versions, the controller 16 may wait for a predetermined delay period (e.g., at least about 25 milliseconds) between moves. In the example shown, after step 815 has been completed, the procedure 800 proceeds to a step 816, at which the controller 16 disables a drive current for the third drive motor 118M for a predetermined time period (e.g., about 200 milliseconds) and captures a reading from the third encoder 118E for rotational clockwise alignment to determine a clockwise aligned value for the rotary platform 101. In the example shown, after step 816 has been completed, the procedure 800 proceeds to a step 817, at which the controller 16 enables the drive current for the third drive motor 118M to rotate the rotary platform 101 in the clockwise direction a predetermined number of steps (e.g., about six steps). In the example shown, after step 817 has been completed, the procedure 800 proceeds to a step 818, at which the controller 16 updates the current rotational position for the rotary platform 101 based on one or more signals received by the controller 16 from the third encoder 118E, and proceeds to a step 819, at which the controller 16 returns the rotary platform 101 to the starting rotational position.

In the example shown, after step 819 has been completed, the procedure 800 proceeds to a step 820, at which the controller 16 rotates the rotary platform 101 from the starting rotational position counterclockwise in one-step increments until slippage of a predetermined number of steps (e.g., two steps) is detected, such as based on one or more signals received by the controller 16 from the third encoder 118E. In some versions, the controller 16 may wait for a predetermined delay period (e.g., at least about 25 milliseconds) between moves. In the example shown, after step 820 has been completed, the procedure 800 proceeds to a step 821, at which the controller 16 disables a drive current for the third drive motor 118M for a predetermined time period (e.g., about 200 milliseconds) and captures a reading from the third encoder 118E for rotational counterclockwise alignment to determine a counterclockwise aligned value for the rotary platform 101. In the example shown, after step 821 has been completed, the procedure 800 proceeds to a step 822, at which the controller 16 calculates a rotational aligned value for the rotary platform 101 based on a difference between the clockwise and counterclockwise aligned values. In the example shown, after step 822 has been completed, the procedure 800 proceeds to a step 823, at which the controller 16 enables the drive current for the third drive motor 118M to rotate the rotary platform 101 based on the rotational aligned value.

Steps 812-823 may collectively define a platform-aligning window method of the procedure 800.

After step 823 has been completed, the liquid consumables 14 may be transferred from the desired consumables container 20 to the automated analyzer 10 via the fluid supply line 108.

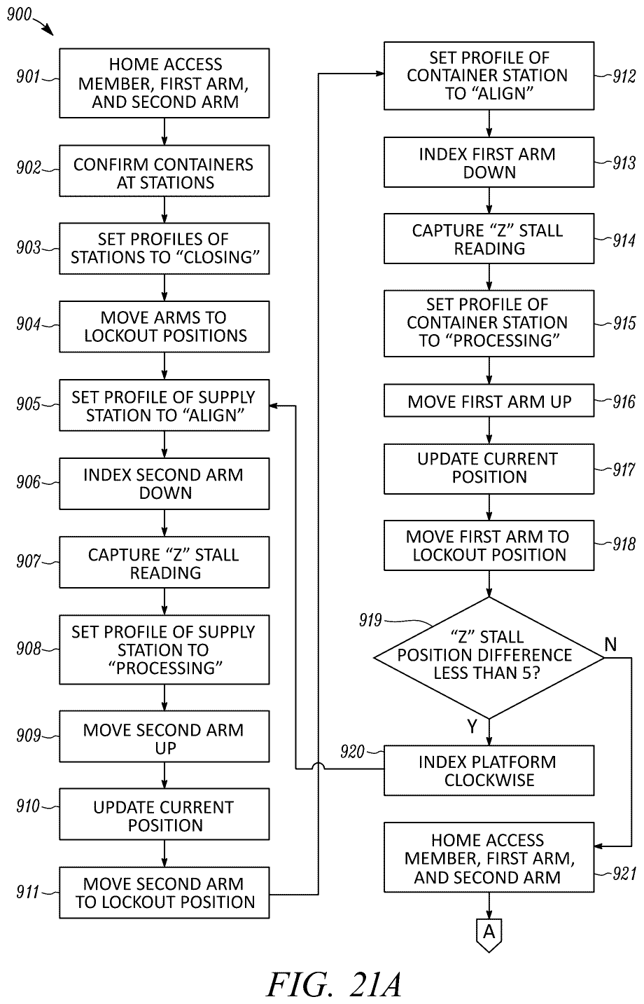

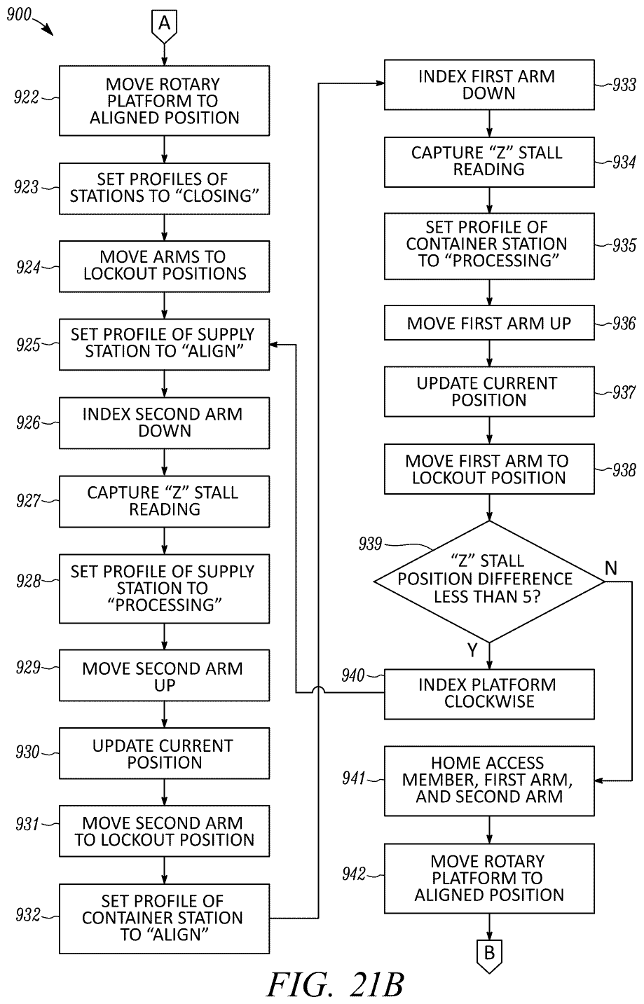

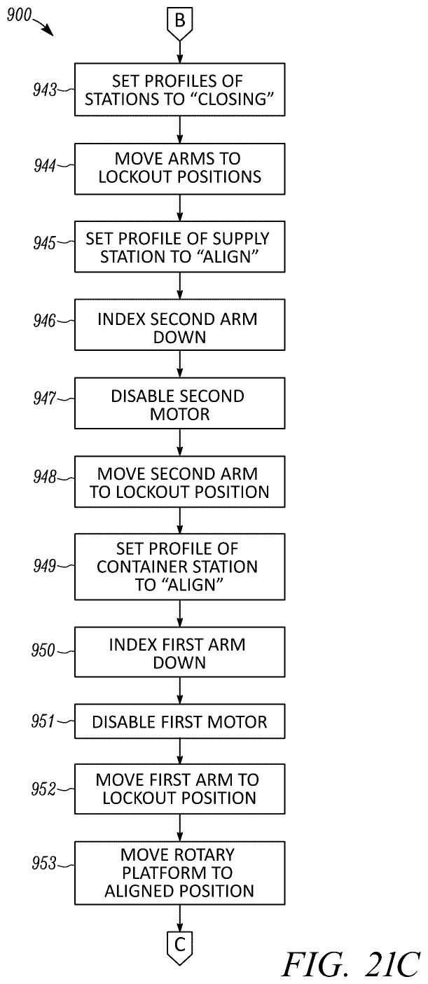

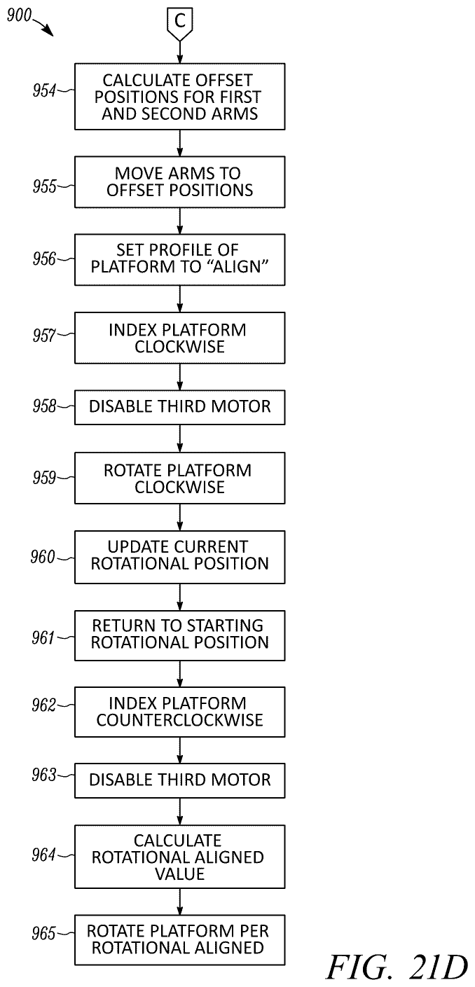

Referring now to FIGS. 21A-21D, another example of a procedure 900 for automatically aligning consumables containers 20 at the operator accessible container station 104 and the analyzer supply station 106 with the respective lock assemblies 202, 252 includes a step 901, at which the controller 16 homes each of the access member 126 (together with the first arm 110), the second arm 112, and the rotary platform 101. In the example shown, after step 901 has been completed, the procedure 900 proceeds to a step 902, at which the controller 16 confirms that consumables containers 20 are at the operator accessible container station 104 and/or the analyzer supply station 106. In some versions, the controller 16 may communicate the absence of a consumables container 20 from the operator accessible container station 104 and/or the analyzer supply station 106 to the operator via a display. In the example, shown, after step 902 has been completed, the procedure 900 proceeds to a step 903, at which the controller 16 sets a profile of each of the operator accessible container station 104 and the analyzer supply station 106 to “closing.” For example, the controller 16 may communicate such a profile to the operator via a display. In the example shown, after step 903 has been completed, the procedure 900 proceeds to a step 904, at which the controller 16 moves the first and second arms 110, 112 to the corresponding lockout positions P2. For example, the controller 16 may move the first and second arms 110, 112 to the corresponding lockout positions P2 by controlling the first and second actuator stacks 114, 116 to release the first and second brakes 114B 116B and/or rotate the first and second shafts 114S, 116S and thereby lower the first and second arms 110, 112 from the corresponding home positions to the corresponding lockout positions P2.

In the example shown, after step 904 has been completed, the procedure 900 proceeds to a step 905, at which the controller 16 sets a profile of the analyzer supply station 106 to “align.” For example, the controller 16 may communicate such a profile to the operator via a display. In the example shown, after step 905 has been completed, the procedure 900 proceeds to a step 906, at which the controller 16 moves the second arm 112 down in one-step increments until slippage of a predetermined number of steps (e.g., two steps) is detected, such as based on one or more signals received by the controller 16 from the second encoder 116E. In some versions, the controller 16 may wait for a predetermined delay period (e.g., at least about 25 milliseconds) between moves. In the example shown, after step 906 has been completed, the procedure 900 proceeds to a step 907, at which the controller 16 captures a reading from the second encoder 116E for the current “Z” stall position for the analyzer supply station 106. In the example shown, after step 907 has been completed, the procedure 900 proceeds to a step 908, at which the controller 16 sets a profile of the analyzer supply station 106 to “processing.” For example, the controller 16 may communicate such a profile to the operator via a display. In the example shown, after step 908 has been completed, the procedure 900 proceeds to a step 909, at which the controller 16 move the second arm 112 up a predetermined number of steps (e.g., about 10 steps). In the example shown, after step 909 has been completed, the procedure 900 proceeds to a step 910, at which the controller 16 updates the current position for the second drive motor 116M based on one or more signals received by the controller 16 from the second encoder 116E, and proceeds to a step 911, at which the controller 16 moves the second arm 112 to the corresponding lockout position.

In the example shown, after step 904 has been completed, the procedure 900 also proceeds to a step 912, at which the controller 16 sets a profile of the operator accessible container station 104 to “align.” For example, the controller 16 may communicate such a profile to the operator via a display. In the example shown, after step 912 has been completed, the procedure 900 proceeds to a step 913, at which the controller 16 moves the first arm 110 down in one-step increments until slippage of a predetermined number of steps (e.g., two steps) is detected, such as based on one or more signals received by the controller 16 from the first encoder 114E. In some versions, the controller 16 may wait for a predetermined delay period (e.g., at least about 25 milliseconds) between moves. In the example shown, after step 913 has been completed, the procedure 900 proceeds to a step 914, at which the controller 16 captures a reading from the first encoder 114E for the current “Z” stall position for the operator accessible container station 104. In the example shown, after step 914 has been completed, the procedure 900 proceeds to a step 915, at which the controller 16 sets a profile of the operator accessible container station 104 to “processing.” For example, the controller 16 may communicate such a profile to the operator via a display. In the example shown, after step 915 has been completed, the procedure 900 proceeds to a step 916, at which the controller 16 move the first arm 110 up a predetermined number of steps (e.g., about 10 steps). In the example shown, after step 916 has been completed, the procedure 900 proceeds to a step 917, at which the controller 16 updates the current position for the first drive motor 114M based on one or more signals received by the controller 16 from the first encoder 114E, and proceeds to a step 918, at which the controller 16 moves the first arm 110 to the lockout position P2. It will be appreciated that steps 912, 913, 914, 915, 916, 917, 918 may be performed concurrently with steps 905, 906, 907, 908, 909, 910, 911 respectively.

In the example shown, after steps 911, 918 have been completed, the procedure 900 proceeds to a step 919, at which the controller 16 determines whether a difference between the previous “Z” stall position (if any) and the current “Z” stall position is less than a predetermined threshold of steps (e.g., about five steps). In the example shown, if no previous “Z” stall position is available, or if the difference between the previous “Z” stall position and the current “Z” stall position is less than the predetermined threshold, then the procedure 900 proceeds from step 919 to a step 920, at which the controller 16 indexes the rotary platform 101 clockwise a predetermined number of steps (e.g., about four steps), after which the procedure 900 returns to step 905. If the difference between the previous “Z” stall position and the current “Z” stall position is greater than the predetermined threshold, then the procedure 900 proceeds from step 919 to step 921, at which the controller 16 homes each of the access member 126 (together with the first arm 110), the second arm 112, and the rotary platform 101, and proceeds from step 921 to a step 922, at which the controller 16 moves the rotary platform 101 to the aligned position.

In the example shown, after step 922 has been completed, the procedure 900 proceeds to a step 923, at which the controller 16 sets a profile of each of the operator accessible container station 104 and the analyzer supply station 106 to “closing.” In the example shown, after step 923 has been completed, the procedure 900 proceeds to a step 924, at which the controller 16 moves the first and second arms 110, 112 to the corresponding lockout positions P2.

In the example shown, after step 924 has been completed, the procedure 900 proceeds to a step 925, at which the controller 16 sets a profile of the analyzer supply station 106 to “align.” For example, the controller 16 may communicate such a profile to the operator via a display. In the example shown, after step 925 has been completed, the procedure 900 proceeds to a step 926, at which the controller 16 moves the second arm 112 down in one-step increments until slippage of a predetermined number of steps (e.g., two steps) is detected, such as based on one or more signals received by the controller 16 from the second encoder 116E. In some versions, the controller 16 may wait for a predetermined delay period (e.g., at least about 25 milliseconds) between moves. In the example shown, after step 926 has been completed, the procedure 900 proceeds to a step 927, at which the controller 16 captures a reading from the second encoder 116E for the current “Z” stall position for the analyzer supply station 106. In the example shown, after step 927 has been completed, the procedure 900 proceeds to a step 928, at which the controller 16 sets a profile of the analyzer supply station 106 to “processing.” For example, the controller 16 may communicate such a profile to the operator via a display. In the example shown, after step 928 has been completed, the procedure 900 proceeds to a step 929, at which the controller 16 move the second arm 112 up a predetermined number of steps (e.g., about 10 steps). In the example shown, after step 929 has been completed, the procedure 900 proceeds to a step 930, at which the controller 16 updates the current position for the second drive motor 116M based on one or more signals received by the controller 16 from the second encoder 116E, and proceeds to a step 931, at which the controller 16 moves the second arm 112 to the corresponding lockout position.

In the example shown, after step 924 has been completed, the procedure 900 also proceeds to a step 932, at which the controller 16 sets a profile of the operator accessible container station 104 to “align.” For example, the controller 16 may communicate such a profile to the operator via a display. In the example shown, after step 932 has been completed, the procedure 900 proceeds to a step 933, at which the controller 16 moves the first arm 110 down in one-step increments until slippage of a predetermined number of steps (e.g., two steps) is detected, such as based on one or more signals received by the controller 16 from the first encoder 114E. In some versions, the controller 16 may wait for a predetermined delay period (e.g., at least about 25 milliseconds) between moves. In the example shown, after step 933 has been completed, the procedure 900 proceeds to a step 934, at which the controller 16 captures a reading from the first encoder 114E for the current “Z” stall position for the operator accessible container station 104. In the example shown, after step 934 has been completed, the procedure 900 proceeds to a step 935, at which the controller 16 sets a profile of the operator accessible container station 104 to “processing.” For example, the controller 16 may communicate such a profile to the operator via a display. In the example shown, after step 935 has been completed, the procedure 900 proceeds to a step 936, at which the controller 16 move the first arm 110 up a predetermined number of steps (e.g., about 10 steps). In the example shown, after step 936 has been completed, the procedure 900 proceeds to a step 937, at which the controller 16 updates the current position for the first drive motor 114M based on one or more signals received by the controller 16 from the first encoder 114E, and proceeds to a step 938, at which the controller 16 moves the first arm 110 to the lockout position P2. It will be appreciated that steps 932, 933, 934, 935, 936, 937, 938 may be performed concurrently with steps 925, 926, 927, 928, 929, 930, 931 respectively.

In the example shown, after steps 931, 938 have been completed, the procedure 900 proceeds to a step 939, at which the controller 16 determines whether a difference between the previous “Z” stall position (if any) and the current “Z” stall position is less than a predetermined threshold of steps (e.g., about five steps). In the example shown, if no previous “Z” stall position is available, or if the difference between the previous “Z” stall position and the current “Z” stall position is less than the predetermined threshold, then the procedure 900 proceeds from step 939 to a step 940, at which the controller 16 indexes the rotary platform 101 counterclockwise a predetermined number of steps (e.g., about four steps), after which the procedure 900 returns to step 925. If the difference between the previous “Z” stall position and the current “Z” stall position is greater than the predetermined threshold, then the procedure 900 proceeds from step 939 to step 941, at which the controller 16 homes each of the access member 126 (together with the first arm 110), the second arm 112, and the rotary platform 101, and proceeds from step 941 to a step 942, at which the controller 16 moves the rotary platform 101 to the aligned position.

Steps 901-942 may collectively define a coarse platform-aligning window method of the procedure 900.

In the example shown, after step 942 has been completed, the procedure 900 proceeds to a step 943, at which the controller 16 sets a profile of each of the operator accessible container station 104 and the analyzer supply station 106 to “closing.” In the example shown, after step 943 has been completed, the procedure 900 proceeds to a step 944, at which the controller 16 moves the first and second arms 110, 112 to the corresponding lockout positions P2.

In the example shown, after step 944 has been completed, the procedure 900 proceeds to a step 945, at which the controller 16 sets a profile of the analyzer supply station 106 to “align.” For example, the controller 16 may communicate such a profile to the operator via a display. In the example shown, after step 945 has been completed, the procedure 900 proceeds to a step 946, at which the controller 16 moves the second arm 112 down in one-step increments until slippage of a predetermined number of steps (e.g., two steps) is detected, such as based on one or more signals received by the controller 16 from the second encoder 116E. In some versions, the controller 16 may wait for a predetermined delay period (e.g., at least about 25 milliseconds) between moves. In the example shown, after step 946 has been completed, the procedure 900 proceeds to a step 947, at which the controller 16 disables a drive current for the second drive motor 116M for a predetermined time period (e.g., about 200 milliseconds) and captures a reading from the second encoder 116E for vertical alignment to determine the aligned value for the analyzer supply station 106. In the example shown, after step 947 has been completed, the procedure 900 proceeds to a step 948, at which the controller 16 enables the drive current for the second drive motor 116M to move the second arm 112 to the corresponding lockout position.

In the example shown, after step 944 has been completed, the procedure 900 also proceeds to a step 949, at which the controller 16 sets a profile of the operator accessible container station 104 to “align.” For example, the controller 16 may communicate such a profile to the operator via a display. In the example shown, after step 949 has been completed, the procedure 900 proceeds to a step 950, at which the controller 16 moves the first arm 110 down in one-step increments until slippage of a predetermined number of steps (e.g., two steps) is detected, such as based on one or more signals received by the controller 16 from the first encoder 114E. In some versions, the controller 16 may wait for a predetermined delay period (e.g., at least about 25 milliseconds) between moves. In the example shown, after step 950 has been completed, the procedure 900 proceeds to a step 951, at which the controller 16 disables a drive current for the first drive motor 114M for a predetermined time period (e.g., about 200 milliseconds) and captures a reading from the first encoder 114E for vertical alignment to determine the aligned value for the analyzer supply station 106. In the example shown, after step 951 has been completed, the procedure 900 proceeds to a step 952, at which the controller 16 enables the drive current for the first drive motor 114M to move the first arm 110 to the lockout position P2.

In the example shown, after steps 948, 951 have been completed, the procedure 900 proceeds to a step 952, at which the controller 16 homes each of the access member 126 (together with the first arm 110), the second arm 112, and the rotary platform 101, and proceeds from step 952 to a step 9523, at which the controller 16 moves the rotary platform 101 to the aligned position.

Steps 943-953 may collectively define a vertical alignment method of the procedure 900.

In the example shown, after step 953 has been completed, the procedure 900 proceeds to a step 954, at which the controller 16 calculates an offset position for each of the first and second arms 110, 112 by adding a predetermined number of steps (e.g., about 15 steps) to the aligned values for the respective stations 104, 106. After step 954 has been completed, the procedure 900 proceeds to step 955, at which the controller 16 moves the first and second arms 110, 112 to the respective offset positions. In the example shown, after step 955 has been completed, the procedure 900 proceeds to a step 956, at which the controller 16 sets a profile of the rotary platform 101 to “align.” For example, the controller 16 may communicate such a profile to the operator via a display.

In the example shown, after step 956 has been completed, the procedure 900 proceeds to a step 957, at which the controller 16 rotates the rotary platform 101 from a starting rotational position clockwise in one-step increments until slippage of a predetermined number of steps (e.g., two steps) is detected, such as based on one or more signals received by the controller 16 from the third encoder 118E. In some versions, the controller 16 may wait for a predetermined delay period (e.g., at least about 25 milliseconds) between moves. In the example shown, after step 957 has been completed, the procedure 900 proceeds to a step 958, at which the controller 16 disables a drive current for the third drive motor 118M for a predetermined time period (e.g., about 200 milliseconds) and captures a reading from the third encoder 118E for rotational clockwise alignment to determine a clockwise aligned value for the rotary platform 101. In the example shown, after step 958 has been completed, the procedure 900 proceeds to a step 959, at which the controller 16 enables the drive current for the third drive motor 118M to rotate the rotary platform 101 in the clockwise direction a predetermined number of steps (e.g., about six steps). In the example shown, after step 959 has been completed, the procedure 900 proceeds to a step 960, at which the controller 16 updates the current rotational position for the rotary platform 101 based on one or more signals received by the controller 16 from the third encoder 118E, and proceeds to a step 961, at which the controller 16 returns the rotary platform 101 to the starting rotational position.

In the example shown, after step 961 has been completed, the procedure 900 proceeds to a step 962, at which the controller 16 rotates the rotary platform 101 from the starting rotational position counterclockwise in one-step increments until slippage of a predetermined number of steps (e.g., two steps) is detected, such as based on one or more signals received by the controller 16 from the third encoder 118E. In some versions, the controller 16 may wait for a predetermined delay period (e.g., at least about 25 milliseconds) between moves. In the example shown, after step 962 has been completed, the procedure 900 proceeds to a step 963, at which the controller 16 disables a drive current for the third drive motor 118M for a predetermined time period (e.g., about 200 milliseconds) and captures a reading from the third encoder 118E for rotational counterclockwise alignment to determine a counterclockwise aligned value for the rotary platform 101. In the example shown, after step 963 has been completed, the procedure 900 proceeds to a step 964, at which the controller 16 calculates a rotational aligned value for the rotary platform 101 based on a difference between the clockwise and counterclockwise aligned values. In the example shown, after step 964 has been completed, the procedure 900 proceeds to a step 965, at which the controller 16 enables the drive current for the third drive motor 118M to rotate the rotary platform 101 based on the rotational aligned value.

Steps 954-965 may collectively define a platform-aligning window method of the procedure 900.

After step 965 has been completed, the liquid consumables 14 may be transferred from the desired consumables container 20 to the automated analyzer 10 via the fluid supply line 108.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A consumables container loading/unloading system (100, 100′, 100″) for an automated analyzer (10), the automated analyzer (10) having an analyzer arrangement (12) with a cycle time, the analyzer arrangement (12) configured to consume at least liquid consumables (14), at least some of the liquid consumables (14) delivered to the automated analyzer (10) via consumables containers (20), the consumables container loading/unloading system (100, 100′, 100″) comprising:
(a) a consumables container loading/unloading apparatus (102) comprising at least a first container holding position (C1) and a second container holding position (C2), each of the first container holding position (C1) and the second container holding position (C2) being configured to removably hold one of the consumables containers (20);
(b) an operator accessible container station (104) accessible by an operator of the automated analyzer (10);
(c) an analyzer supply station (106) not accessible by the operator of the automated analyzer (10); and
(d) a fluid supply line (108) positioned at the analyzer supply station (106), the fluid supply line (108) being configured to deliver the at least some of the liquid consumables (14) to the automated analyzer (10) from the consumables containers (20);
wherein the consumables container loading/unloading apparatus (102) is configured to move the first container holding position (C1) between the operator accessible container station (104) and the analyzer supply station (106) and is further configured to move the second container holding position (C2) between the analyzer supply station (106) and the operator accessible container station (104); and
wherein the consumables container loading/unloading apparatus (102) is configured to:
(i) disconnect the fluid supply line (108) from a first one of the consumables containers (20) positioned at the analyzer supply station (106),
(ii) move the first one of the consumables containers (20) away from the analyzer supply station (106),
(iii) move a second one of the consumables containers (20) to the analyzer supply station (106), and
(iv) connect the fluid supply line (108) to the second one of the consumables containers (20) when positioned at the analyzer supply station (106)
within the cycle time and thereby provide loading of the consumables containers (20) to the automated analyzer (10) on-the-fly.

2. The consumables container loading/unloading system (100, 100′, 100″) of claim 1, further comprising a barrier (130) positioned between the analyzer supply station (106) and the operator.

3. The consumables container loading/unloading system (100, 100′, 100″) of claim 1 or 2, wherein the consumables container loading/unloading apparatus (102) comprises an actuator (118) that is configured to simultaneously move the first container holding position (C1) between the operator accessible container station (104) and the analyzer supply station (106) and the second container holding position (C2) between the analyzer supply station (106) and the operator accessible container station (104).

4. The consumables container loading/unloading system (100, 100′, 100″) of claim 3, wherein the actuator (118) comprises a rotary actuator that moves the first and second container holding positions (C1, C2) a half spin.

5. The consumables container loading/unloading system (100, 100′, 100″) of any one of the above claims, wherein the consumables container loading/unloading apparatus (102) comprises three or more container holding positions (C1, C2).

6. The consumables container loading/unloading system (100, 100′, 100″) of any one of the above claims, further comprising a controller (16) communicably coupled to the consumables container loading/unloading apparatus (102), wherein the controller (16) is configured to control the consumables container loading/unloading apparatus (102) to move the first container holding position (C1) between the operator accessible container station (104) and the analyzer supply station (106) and is further configured to control the consumables container loading/unloading apparatus (102) to move the second container holding position (C2) between the analyzer supply station (106) and the operator accessible container station (104).

7. The consumables container loading/unloading system (100, 100′, 100″) of any one of the above claims, further comprising an access member (126) configured to move vertically between an open position (P3), a lockout position (P2), and a closed position (P1), wherein:
(a) in the closed position (P1) of the access member (126), the access member (126) is disposed adjacent to the operator accessible container station (104) and opposite to the analyzer supply station (106) to thereby prevent the operator from loading/unloading the consumables containers (20) to/from the consumables container loading/unloading apparatus (102);
(b) in at least the lockout position (P2) and not in the closed position (P1) of the access member (126), the first container holding position (C1) is movable between the operator accessible container station (104) and the analyzer supply station (106), and the second container holding position (C2) is movable between the analyzer supply station (106) and the operator accessible container station (104); and
(c) in the open position (P3) of the access member (126), the access member (126) permits the operator load/unload the consumables containers (20) to/from the consumables container loading/unloading apparatus (102) at the operator accessible container station (104).

8. The consumables container loading/unloading system (100, 100′, 100″) of claim 7, further comprising a first arm (110) fixedly attached to the access member (126), wherein the first arm (110) is configured to:
(i) move at least vertically along a first direction (d1) in order to move the access member (126) from the open position (P3) towards the lockout position (P2) and/or the closed position (P1); and
(ii) move at least vertically along a second direction (d2) opposite to the first direction (d1) in order to move the access member (126) from the closed position (P1) towards the lockout position (P2) and/or the open position (P3).

9. The consumables container loading/unloading system (100, 100′, 100″) of claim 8, further comprising a first lock assembly (202, 202′, 202″) fixedly attached to the first arm (110).

10. The consumables container loading/unloading system (100, 100′, 100″) of claim 9, wherein the first lock assembly (202, 202′, 202″) comprises:
(i) a first sealing ring (204, 204′, 204″) configured to seal an opening (O1, O2) of one of the consumables containers (20) held in one of the first container holding position (C1) and the second container holding position (C2) at the operator accessible container station (104) when the fluid supply line (108) is connected with the other of the consumables containers (20) at the analyzer supply station (106) and when the access member (126) is in the closed position (P1);
(ii) a first spring (206, 206′) configured to bias the first sealing ring (204, 204′, 204″) towards the opening (O1, O2) of the one of the consumables containers (20); and
(iii) at least one first manifold (208, 210, 208′, 210′, 210″) configured to hold the first sealing ring (204, 204′, 204″) thereagainst.

11. The consumables container loading/unloading system (100, 100′, 100″) of claim 10, wherein the first scaling ring (204, 204′, 204″) is not configured to seal the opening (O1, O2) of the one of the consumables containers (20) when the access member (126) is in one of the lockout position (P1) and the open position (P3).

12. The consumables container loading/unloading system (100, 100′, 100″) of any one of the above claims, further comprising a second arm (112) fixedly attached to the fluid supply line (108).

13. The consumables container loading/unloading system (100, 100′, 100″) of claim 12, wherein the second arm (112) is configured to:
(i) move at least vertically along a first direction (d1) in order to connect the fluid supply line (108) with one of the consumables containers (20) at the analyzer supply station (106); and
(ii) move at least vertically along a second direction (d2) in order to disconnect the fluid supply line (108) from the one of the consumables containers (20).

14. The consumables container loading/unloading system (100, 100′, 100″) of claim 12 or 13, further comprising a second lock assembly (252, 252′) fixedly attached to the second arm (112), the second lock assembly (252, 252′) comprising:
(a) a second sealing ring (254, 254′) configured to seal an opening (O1, O2) of one of the consumables containers (20) held in one of the first container holding position (C1) and the second container holding position (C2) at the analyzer supply station (106) when the fluid supply line (108) is connected with the one of the consumables containers (20) at the analyzer supply station (106);
(b) a second spring (256) configured to bias the second sealing ring (254, 254′) towards the opening (O1, O2) of the one of the consumables containers (20);
(c) at least one second manifold (258, 260, 260′) configured to hold the second sealing ring (254, 254′) thereagainst, the at least one second manifold (258, 260, 260′) comprising an opening (258o, 260o, 260o′) for receiving a suction straw (109) therethrough;
(d) a vent (264, 264′) extending at least partially through the at least one second manifold (258, 260, 260′) and disposed in fluid communication with the one of the consumables containers (20) when the fluid supply line (108) is connected with the one of the consumables containers (20) at the analyzer supply station (106); and
(e) a valve (262) disposed in fluid communication with the vent (264, 264′) and configured to allow a flow of at least one gas into the one of the consumables containers (20) at the analyzer supply station (106) when the fluid supply line (108) is connected with the one of the consumables containers (20) and some of the liquid consumables (14) is being delivered to the automated analyzer (10).

15. The consumables container loading/unloading system (100, 100′, 100″) of any one of claims 1-13, wherein the fluid supply line (108) comprises a suction straw (109) configured to access the liquid consumables (14) and deliver the liquid consumables (14) to the automated analyzer (10) when the fluid supply line (108) is connected with one of the consumables containers (20) at the analyzer supply station (106).

16. A consumables container loading/unloading system (100, 100′, 100″) for an automated analyzer (10), the automated analyzer (10) having an analyzer arrangement (12) with a cycle time, the analyzer arrangement (12) configured to consume at least liquid consumables (14), at least some of the liquid consumables (14) delivered to the automated analyzer (10) via consumables containers (20), the consumables container loading/unloading system (100, 100′, 100″) comprising:
(a) a consumables container loading/unloading unit (102) comprising at least a first container holding position (C1) and a second container holding position (C2), each of the first container holding position (C1) and the second container holding position (C2) configured to removably hold at least one of the consumables containers (20), wherein the consumables container loading/unloading unit (102) is configured to receive the consumables containers (20) from an operator of the automated analyzer (10);
(b) an operator accessible container station (104) accessible by the operator, such that at least one of the first container holding position (C1) and the second container holding position (C2) is configured to directly receive the consumables containers (20) at the operator accessible container station (104) from the operator;
(c) an analyzer supply station (106) not accessible by the operator,
(d) a fluid supply line (108) disposed at the analyzer supply station (106) and configured to connect with the consumables containers (20) and thereby deliver some of the liquid consumables (14) from the consumables containers (20) to the automated analyzer (10); and
(e) a controller (16) communicably coupled to the consumables container loading/unloading unit (102) and the fluid supply line (108);
wherein the controller (16) is configured to control the consumables container loading/unloading unit (102) to move the first container holding position (C1) between the operator accessible container station (104) and the analyzer supply station (106) and is further configured to control the consumables container loading/unloading unit (102) to move the second container holding position (C2) between the analyzer supply station (106) and the operator accessible container station (104);
wherein the controller (16) is further configured to control the consumables container loading/unloading unit (102) and the fluid supply line (108) to:
(i) disconnect the fluid supply line (108) from a first one of the consumables containers (20) positioned at the analyzer supply station (106),
(ii) move the first one of the consumables containers (20) away from the analyzer supply station (106) by moving a corresponding one of the first container holding position (C1) and the second container holding position (C2) located at the analyzer supply station (106) to the operator accessible container station (104),
(iii) move a second one of the consumables containers (20) to the analyzer supply station (106) by moving the corresponding other of the first container holding position (C1) and the second container holding position (C2) located at the operator accessible container station (104) to the analyzer supply station (106), and
(iv) connect the fluid supply line (108) with the second one of the consumables containers (20) positioned at the analyzer supply station (106)
within the cycle time of the analyzer arrangement (12) and thereby provide loading/unloading of the consumables containers (20) during the cycle time of the analyzer arrangement (12).

17. The consumables container loading/unloading system (100, 100′, 100″) of claim 16, further comprising an access member (126) configured to move vertically between an open position (P3), a lockout position (P2), and a closed position (P1), wherein:
(a) in the closed position (P1) of the access member (126), the access member (126) is disposed adjacent to the operator accessible container station (104) and opposite to the analyzer supply station (106) to thereby prevent the operator from loading/unloading the consumables containers (20) to/from the consumables container loading/unloading unit (102);
(b) in at least the lockout position (P2) and not in the closed position (P1) of the access member (126), the first container holding position (C1) is movable between the operator accessible container station (104) and the analyzer supply station (106), and the second container holding position (C2) is movable between the analyzer supply station (106) and the operator accessible container station (104); and
(c) in the open position (P3) of the access member (126), the access member (126) permits the operator to load/unload the consumables containers (20) to/from the consumables container loading/unloading unit (102) at the operator accessible container station (104).

18. The consumables container loading/unloading system (100, 100′, 100″) of claim 17, further comprising a first arm (110) fixedly attached to the access member (126) and communicably coupled to the controller (16), wherein the first arm (110) is configured to:
(i) move at least vertically along a first direction (d1) in order to move the access member (126) from the open position (P3) towards the lockout position (P2) and/or the closed position (P1); and
(ii) move at least vertically along a second direction (d2) opposite to the first direction (d1) in order to move the access member (126) from the closed position (P1) towards the lockout position (P2) and/or the open position (P3).

19. The consumables container loading/unloading system (100, 100′, 100″) of claim 18, further comprising a first lock assembly (202, 202′, 202″) fixedly attached to the first arm (110), the first lock assembly (202, 202′, 202″) comprising:
(i) a first sealing ring (204, 204′, 204″) configured to seal an opening (O1, O2) of one of the consumables containers (20) held in one of the first container holding position (C1) and the second container holding position (C2) at the operator accessible container station (104) when the fluid supply line (108) is connected with the other of the consumables containers (20) at the analyzer supply station (106) and when the access member (126) is in the closed position (P1);
(ii) a first spring (206, 206′) configured to bias the first sealing ring (204, 204′, 204″) towards the opening (O1, O2) of the one of the consumables containers (20); and
(iii) at least one first manifold (208, 210, 208′, 210′, 210″) configured to hold the first sealing ring (204, 204′, 204″) thereagainst.

20. The consumables container loading/unloading system (100, 100′, 100″) of claim 19, wherein the first sealing ring (204, 204′, 204″) is not configured to seal the opening (O1, O2) of the one of the consumables containers (20) when the access member (126) is in one of the lockout position (P1) and the open position (P3).

21. The consumables container loading/unloading system (100, 100′, 100″) of claim 19 or 20, further comprising a first actuator (114) communicably coupled to the controller (16), wherein the controller (16) is further configured to control the first actuator (114) to move the first arm (110) at least vertically along the first direction (d1) and the second direction (d2) in order to move the access member (126) between the open position (P3), the lockout position (P2), and the closed position (P1).

22. The consumables container loading/unloading system (100, 100′, 100″) of any one of claims 19-21, wherein the fluid supply line (108) comprises a suction straw (109) configured to access the liquid consumables (14) and deliver the liquid consumables (14) to the automated analyzer (10) when the fluid supply line (108) is connected with one of the consumables containers (20) at the analyzer supply station (106).

23. The consumables container loading/unloading system (100, 100′, 100″) of claim 22, wherein a portion of the suction straw (109) is surrounded by a sleeve (107) configured to limit exposure of the liquid consumables (14) to ambient light.

24. The consumables container loading/unloading system (100, 100′, 100″) of claim 22 or 23, further comprising a second arm (112) fixedly attached to the fluid supply line (108) and communicably coupled to the controller (16), wherein the second arm (112) is configured to:
(i) move at least vertically along the first direction (d1) in order to connect the fluid supply line (108) with one of the consumables containers (20) at the analyzer supply station (106); and
(ii) move at least vertically along the second direction (d2) in order to disconnect the fluid supply line (108) from the one of the consumables containers (20).

25. The consumables container loading/unloading system (100, 100′, 100″) of claim 24, further comprising a second lock assembly (252, 252′) fixedly attached to the second arm (112), the second lock assembly (252, 252′) comprising:
(i) a second sealing ring (254, 254′) configured to seal an opening (O1, O2) of one of the consumables containers (20) held in one of the first container holding position (C1) and the second container holding position (C2) at the analyzer supply station (106) when the fluid supply line (108) is connected with the one of the consumables containers (20) at the analyzer supply station (106);
(ii) a second spring (256) configured to bias the second sealing ring (254, 254′) towards the opening (O1, O2) of the one of the consumables containers (20);
(iii) at least one second manifold (258, 260, 260′) configured to hold the second sealing ring (254, 254′) thereagainst, the at least one second manifold (258, 260, 260′) comprising an opening (258o, 260o, 260o′) for receiving the suction straw (109) therethrough;
(iv) a vent (264, 264′) extending at least partially through the at least one second manifold (258, 260, 260′) and disposed in fluid communication with the one of the consumables containers (20) when the fluid supply line (108) is connected with the one of the consumables containers (20) at the analyzer supply station (106); and
(v) a check valve (262) disposed in fluid communication with the vent (264, 264′) and configured to allow a flow of at least one gas into the one of the consumables containers (20) at the analyzer supply station (106) when the fluid supply line (108) is connected with the one of the consumables containers (20) and some of the liquid consumables (14) is being delivered to the automated analyzer (10).

26. The consumables container loading/unloading system (100, 100′, 100″) of claim 25, further comprising a second actuator (116) communicably coupled to the controller (16), wherein the controller (16) is further configured to:
(i) control the second actuator (116) to move the second arm (112) at least vertically along the first direction (d1) in order to connect the fluid supply line (108) with the one of the consumables containers (20) at the analyzer supply station (106); and
(ii) control the second actuator (116) to move the second arm (112) at least vertically along the second direction (d2) in order to disconnect the fluid supply line (108) from the one of the consumables containers (20) at the analyzer supply station (106).

27. The consumables container loading/unloading system (100, 100′, 100″) of claim 25 or 26, wherein the controller (16) is further configured to:
(i) control the second arm (112) to move the second arm (112) at least vertically along the first direction (d1) in order to connect the fluid supply line (108) with one of the consumables containers (20) at the analyzer supply station (106) and seal, via the second lock assembly (252, 252′), the opening (O1, O2) of the one of the consumables containers (20) at the analyzer supply station (106);
(ii) control the fluid supply line (108) to deliver the liquid consumables (14) to the automated analyzer (10) when the fluid supply line (108) is connected with the one of the consumables containers (20) at the analyzer supply station (106);
(iii) control the first arm (110) to move the first arm (110) at least vertically along the first direction (d1) in order to seal, via the first lock assembly (202, 202′, 202″), the opening (O1, O2) of the other of the consumables containers (20) at the operator accessible container station (104) during transfer of the liquid consumables (14) to the automated analyzer (10);
(iv) control each of the first arm (110) and the second arm (112) to move each of the first arm (110) and the second arm (112) at least vertically along the second direction (d2) when the transfer of the liquid consumables (14) from the one of the consumables containers (20) to the automated analyzer (10) is completed;
(v) control the consumables container loading/unloading unit (102) to move the first container holding position (C1) between the operator accessible container station (104) and the analyzer supply station (106) and to move the second container holding position (C2) between the analyzer supply station (106) and the operator accessible container station (104), such that the other of the consumables containers (20) is positioned at the analyzer supply station (106);
(vi) control the second arm (112) to move the second arm (112) at least vertically along the first direction (d1) in order to connect the fluid supply line (108) with the other of the consumables containers (20) at the analyzer supply station (106) and seal, via the second lock assembly (252, 252′), the opening (O1, O2) of the other of the consumables containers (20) at the analyzer supply station (106);
(vii) control the fluid supply line (108) to deliver the liquid consumables (14) to the automated analyzer (10) when the fluid supply line (108) is connected with the other of the consumables containers (20) at the analyzer supply station (106); and
(viii) control the first arm (110) to further move the first arm (110) at least vertically along the first direction (d1) to thereby allow the operator to replace the one of the consumables containers (20) at the operator accessible container station (104) with a new consumables container (20), wherein the one of the first container holding position (C1) and the second container holding position (C2) at the operator accessible container station (104) is configured to receive the new consumables container (20).

28. The consumables container loading/unloading system (100, 100′, 100″) of any one of claims 24-27, further comprising:
(a) a first home sensor (122) disposed on the first arm (110) to sense a position of the first arm (110); and
(b) a second home sensor (124) disposed on the second arm (112) to sense a position of the second arm (112).

29. The consumables container loading/unloading system (100, 100′, 100″) of any one of claims 16-28, further comprising a third actuator (118) communicably coupled to the controller (16), wherein the controller (16) is configured to:
(i) control the third actuator (118) to move the first container holding position (C1) between the operator accessible container station (104) and the analyzer supply station (106); and
(ii) control the third actuator (118) to move the second container holding position (C2) between the analyzer supply station (106) and the operator accessible container station (104).

30. The consumables container loading/unloading system (100, 100′, 100″) of claim 29, wherein the third actuator (118) comprises a rotary actuator configured to:
(i) move the first container holding position (C1) between the operator accessible container station (104) and the analyzer supply station (106) by rotating the first container holding position (C1) by 180 degrees; and
(ii) move the second container holding position (C2) between the analyzer supply station (106) and the operator accessible container station (104) by rotating the second container holding position (C2) by 180 degrees.

31. The consumables container loading/unloading system (100, 100′, 100″) of claim 29, wherein the third actuator (118) comprises a linear actuator configured to:
(i) move the first container holding position (C1) at least piecewise linearly between the operator accessible container station (104) and the analyzer supply station (106); and
(ii) move the second container holding position (C2) at least piecewise linearly between the analyzer supply station (106) and the operator accessible container station (104).

32. The consumables container loading/unloading system (100, 100′, 100″) of any one of claims 16-31, wherein the consumables container loading/unloading unit (102) further comprises a barrier (130) configured to allow loading of only consumables containers (20) with predetermined dimensions and/or uncapped consumables containers (20).

33. The consumables container loading/unloading system (100, 100′, 100″) of any one of claims 16-32, further comprising a reader (132) configured to read identifiers of the consumables containers (20) at the operator accessible container station (104).

34. The consumables container loading/unloading system (100, 100′, 100″) of any one of claims 16-33, wherein the consumables container loading/unloading unit (102) comprises at least one additional container holding position in addition to the first container holding position (C1) and the second container holding position (C2).

35. A consumables container loading/unloading system (100, 100′, 100″) for an automated analyzer (10), the automated analyzer (10) having an analyzer arrangement (12) with a cycle time, the analyzer arrangement (12) configured to consume at least liquid consumables (14), at least some of the liquid consumables (14) delivered to the automated analyzer (10) via consumables containers (20), the consumables container loading/unloading system (100, 100′, 100″) comprising:
(a) a consumables container loading/unloading unit (102) comprising at least a first container holding position (C1) and a second container holding position (C2), each of the first container holding position (C1) and the second container holding position (C2) configured to removably hold at least one of the consumables containers (20), wherein the consumables container loading/unloading unit (102) is configured to receive the consumables containers (20) from an operator of the automated analyzer (10);
(b) at least one operator accessible container station (104) accessible by the operator, such that at least one of the first container holding position (C1) and the second container holding position (C2) is configured to directly receive the consumables containers (20) at the at least one operator accessible container station (104) from the operator;
(c) at least one analyzer supply station (106);
(d) at least one fluid supply line (108) disposed at the at least one analyzer supply station (106) and configured to connect with the consumables containers (20) and thereby deliver some of the liquid consumables (14) from the consumables containers (20) to the automated analyzer (10);
(e) a first lock assembly (202, 202′, 202″) fixedly attached to a first arm (110), the first lock assembly (202, 202′, 202″) comprising a first sealing ring (204, 204′, 204″) configured to seal a first opening (O1) of a first consumables container (20a) held in one of the first container holding position (C1) and the second container holding position (C2);
(f) a second lock assembly (252, 252′) fixedly attached to a second arm (112), the second lock assembly (252, 252′) comprising:
(i) a second sealing ring (254, 254′) configured to seal a second opening (O2) of a second consumables container (20b) held in the other of the first container holding position (C1) and the second container holding position (C2); and
(ii) a valve (262) configured to allow a flow of at least one gas into the second consumables container (20b) at the at least one analyzer supply station (106) when the at least one fluid supply line (108) is connected with the second consumables container (20b) and some of the liquid consumables (14) is being delivered to the automated analyzer (10); and
(g) a controller (16) communicably coupled to the consumables container loading/unloading unit (102).

36. The consumables container loading/unloading system (100, 100′, 100″) of claim 35, wherein the first lock assembly (202, 202′, 202″) further comprises:
(i) a first spring (206, 206′) configured to bias the first sealing ring (204, 204′, 204″) towards the first opening (O1) of the first consumables container (20a); and
(ii) at least one first manifold (208, 208′, 210, 210′, 210″) configured to hold the first sealing ring (204, 204′, 204″) thereagainst.

37. The consumables container loading/unloading system (100, 100′, 100″) of claim 36, wherein the first lock assembly (202, 202′, 202″) further comprises:
(i) a first vent (214) extending at least partially through the at least one first manifold (208, 210, 208′, 210′, 210″) and disposed in fluid communication with the first consumables container (20a) when the at least one fluid supply line (108) is connected with the first consumables container (20a) at the at least one analyzer supply station (106); and
(ii) a first check valve (212) disposed in fluid communication with the first vent (214) and configured to allow a flow of at least one gas into the first consumables container (20a) at the at least one analyzer supply station (106) when the at least one fluid supply line (108) is connected with the first consumables container (20a) and some of the liquid consumables (14) is being delivered to the automated analyzer (10).

38. The consumables container loading/unloading system (100, 100′, 100″) of any one of claims 35-37, wherein the first arm (110) is fixedly attached to the at least one fluid supply line (108), wherein the first arm (110) is configured to:
(i) move at least vertically along a first direction (d1) in order to connect the at least one fluid supply line (108) with the first consumables container (20a) at the at least one analyzer supply station (106); and
(ii) move at least vertically along a second direction (d2) opposite to the first direction (d1) in order to disconnect the at least one fluid supply line (108) from the first consumables container (20a).

39. The consumables container loading/unloading system (100, 100′, 100″) of any one of claims 35-38, wherein the second lock assembly (252, 252′) further comprises:
(i) a second spring (256) configured to bias the second sealing ring (254, 254′) towards the second opening (O2) of the second consumables container (20b);
(ii) at least one second manifold (258, 260, 260′) configured to hold the second sealing ring (254, 254′) thereagainst; and
(iii) a second vent (264, 264′) disposed in fluid communication with the valve (262) and extending at least partially through the at least one second manifold (258, 260, 260′), wherein the second vent (264, 264′) is disposed in fluid communication with the second consumables container (20b) when the at least one fluid supply line (108) is connected with the second consumables container (20b) at the at least one analyzer supply station (106).

40. The consumables container loading/unloading system (100, 100′, 100″) of any one of claims 35-39, wherein the second arm (112) is fixedly attached to the at least one fluid supply line (108), wherein the second arm (112) is configured to:
(i) move at least vertically along a first direction (d1) in order to connect the at least one fluid supply line (108) with the second consumables container (20b) at the at least one analyzer supply station (106); and
(ii) move at least vertically along a second direction (d2) opposite to the first direction (d1) in order to disconnect the at least one fluid supply line (108) from the second consumables container (20b).

41. The consumables container loading/unloading system (100, 100′, 100″) of any one of claims 35-40, wherein the controller (16) is configured to:
(i) control the second arm (112) to move the second arm (112) at least vertically along a first direction (d1) in order to connect the at least one fluid supply line (108) with the second consumables container (20b) at the at least one analyzer supply station (106) and seal, via the second lock assembly (252, 252′), the second opening (O2) of the second consumables container (20b) at the at least one analyzer supply station (106);
(ii) control the at least one fluid supply line (108) to deliver the liquid consumables (14) to the automated analyzer (10) when the at least one fluid supply line (108) is connected with the second consumables container (20b) at the at least one analyzer supply station (106);
(iii) control the first arm (110) to move the first arm (110) at least vertically along a second direction (d2) opposite to the first direction (d1) to thereby allow the operator to replace the first consumables container (20a) at the at least one operator accessible container station (104) with a new consumables container (20n), wherein the one of the first container holding position (C1) and the second container holding position (C2) at the at least one operator accessible container station (104) is configured to receive the new consumables container (20n);
(iv) control the first arm (110) to move the first arm (110) at least vertically along the first direction (d1) in order to connect the at least one fluid supply line (108) with the new consumables container (20n) at the at least one analyzer supply station (106) and seal, via the first lock assembly (202, 202′, 202″), an opening of the new consumables container (20n) at the at least one operator accessible container station (104) during transfer of the liquid consumables (14) from the second consumables container (20h) to the automated analyzer (10);
(v) control the at least one fluid supply line (108) to deliver the liquid consumables (14) from the new consumables container (20n) to the automated analyzer (10) when the transfer of the liquid consumables (14) from the second consumables container (20b) to the automated analyzer (10) is completed; and
(vi) control the second arm (112) to move the second arm (112) at least vertically along the second direction (d2) in order to disconnect the at least one fluid supply line (108) from the second consumables container (20b) at the at least one analyzer supply station (106), wherein the operator is allowed to replace the second consumables container (20b) at the at least one operator accessible container station (104) with another new consumables container (20n′) when the at least one fluid supply line (108) is disconnected from the second consumables container (20b), and wherein the another new consumables container (20n′) is received in the other of the first container holding position (C1) and the second container holding position (C2) at the at least one operator accessible container station (104).

42. The consumables container loading/unloading system (100, 100′, 100″) of claim 35, wherein the at least one operator accessible container station (104) comprises only a single operator accessible container station (104) serving at the one of the first container holding position (C1) and the second container holding position (C2).

43. The consumables container loading/unloading system (100, 100′, 100″) of claim 42, wherein the at least one analyzer supply station (106) comprises only a single analyzer supply station (106) spaced apart from the single operator accessible container station (104) and serving at the other of the first container holding position (C1) and the second container holding position (C2), wherein the single analyzer supply station (106) is not accessible by the operator, and wherein the at least one fluid supply line (108) comprises a single fluid supply line (108) disposed at the single analyzer supply station (106).

44. The consumables container loading/unloading system (100, 100′, 100″) of claim 43, wherein the controller (16) is configured to control the consumables container loading/unloading unit (102) to move the first container holding position (C1) between the single operator accessible container station (104) and the single analyzer supply station (106) and is further configured to control the consumables container loading/unloading unit (102) to move the second container holding position (C2) between the single analyzer supply station (106) and the single operator accessible container station (104).

45. The consumables container loading/unloading system (100, 100′, 100″) of claim 44, wherein the controller (16) is further configured to control the consumables container loading/unloading unit (102) and the single fluid supply line (108) to:
(i) disconnect the single fluid supply line (108) from the second consumables container (20b) positioned at the single analyzer supply station (106),
(ii) move the second consumables container (20b) away from the single analyzer supply station (106) by moving a corresponding one of the first container holding position (C1) and the second container holding position (C2) located at the single analyzer supply station (106) to the single operator accessible container station (104),
(iii) move the first consumables container (20a) to the single analyzer supply station by moving the corresponding other of the first container holding position (C1) and the second container holding position (C2) located at the single operator accessible container station (104) to the single analyzer supply station (106), and
(iv) connect the single fluid supply line (108) with the first consumables container (20a) positioned at the single analyzer supply station (106)
within the cycle time of the analyzer arrangement (12) and thereby provide loading/unloading of the consumables containers (20) during the cycle time of the analyzer arrangement (12);
wherein the operator is allowed to replace the second consumables container (20b) positioned at the single operator accessible container station (104) with another consumables container (20).

46. The consumables container loading/unloading system (100, 100′, 100″) of claim 35, wherein the at least one operator accessible container station (104) comprises a pair of operator accessible container stations (104) spaced apart from each other, one of the pair of operator accessible container stations (104) serving at the one of the first container holding position (C1) and the second container holding position (C2), and the other of the pair of operator accessible container stations (104) serving at the other of the first container holding position (C1) and the second container holding position (C2).

47. The consumables container loading/unloading system (100, 100′, 100″) of claim 46, wherein the at least one analyzer supply station (106) comprises a pair of analyzer supply stations (106) spaced apart from each other, one of the pair of analyzer supply stations (106) serving at the one of the first container holding position (C1) and the second container holding position (C2), the other of the pair of analyzer supply stations (106) serving at the other of the first container holding position (C1) and the second container holding position (C2), and wherein the at least one fluid supply line (108) comprises a pair of fluid supply lines (108), each of the pair of fluid supply lines (108) disposed at a corresponding analyzer supply station (106) from the pair of analyzer supply stations (106).

48. The consumables container loading/unloading system (100, 100′, 100″) of claim 47, wherein:
(a) the one of the pair of analyzer supply stations (106) and the one of the pair of operator accessible container stations (104) are configured to serve at the first container holding position (C1); and
(b) the other of the pair of analyzer supply stations (106) and the other of the pair of operator accessible container stations (104) are configured to serve at the second container holding position (C2).

49. The consumables container loading/unloading system (100, 100′, 100″) of any one of claims 35-48, wherein each of the at least one fluid supply line (108) comprises a suction straw (109) configured to access the liquid consumables (14) and deliver the liquid consumables (14) to the automated analyzer (10) when the at least one fluid supply line (108) is connected with the at least one of the consumables containers (20) at the at least one analyzer supply station (106).

50. The consumables container loading/unloading system (100, 100′, 100″) of any one of claims 35-49, further comprising:
(a) a first home sensor (122) disposed on the first arm (110) to sense a position of the first arm (110); and
(b) a second home sensor (124) disposed on the second arm (112) to sense a position of the second arm (112).

51. The consumables container loading/unloading system (100, 100′, 100″) of any one of claims 35-50, wherein the consumables container loading/unloading unit (102) further comprises a barrier (130) configured to allow loading of only consumables containers (20) with predetermined dimensions and/or uncapped consumables containers (20).

52. The consumables container loading/unloading system (100, 100′, 100″) of any one of claims 35-51, further comprising at least one reader (132) configured to read identifiers of the consumables containers (20) at the at least operator accessible container station (104).

53. The consumables container loading/unloading system (100, 100′, 100″) of claim 41, further comprising a tubing guide (140) for guiding the at least one fluid supply line (108) when the second arm (112) moves along the first direction (d1) and the second direction (d2).

54. A method of operating a consumables container loading/unloading system (100, 100′, 100″) for an automated analyzer (10), the automated analyzer (10) having an analyzer arrangement (12) with a cycle time, the analyzer arrangement (12) configured to consume at least liquid consumables (14), at least some of the liquid consumables (14) delivered to the automated analyzer (10) via consumables containers (20), the method comprising:
(a) disconnecting a fluid supply line (108) from a first one of the consumables containers (20) positioned at an analyzer supply station (106) not accessible by an operator of the automated analyzer (10),
(b) moving the first one of the consumables containers (20) away from the analyzer supply station (106),
(c) moving a second one of the consumables containers (20) to the analyzer supply station (106), and
(d) connecting the fluid supply line (108) to the second one of the consumables containers (20) when positioned at the analyzer supply station (106),
wherein disconnecting the fluid supply line (108) from the first one of the consumables containers (20), moving the first one of the consumables containers (20) away from the analyzer supply station (106), moving the second one of the consumables containers (20) to the analyzer supply station (106), and connecting the fluid supply line (108) to the second one of the consumables containers (20) are performed within the cycle time and thereby provide loading of the consumables containers (20) to the automated analyzer (10) on-the-fly.

55. The method of claim 54, wherein moving the first one of the consumables containers (20) away from the analyzer supply station (106) includes moving the first one of the consumables containers (20) to an operator accessible container station (104) accessible by the operator of the automated analyzer (10).

56. The method of any of claims 54 through 55, wherein moving the second one of the consumables containers (20) to the analyzer supply station (106) includes moving the second one of the consumables containers (20) from an operator accessible container station (104) accessible by the operator of the automated analyzer (10).

57. The method of any of claims 54 through 56, wherein the fluid supply line (108) is positioned at the analyzer supply station (106).

58. The method of any of claims 54 through 57, further comprising delivering the at least some of the liquid consumables (14) to the automated analyzer (10) from the consumables containers (20) via the fluid supply line (108).

59. The method of any of claims 54 through 58, further comprising operating the analyzer arrangement (12) within the cycle time.

60. The method of any of claims 54 through 59, wherein the cycle time is within a range of about 6 seconds to about 12 seconds.

61. A consumables container loading/unloading system (100, 100′, 100″) for an automated analyzer (10), the automated analyzer (10) having an analyzer arrangement (12) with a cycle time, the consumables container loading/unloading system (100, 100′, 100″) comprising:
(a) an operator accessible container station (104) accessible by an operator of the automated analyzer (10);
(b) an analyzer supply station (106) not accessible by the operator of the automated analyzer (10);
(c) a consumables container loading/unloading apparatus (102) configured to move first and second consumable containers (20) between the operator accessible container station (104) and the analyzer supply station (106);
(d) a fluid supply line (108) positioned at the analyzer supply station (106), the fluid supply line (108) being configured to deliver liquid consumables (14) to the automated analyzer (10) from the first and second consumables containers (20); and
(e) a controller (16) communicably coupled to the consumables container loading/unloading apparatus (102), wherein the controller (16) is configured to, within the cycle time:
(i) disconnect the fluid supply line (108) from the first consumables container (20) positioned at the analyzer supply station (106),
(ii) move the first consumables container (20) away from the analyzer supply station (106),
(iii) move the second consumables container (20) to the analyzer supply station (106), and
(iv) connect the fluid supply line (108) to the second consumables container (20) when positioned at the analyzer supply station (106).

62. The consumables container loading/unloading system (100, 100′, 100″) of claim 61, wherein the consumables container loading/unloading unit (102) further comprises a barrier (130) configured to allow loading of only consumables containers (20) with predetermined dimensions and/or uncapped consumables containers (20).

63. The consumables container loading/unloading system (100, 100′, 100″) of claim 62, wherein the barrier (130) includes at least one pair of upper prongs (131) spaced apart from each other to define an opening that is sized and configured to receive a neck portion of only consumables containers (20) with predetermined dimensions and/or uncapped consumables containers (20).

64. The consumables container loading/unloading system (100, 100′, 100″) of any of claims 62 through 63, wherein the barrier (130) includes at least one pair of lower prongs (133) spaced apart from each other to define an opening that is sized and configured to receive a body portion of only consumables containers (20) with predetermined dimensions and/or uncapped consumables containers (20).

65. The consumables container loading/unloading system (100, 100′, 100″) of any of claims 61 through 64, further comprising a first lock assembly (202, 202′, 202″) configured to selectively seal an opening (O1, O2) of at least one of the first or second consumables containers (20) when positioned at the operator accessible container station (104).

66. The consumables container loading/unloading system (100, 100′, 100″) of claim 65, wherein the first lock assembly (202, 202′, 202″) comprises:
(i) a first sealing ring (204, 204′, 204″) configured to selectively seal the opening (O1, O2) of the at least one of the first or second consumables containers (20) when positioned at the operator accessible container station (104);
(ii) a first spring (206, 206′) configured to bias the first sealing ring (204, 204′, 204″) towards the opening (O1, O2) of the at least one of the first or second consumables containers (20); and
(iii) at least one first manifold (208, 210, 208′, 210′, 210″) configured to hold the first sealing ring (204, 204′, 204″) thereagainst.

67. The consumables container loading/unloading system (100, 100′, 100″) of claim 66, wherein the at least one first manifold (208, 210, 208′, 210′, 210″) includes only a single manifold (210″), wherein the first lock assembly (202, 202′, 202″) further comprises a first nut (211) configured to hold the first sealing ring (204, 204′, 204″) against the single manifold (210″).

68. The consumables container loading/unloading system (100, 100′, 100″) of any of claims 61 through 67, further comprising a second lock assembly (252, 252′) configured to selectively seal an opening (O1, O2) of at least one of the first or second consumables containers (20) when positioned at the analyzer supply station (106).

69. The consumables container loading/unloading system (100, 100′, 100″) of claim 68, wherein the second lock assembly (252, 252′) comprises:
(i) a second sealing ring (254, 254′) configured to selectively seal the opening (O1, O2) of at least one of the first or second consumables containers (20) when positioned at the analyzer supply station (106);
(ii) a second spring (256) configured to bias the second sealing ring (254, 254′) towards the opening (O1, O2) of the at least one of the first or second consumables containers (20); and
(iii) at least one second manifold (258, 260, 260′) configured to hold the second sealing ring (254, 254′) thereagainst, the at least one second manifold (258, 260, 260′) comprising an opening (258o, 260o, 260o′) for receiving a suction straw (109) therethrough.

70. The consumables container loading/unloading system (100, 100′, 100″) of claim 69, wherein the at least one second manifold (258, 260, 260′) includes only a single manifold (260′), wherein the second lock assembly (252, 252′) further comprises a second nut (261) configured to hold the second sealing ring (254, 254′) against the single manifold (260′).
